(19) United States
(12) Patent Application Publication
(10) Pub. No.: US 2005/0114829 A1
(43) Pub. Date: May 26, 2005

(54) Facilitating the process of designing and developing a project

(75) Inventors: Allison Robin, Lansdale, PA (US); Paul D. Haynes, Issaquah, WA (US); Enzo Paschino, Seattle, WA (US); Roelof Kroes, Issaquah, WA (US); Robert Y. Oikawa, Redmond, WA (US); Scott D. Getchell, Bellevue, WA (US); Pervez Kazmi, Glen Waverley (AU); Holly Dyas, Bothell, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/955,248

(22) Filed: Sep. 30, 2004

Related U.S. Application Data
(60) Provisional application No. 60/516,457, filed on Oct. 30, 2003.

(51) Int. Cl. G06F 9/44

(52) U.S. Cl. 717/101

(57) ABSTRACT

The process of designing and developing a software project is facilitated with one or more of multiple exemplary data structures. These exemplary data structures facilitate interaction among team members from one or more teams selected from those of an exemplary team model and across process phases of two or more process phases selected from those of an exemplary process model. Moreover, the exemplary data structures facilitate implementation of and adherence to (i) an exemplary risk management discipline and process and (ii) an exemplary readiness management discipline and process. These exemplary data structures include, but are not limited to, a milestone review data structure, a team lead project progress data structures, a vision/scope data structure, a project structure data structure, a team member project progress data structure, a master project plan data structure, a training plan data structure, a functional specification data structure, and a post project analysis data structure.

### CROSS-REFERENCE(S) TO RELATED APPLICATION(S)

This nonprovisional patent application claims the benefit of priority from co-pending provisional patent application No. 60/516,457, filed on Oct. 30, 2003, entitled “Computer Supported Project Design, Development, and Management Process Tools and Techniques”. This nonprovisional patent application hereby incorporates by reference herein the entire disclosure thereof.

### COPYRIGHT NOTICE

A portion of the disclosure (including text and drawings) of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNICAL FIELD

This disclosure relates in general to designing and developing a project and in particular, by way of example but not limitation, to facilitating the process of designing and developing a project.

### BACKGROUND

Computer software projects entail completion of a variety of tasks and involve a myriad of specialties. The personnel providing the specialties and accomplishing the tasks are therefore as numerous as they are diverse. Historically, software projects have been divided into separate phases. Each separate phase is worked on by relatively autonomous groups of personnel.

In effect, each autonomous group receives a task, completes the task, and forwards some kind of result to the next personnel group. Consequently, such personnel groups tend to be unknowledgeable about and likely indifferent to the overall goals and timelines of the software project. Poorly executed software projects thus tend to exhibit one or more of the following effects: important features are omitted, costly workarounds are needed, bugs are ubiquitous, confusion and miscommunication cause delays, and so forth.

Accordingly, there is a need for schemes and/or techniques that can efficiently and/or uniformly address one or more of the above-described and other inadequacies of existing strategies for computer software projects.

### SUMMARY

The process of designing and developing a software project is facilitated with one or more of multiple exemplary data structures. These exemplary data structures facilitate interaction among team members from one or more teams selected from those of an exemplary team model. The exemplary team model includes six teams: a program management team, a development team, a test team, a release management team, a user experience team, and a product management team.

These exemplary data structures also facilitate interaction across process phases of two or more process phases selected from those of an exemplary process model. The exemplary process model includes five phases: an envisioning phase, a planning phase, a developing phase, a stabilizing phase, and a deploying phase. Moreover, the exemplary data structures facilitate implementation of and adherence to (i) an exemplary risk management discipline and process and (ii) an exemplary readiness management discipline and process.

These exemplary data structures include, but are not limited to, a milestone review data structure, a team lead project progress data structure, a vision/scope data structure, a project structure data structure, a team member project progress data structure, a master project plan data structure, a training plan data structure, a functional specification data structure, and a post project analysis data structure.

Other method, system, approach, apparatus, device, media, procedure, arrangement, etc. implementations are described herein.

### BRIEF DESCRIPTION OF THE DRAWINGS

The same numbers are used throughout the drawings to reference like and/or corresponding aspects, features, and components.

FIG. 1 illustrates an example of a computing (or general device) operating environment that is capable of (wholly or partially) implementing at least one aspect of facilitating the process of designing and developing a project as described herein.

FIG. 2 is a block diagram depicting exemplary underlying components for differing implementations.

FIG. 3 is a block diagram depicting an exemplary team model.

FIG. 4 is a block diagram depicting an exemplary process model.

FIG. 5 is a block diagram depicting an exemplary risk management process.

FIG. 6 is a block diagram depicting an exemplary readiness management discipline.

FIG. 7 is a block diagram depicting an exemplary waterfall model.

FIG. 8 is a block diagram depicting an exemplary spiral model.

FIG. 9 is a block diagram depicting an exemplary hybrid process model.

FIG. 10 is a block diagram depicting exemplary elements of a software-based solution.

FIG. 11 is a block diagram depicting an exemplary tradeoff triangle.

FIG. 12 is a block diagram depicting an exemplary tradeoff matrix.

FIG. 13 is an illustrative graph depicting an exemplary process using versioned releases.

FIG. 14 is a block diagram depicting an exemplary process model in terms of modules for phases and milestones thereof.

FIG. 15 is an illustrative diagram depicting an exemplary master project plan.

FIG. 16 is a graph depicting an exemplary bug convergence paradigm.

FIG. 17 is a graph depicting an exemplary zero bug bounce paradigm.

FIG. 18 is a block diagram depicting exemplary team model role clusters.

FIG. 19 is a block diagram depicting exemplary feature teams.

FIG. 20 is a block diagram depicting an exemplary process for combining roles.

FIG. 21 is a block diagram depicting an exemplary accountability paradigm.

FIG. 22 is a block diagram depicting an exemplary risk management process.

FIG. 23 is a block diagram depicting an exemplary risk identification paradigm that produces at least one or more risk statements.

FIG. 24 is a block diagram of an exemplary risk statement.

FIG. 25 is a block diagram depicting an exemplary risk analysis and prioritization paradigm that produces at least a prioritized risk list, deactivated risks, and one or more risk statement forms.

FIG. 26 is a block diagram depicting an exemplary risk planning and scheduling paradigm that produces at least an updated risk list, updated project plans and schedules, and one or more risk action forms.

FIG. 27 is a block diagram depicting an exemplary risk tracking and reporting paradigm that produces at least a risk status report and a trigger event notification.

FIG. 28 is a block diagram depicting an exemplary risk control paradigm that produces at least a project status report, a contingency plan outcome report, and one or more project change control requests.

FIG. 29 is a block diagram depicting an exemplary learning-from-risk paradigm that produces at least a risk knowledge base.

FIG. 30 is a block diagram depicting an exemplary readiness management discipline.

FIG. 31 is a block diagram depicting an exemplary readiness management process.

FIG. 32 is a block diagram depicting an exemplary correlation between IT scenario categories and typical phases, training types, and skills management.

FIG. 33 is an example of devices and team members creating, manipulating, and otherwise interacting with a data structure that can facilitate the process of designing and developing a project.

FIG. 34 is an example milestone review data structure.

FIG. 35 is an example team lead project progress data structure.

FIG. 36 is an example vision/scope data structure.

FIGS. 37A and 37B are together an example project structure data structure.

FIG. 38 is an example team member project progress data structure.

FIG. 39 is an example master project plan data structure.

FIG. 40 is an example training plan data structure.

FIG. 41 is an example functional specification data structure.

FIG. 42 is an example post project analysis data structure.

### DETAILED DESCRIPTION

Introduction

Implementations of the described solutions framework (SF) involve a deliberate and disciplined approach to technology projects based on a defined set of principles, models, disciplines, concepts, guidelines, and proven practices. This section introduces the SF and provides an overview of its foundational principles, core models, and relevant disciplines. It focuses on how their application contributes to the success of technology projects.

Creating meaningful business solutions on time and within budget is aided with a proven approach. The SF provides an adaptable framework for successfully delivering information technology solutions faster, requiring fewer people, and involving less risk, while enabling higher quality results. The described SF helps teams directly address the most common causes of technology project failure in order to improve success rates, solution quality, and business impact. Created to deal with the dynamic nature of technology projects and environments, the SF fosters the ability to adapt to continual change within the course of a project.

The SF is called a framework instead of a methodology for specific reasons. As opposed to a prescriptive methodology, the SF provides a flexible and scalable framework that can be adapted to meet the needs of any project (regardless of size or complexity) to plan, build, and deploy business-driven technology solutions. The exemplary SF techniques described herein essentially hold that there is no single structure or process that optimally applies to the requirements and environments for all projects. It recognizes that, nonetheless, the need for guidance exists. As a framework, SF provides this guidance without imposing so much prescriptive detail that its use is limited to a narrow range of project scenarios. Accordingly, SF components can be applied individually or collectively to improve success rates for the following exemplary types of projects and others:
Software development projects, including mobile, Web and e-commerce applications, Web services, mainframe, and n-tier.
Infrastructure deployment projects, including desktop deployments, operating system upgrades, enterprise messaging deployments, and configuration and operations management systems deployments.
Packaged application integration projects, including personal productivity suites, enterprise resource planning (ERP), and enterprise project management solutions.
Any combination of the above.

SF guidance for these different project types focuses on managing the “people and process” as well as the technology elements that most projects encounter. Because the needs and practices of technology teams are constantly evolving, the materials gathered into SF may be continually changed and expanded to keep pace. Additionally, the described SF may interact with a described operations framework (OF) to provide a smooth transition to the operational environment, which can facilitate long-term project success.

Today's business environment is characterized by complexity, global interconnectedness, and the acceleration of everything from customer demands to production methods to the rate of change itself. It is acknowledged that technology has contributed to each of these factors. That is, technology is often a source of additional complexity, supports global connections, and has been one of the major catalysts of change. Understanding and using the opportunities afforded by technology changes has become a primary cause of time and resource consumption in organizations.

Information systems and technology organizations (hereafter referred to as IT) have been frustrated by the time and effort it takes to develop and deploy business-driven solutions based on changing technology. They are increasingly aware of the negative impact and unacceptable business risks that poor quality results incur.

Technology development and deployment projects can be extremely complex, which contributes to their difficulty. Technology alone can be a factor in project failures; however, it is rarely the primary cause. Surprisingly, experience has shown that a successful project outcome is related more to the people and processes involved than to the complexity of the technology itself.

When the organization and management of people and processes breaks down, the following exemplary effects on projects can be observed:
Disconnected stakeholders and/or irregular, random, or insufficient business input into the process, resulting in critical needs going uncaptured.
Teams that do not understand the business problem, do not have clearly defined roles, and struggle to communicate internally and externally.
Lists of requirements that fail to address the real customer problems, cannot be implemented as stated, omit important features, and include unsubstantiated features.
A vague project approach that is not well understood by the participants, resulting in confusion, overwork, missing elements, and reduced solution quality.
Poor hand-off from project teams to operations, resulting in lengthy delays in realizing business value or costly workarounds to meet business demands.

Organizations that overcome these issues derive better results for their business through higher product and service quality, improved customer satisfaction, and working environments that attract the best people in the industry. These factors translate into a positive impact on bottom lines and improvements in the organization's strategic effectiveness.

Changing organizational behaviors to effectively address these challenges and achieve outstanding results is possible, but requires dedication, commitment, and leadership. To accomplish this, links need to be forged between IT and the business—links of understanding, accountability, collaboration, and communications. IT should take a leadership role to remove the barriers to its own success. The described SF was designed and built to provide the framework for this transition.

Certain implementations of the described SF provide operational guidance that enables organizations to achieve mission-critical system reliability, availability, supportability, and manageability of products and technologies.

Certain implementations of the described SF provide operational guidance in the form of sections, operations guides, assessment tools, best practices, case studies, templates, support tools, courseware, and services. This guidance addresses the people, process, technology, and management issues pertaining to complex, distributed, and heterogeneous technology environments.

Certain implementations of the described SF uses lessons learned through the evolution of the SF building on best practices for organizational structure and process ownership, and modeling the critical success factors used by partners and customers.

In certain implementations, SF and OF share foundational principles and core disciplines. In certain implementations however, they differ in their application of these principles and disciplines, each using unique team and process models and proven practices that are specific to their respective domains. The SF presents team structure and activities from a solution delivery perspective, while the OF presents team structure and activities from a service management perspective. In SF, the emphasis is on projects; in OF, it is on running the production environment. Thus, the SF and the OF provide an interface between the solution development domain and the solution operations domain.

SF and OF can be used in conjunction throughout the technology life cycle to successfully provide business-driven technology solutions—from inception to delivery through operations to final retirement. SF and OF are intended for use within the typical organizational structures that exist in businesses today; they collectively describe how diverse departments can best work together to achieve common business goals in a mutually supportive environment.

This description next focuses on hardware, software, media, networking, etc. examples that can be used to realize various implementations for facilitating the process of designing and developing a project. For example, tools and techniques as described further below may be implemented through such described computing or other devices.

### EXAMPLE OPERATING ENVIRONMENT FOR COMPUTER OR OTHER DEVICE

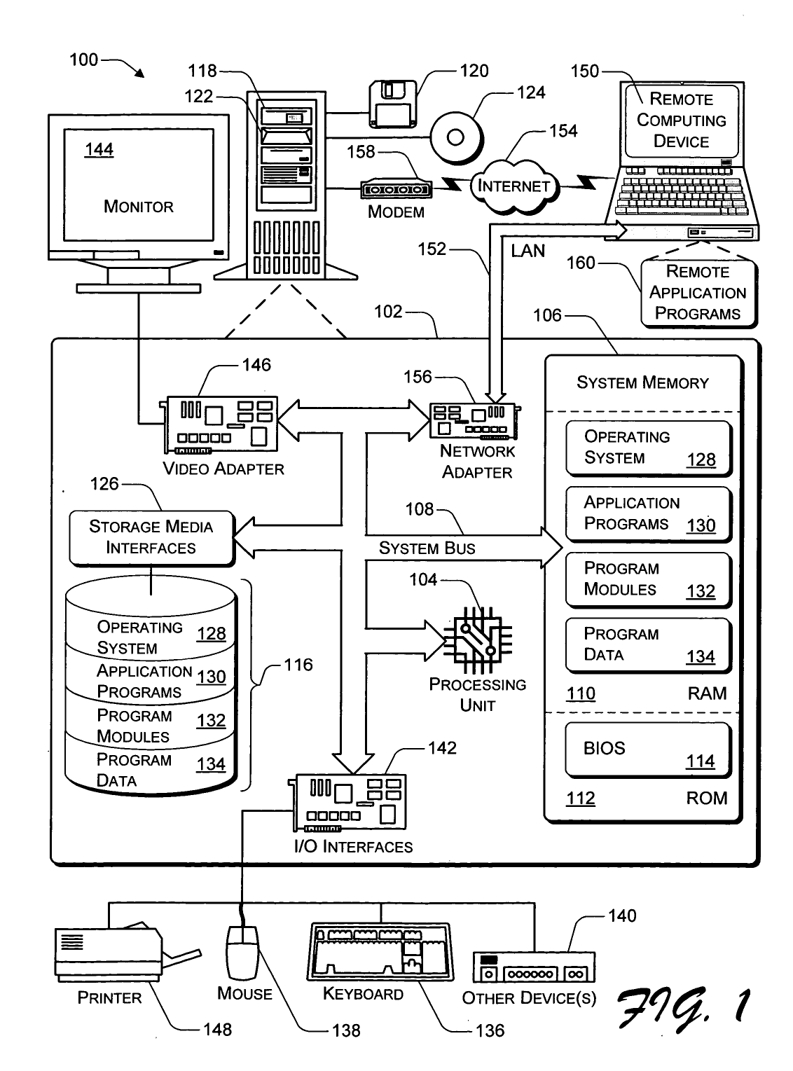

FIG. 1 illustrates an example computing (or general device) operating environment 100 that is capable of (fully or partially) implementing at least one system, device, apparatus, component, arrangement, protocol, approach, method, procedure, media, API, data structure, some combination thereof, etc. for facilitating the process of designing and developing a project as described herein. Operating environment 100 may be utilized in the computer and network architectures described below.

Operating environment 100, as well as device(s) thereof and alternatives thereto, may realize processor-implemented tools for facilitating the process of designing and developing a project. Furthermore, such devices may store a description of the exemplary models, disciplines/processes, data structures, etc. as described herein. Moreover, such devices may store all or part of the exemplary data structures as described herein with fields that are populated with data. Devices may also implement one or more aspects of facilitating the process of designing and developing a project in other alternative manners, including but not limited to, transmitting, receiving, modifying, displaying, etc. the exemplary data structures as described herein below.

Example operating environment 100 is only one example of an environment and is not intended to suggest any limitation as to the scope of use or functionality of the applicable device (including computer, network node, entertainment device, mobile appliance, general electronic device, etc.) architectures. Neither should operating environment 100 (or the devices thereof) be interpreted as having any dependency or requirement relating to any one or to any combination of components as illustrated in FIG. 1.

Additionally, facilitating the process of designing and developing a project may be implemented with numerous other general purpose or special purpose device (including computing system) environments or configurations. Examples of well known devices, systems, environments, and/or configurations that may be suitable for use include, but are not limited to, personal computers, server computers, thin clients, thick clients, personal digital assistants (PDAs) or mobile telephones, watches, hand-held or laptop devices, multiprocessor systems, microprocessor-based systems, set-top boxes, programmable consumer electronics, video game machines, game consoles, portable or handheld gaming units, network PCs, minicomputers, mainframe computers, network nodes, distributed or multi-processing computing environments that include any of the above systems or devices, some combination thereof, and so forth.

Implementations for facilitating the process of designing and developing a project may be described in the general context of processor-executable instructions. Generally, processor-executable instructions include routines, programs, protocols, objects, interfaces, components, data structures, etc. that perform and/or enable particular tasks and/or implement particular abstract data types. Moreover, facilitating the process of designing and developing a project, as described in certain implementations herein, may also be practiced in distributed processing environments where tasks are performed by remotely-linked processing devices that are connected through a communications link and/or network. Especially but not exclusively in a distributed computing environment, processor-executable instructions may be located in separate storage media, executed by different processors, and/or propagated over transmission media.

Example operating environment 100 includes a general-purpose computing device in the form of a computer 102, which may comprise any (e.g., electronic) device with computing/processing capabilities. The components of computer 102 may include, but are not limited to, one or more processors or processing units 104, a system memory 106, and a system bus 108 that couples various system components including processor 104 to system memory 106.

Processors 104 are not limited by the materials from which they are formed or the processing mechanisms employed therein. For example, processors 104 may be comprised of semiconductor(s) and/or transistors (e.g., electronic integrated circuits (ICs)). In such a context, processor-executable instructions may be electronically-executable instructions. Alternatively, the mechanisms of or for processors 104, and thus of or for computer 102, may include, but are not limited to, quantum computing, optical computing, mechanical computing (e.g., using nanotechnology), and so forth.

System bus 108 represents one or more of any of many types of wired or wireless bus structures, including a memory bus or memory controller, a point-to-point connection, a switching fabric, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, some combination thereof, and so forth.

Computer 102 typically includes a variety of processor-accessible media. Such media may be any available media that is accessible by computer 102 or another (e.g., electronic) device, and it includes both volatile and non-volatile media, removable and non-removable media, and storage and transmission media.

System memory 106 includes processor-accessible storage media in the form of volatile memory, such as random access memory (RAM) 140, and/or non-volatile memory, such as read only memory (ROM) 112. A basic input/output system (BIOS) 114, containing the basic routines that help to transfer information between elements within computer 102, such as during start-up, is typically stored in ROM 112. RAM 110 typically contains data and/or program modules/instructions that are immediately accessible to and/or being presently operated on by processing unit 104.

Computer 102 may also include other removable/non-removable and/or volatile/non-volatile storage media. By way of example, FIG. 1 illustrates a hard disk drive or disk drive array 116 for reading from and writing to a (typically) non-removable, non-volatile magnetic media (not separately shown); a magnetic disk drive 118 for reading from and writing to a (typically) removable, non-volatile magnetic disk 120 (e.g., a “floppy disk”); and an optical disk drive 122 for reading from and/or writing to a (typically) removable, non-volatile optical disk 124 such as a CD, DVD, or other optical media. Hard disk drive 116, magnetic disk drive 118, and optical disk drive 122 are each connected to system bus 108 by one or more storage media interfaces 126. Alternatively, hard disk drive 116, magnetic disk drive 118, and optical disk drive 122 may be connected to system bus 108 by one or more other separate or combined interfaces (not shown).

The disk drives and their associated processor-accessible media provide non-volatile storage of processor-executable instructions, such as data structures, program modules, and other data for computer 102. Although example computer 102 illustrates a hard disk 116, a removable magnetic disk 120, and a removable optical disk 124, it is to be appreciated that other types of processor-accessible media may store instructions that are accessible by a device, such as magnetic cassettes or other magnetic storage devices, flash memory, compact disks (CDs), digital versatile disks (DVDs) or other optical storage, RAM, ROM, electrically-erasable programmable read-only memories (EEPROM), and so forth. Such media may also include so-called special purpose or hard-wired IC chips. In other words, any processor-accessible media may be utilized to realize the storage media of the example operating environment 100.

Any number of program modules (or other units or sets of instructions/code, including templates) may be stored on hard disk 116, magnetic disk 120, optical disk 124, ROM 112, and/or RAM 140, including by way of general example, an operating system 128, one or more application programs 130, other program modules 132, and program data 134, including data structures. These program modules may define, create, modify, use, transfer/share, etc. templates and other process model deliverables, for example, as described herein for facilitating the process of designing and developing a project.

A user may enter commands and/or information into computer 102 via input devices such as a keyboard 136 and a pointing device 138 (e.g., a “mouse”). Other input devices 140 (not shown specifically) may include a microphone, joystick, game pad, satellite dish, serial port, scanner, and/or the like. These and other input devices are connected to processing unit 104 via input/output interfaces 142 that are coupled to system bus 108. However, input devices and/or output devices may instead be connected by other interface and bus structures, such as a parallel port, a game port, a universal serial bus (USB) port, an infrared port, an IEEE 1394 (“Firewire”) interface, an IEEE 802.11 wireless interface, a Bluetooth® wireless interface, and so forth.

A monitor/view screen 144 or other type of display device may also be connected to system bus 108 via an interface, such as a video adapter 146. Video adapter 146 (or another component) may be or may include a graphics card for processing graphics-intensive calculations and for handling demanding display requirements. Typically, a graphics card includes a graphics processing unit (GPU), video RAM (VRAM), etc. to facilitate the expeditious display of graphics and performance of graphics operations. In addition to monitor 144, other output peripheral devices may include components such as speakers (not shown) and a printer 148, which may be connected to computer 102 via input/output interfaces 142.

Computer 102 may operate in a networked environment using logical connections to one or more remote computers, such as a remote computing device 150. By way of example, remote computing device 150 may be a peripheral device, a personal computer, a portable computer (e.g., laptop computer, tablet computer, PDA, mobile station, etc.), a palm or pocket-sized computer, a watch, a gaming device, a server, a router, a network computer, a peer device, another network node, or another device type as listed above, and so forth. However, remote computing device 150 is illustrated as a portable computer that may include many or all of the elements and features described herein with respect to computer 102.

Logical connections between computer 102 and remote computer 150 are depicted as a local area network (LAN) 152 and a general wide area network (WAN) 154. Such networking environments are commonplace in offices, enterprise-wide computer networks, intranets, the Internet, fixed and mobile telephone networks, ad-hoc and infrastructure wireless networks, mesh networks, other wireless networks, gaming networks, some combination thereof, and so forth. Such networks and logical and physical communications connections are additional examples of transmission media.

When implemented in a LAN networking environment, computer 102 is usually connected to LAN 152 via a network interface or adapter 156. When implemented in a WAN networking environment, computer 102 typically includes a modem 158 or other component for establishing communications over WAN 154. Modem 158, which may be internal or external to computer 102, may be connected to system bus 108 via input/output interfaces 142 or any other appropriate mechanism(s). It is to be appreciated that the illustrated network connections are examples and that other manners for establishing communication link(s) between computers 102 and 150 may be employed.

In a networked environment, such as that illustrated with operating environment 100, program modules or other instructions that are depicted relative to computer 102, or portions thereof, may be fully or partially stored in a remote media storage device. By way of example, remote application programs 160 reside on a memory component of remote computer 150 but may be usable or otherwise accessible via computer 102. Also, for purposes of illustration, application programs 130 and other processor-executable instructions such as operating system 128 are illustrated herein as discrete blocks, but it is recognized that such programs, components, and other instructions (including data structures) reside at various times in different storage components of computing device 102 (and/or remote computing device 150) and are executed by processor(s) 104 of computer 102 (and/or those of remote computing device 150).

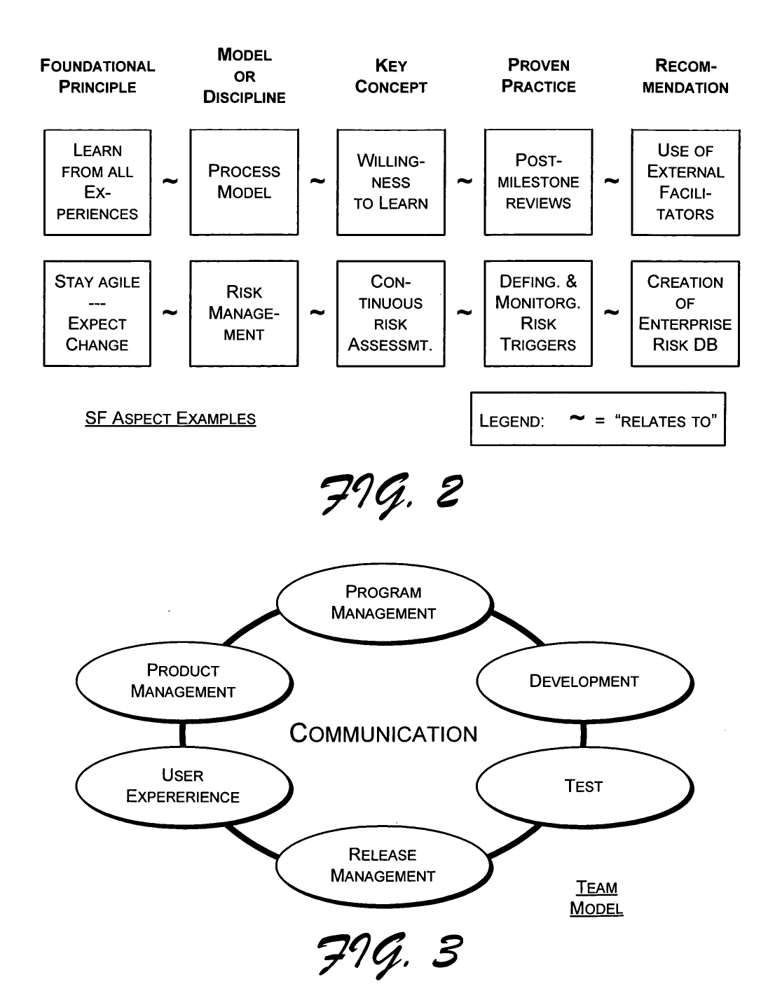

The devices, actions, formats, aspects, features, procedures, components, paradigms, data structures, etc. of FIGS. 2-42 are illustrated in diagrams that are divided into multiple blocks. However, the order, interconnections, interrelationships, layout, etc. in which FIGS. 2-42 are described and/or shown is not intended to be construed as a limitation, and any number of the blocks and/or other illustrated parts can be modified, combined, rearranged, augmented, omitted, etc. in any manner to implement one or more systems, methods, devices, procedures, media, apparatuses, arrangements, etc. for facilitating the process of designing and developing a software project. Furthermore, although the description herein includes references to specific implementations (including the general device of FIG. 1 above), the illustrated and/or described implementations can be realized in any suitable hardware, software, firmware, or combination thereof and using any suitable model(s), paradigm(s)/process(es), data representation(s), data structure sharing/communication/displaying mechanism(s), data structure organization(s), and so forth.

Overview

TERMINOLOGY AND EXAMPLE PRINCIPLES AND CONCEPTS

As a framework, the SF contains multiple components that can be used individually or adopted as an integrated whole. Collectively, they create a solid yet flexible approach to the successful execution of technology projects. The following non-exhaustive list includes optional aspects but provides example descriptions of some of these components:
SF foundational principles: The core principles upon which the framework is based. They express values and standards that are common to all elements of the framework.
SF models: Schematic descriptions or “mental maps” of the organization of project teams and processes (Team Model and Process Model—two of the major defining components of the framework).
SF disciplines: Areas of practice using a specific set of methods, terms, and approaches (Project Management, Risk Management, and Readiness Management—three other major defining components of the framework).
SF important concepts: Ideas that support SF principles and disciplines and are displayed through specific proven practices.
SF proven practices: Practices that have been proven effective in technology projects under a variety of real-world conditions.
SF recommendations: Suggested practices and guidelines in the application of the models and discipline.

FIG. 2 is a block diagram depicting exemplary underlying components for differing implementations. The example components of FIG. 2 help to demonstrate the interconnections between some of the principles, disciplines, concepts, etc. of the described SF.

One of the foundational principles of SF is to learn from all experiences. This is practiced deliberately at important milestones within the SF Process Model, where the important concept of willingness to learn is a requirement for the successful application of the principle. The willingness to learn concept is exercised in the project through the proven practice of post milestone reviews. On large and complex projects, a recommendation is the use of an objective outside facilitator to ensure a no-blame environment and to maximize learning.

Inversely, the proven practice of defining and monitoring risk triggers (recommends capturing them in an enterprise database or repository for cross-project use) is one application of the important concept of assessing risk continuously. These practices and concepts are part of the Risk Management Discipline exercised by members of the SF Team Model through phases of the SF Process Model, and employ the foundational principle of stay agile—expect change.

The foundational principles, models, and disciplines are further explained in the following sections, which provide a context for their relationship to each other.

Foundational Principles

At the core of SF are eight foundational principles:
Foster open communications
Work toward a shared vision
Empower team members
Establish clear accountability and shared responsibility
Focus on delivering business value
Stay agile, expect change
Invest in quality
Learn from all experiences.

Together, these principles express the SF philosophy, forming the basis of a coherent approach to organizing people and processes for projects undertaken to deliver technology solutions. They underlie both the structure and the application of SF. Although each principle has been shown to have merit on its own, many are interdependent in the sense that the application of one supports the successful application of another. When applied in tandem, they create a strong foundation that enables SF to work well in a wide range of projects varying in size, complexity, and type.

The following selective examples illustrate how SF applies each principle to SF models or disciplines. Note that this section does not attempt to describe every instance of the application of these principles within SF.

Foster Open Communications:

Technology projects and solutions are built and delivered by human activity. Each person on a project brings his or her own talents, abilities, and perspective to the team. In order to maximize members' individual effectiveness and optimize efficiencies in the work, information has to be readily available and actively shared. Without the open communication that provides broad access to such information, team members will not be able to perform their jobs effectively or make good decisions. As projects increase in size and complexity, the need for open communications becomes even more urgent. The sharing of information purely on a need-to-know basis (the historical norm) can lead to misunderstandings that impair the ability of a team to deliver a meaningful solution. The final result of such restricted communication can be inadequate solutions and unmet expectations.

Open Communications in SF:

SF proposes an open and inclusive approach to communications, both within the team and with important stakeholders, subject to practical restrictions such as time constraints and special circumstances. A free flow of information not only reduces the chances of misunderstandings and wasted effort, but also ensures that all team members can contribute to reducing uncertainties surrounding the project by sharing information that belongs to their respective domains.

Open and inclusive communication takes all forms within an SF project. The principle is basic to the SF Team Model, which integrates it into the description of role responsibilities. When used throughout the entire project life cycle, open communications fosters active customer, user, and operations involvement. Such involvement is also supported by incorporating the open communications concept into the definition of important milestones in the SF Process Model. Communication becomes the medium through which a shared vision and performance goals can be established, measured, and achieved.

Work Toward a Shared Vision:

All great teams share a clear and elevating vision. This vision is best expressed in the form of a vision statement. Although concise—no more than a paragraph or two—the vision statement describes where the business is going and how the proposed solution will help to achieve business value. Having a generally long-term and unbounded vision inspires the team to rise above its fear of uncertainty and preoccupation with the current state of things and to reach for what could be.

Without a shared vision, team members and stakeholders may have conflicting views of the project's goals and purpose and be unable to act as a cohesive group. Unaligned effort will be wasteful and potentially debilitating to the team. Even if the team produces its deliverable, members will have difficulty assessing their success because it will depend on which vision they use to measure it. Working toward a shared vision requires the application of many of the other principles that are essential to team success. Principles of empowerment, accountability, communication, and focus on business value each play a part in the successful pursuit of a shared vision, which can be difficult and courageous work.

Shared Vision in SF:

Shared vision is one of the important components of the SF Team and Process models, emphasizing the importance of understanding the project goals and objectives. When all participants understand the shared vision and are working toward it, they can align their own decisions and priorities (representing the perspectives of their roles) with the broader team purpose represented by that vision. The iterative nature of the SF Process Model requires that a shared vision exist to guide a solution toward the ultimate business result. Without this vision, the business value of a solution will lean toward mediocrity.

A shared vision for the project is fundamental to the work of the team. The process of creating that vision helps to clarify goals and bring conflicts and mistaken assumptions to light so they can be resolved. Once agreed upon, the vision motivates the team and helps to ensure that all efforts are aligned in service of the project goal. It also provides a way to measure success. Clarifying and getting commitment to a shared vision is so important that it is the primary objective of the first phase of any SF project.

Empower Team Members:

In projects where certainty is the norm and each individual's contribution is prescribed and repeatable, less-empowered teams can survive and be successful. Even in these conditions, however, the potential value of the solution is not likely to be realized to the extent that it could be if all team members were empowered. Lack of empowerment not only diminishes creativity but also reduces morale and thwarts the ability to create high-performance teams. Organizations that single out individuals for praise or blame undermine the foundation for empowering a team.

In an effective team, all members are empowered to deliver on their own commitments and to feel confident that other team members will also meet theirs. Likewise, customers are able to assume that the team will meet its commitments and plan accordingly. Building a culture that supports and nourishes empowered teams and team members can be challenging and takes a commitment by the organization.

Empowered Team Members in SF:

Empowerment has a profound impact on SF. The SF Team Model is based on the concept of a team of peers and the implied empowered nature of such team members. Empowered team members hold themselves and each other accountable to the goals and deliverables of the project. Empowered teams accept responsibility for the management of project risks and team readiness and therefore proactively manage such risk and readiness to ensure the greatest probability of success.

Creating and managing schedules provides another example of team empowerment. SF advocates bottom-up scheduling, meaning that the people doing the work make commitments as to when it will be done. The result is a schedule that the team can support because it believes in it. SF team members are confident that any delays will be reported as soon as they are known, thereby freeing team leads to play a more facilitative role, offering guidance and assistance when it is most critical. The monitoring of progress is distributed across the team and becomes a supportive rather than a policing activity.

Establish Clear Accountability and Shared Responsibility:

Failure to establish clearly understood lines of accountability and responsibility on projects often results in duplicated efforts or missing deliverables. These are symptoms of dysfunctional teams that are unable to make progress in spite of the amount of effort applied. Equally challenging are autocratically run projects that stifle creativity, minimize individual contributions, and disempower teams. In technology projects where human capital is the primary resource, this is a recipe for failure. The success of cross-functional teams can be facilitated with clear accountability and shared responsibilities.

Accountability and Responsibility in SF:

The SF Team Model is based on the premise that each team role presents a unique perspective on the project. Yet, for project success, the customer and other stakeholders need an authoritative single source of information on project status, actions, and current issues. To resolve this dilemma, the SF Team Model combines clear role accountability to various stakeholders with shared responsibility among the entire team for overall project success.

Each team role is accountable to the team itself, and to the respective stakeholders, for achieving the role's quality goal. In this sense, each role is accountable for a share of the quality of the eventual solution. At the same time, overall responsibility is shared across the team of peers because any team member has the potential to cause project failure. It is interdependent for two reasons: first, out of necessity, since it is impossible to isolate each role's work; second, by preference, since the team will be more effective if each role is aware of the entire picture. This mutual dependency encourages team members to comment and contribute outside their direct areas of accountability, ensuring that the full range of the team's knowledge, competencies, and experience can be applied to the solution.

Focus on Delivering Business Value:

Projects that skip, rush through, or are not deliberate in defining the business value of the project suffer in later stages as the sustaining impetus for the project becomes clouded or uncertain. Action without purpose becomes difficult to channel toward productive results and eventually loses momentum at the team level and within the organization. This can result in everything from missed delivery dates, to delivery of something that does not meet even the minimum customer requirements, to cancelled projects.

By focusing on improving the business, team members' activities will become much more likely to do just that. While many technology projects focus on the delivery of technology, technology is not delivered for its own sake-solutions should provide tangible business value.

Delivering Business Value in SF:

Successful solutions, whether targeted at organizations or individuals, should satisfy some basic need and deliver value or benefit to the purchaser. By combining a focus on business value with shared vision, the project team and the organization can develop a clear understanding of why the project exists and how success will be measured in terms of business value to the organization.

The SF Team Model advocates basing team decisions on a sound understanding of the customer's business and on active customer participation throughout the project. The Product Management and User Experience roles act as the customer and user advocates to the team, respectively. These roles are often undertaken by members of the business and user communities.

A solution does not provide business value until it is fully deployed into production and used effectively. For this reason, the life cycle of the SF Process Model includes both the development and deployment into production of a solution, thereby ensuring realization of business value. The combination of a strong multi-dimensional business representation on the team with explicit focus on impact to the business throughout the process is how SF ensures that projects fulfill the promise of technology.

Stay Agile, Expect Change:

Traditional project management approaches and “waterfall” solution delivery process models assume a level of predictability that is not as common on technology projects as it might be in other industries. Often, neither the outcome nor the means to deliver it is well understood, and exploration becomes a part of the project. The more an organization seeks to maximize the business impact of a technology investment, the more they venture into new territories. This new ground is inherently uncertain and subject to change as exploration and experimentation results in new needs and methods. To pretend or demand certainty in the face of this uncertainty would, at the very least, be unrealistic and, at the most, dysfunctional.

Agility in SF:

SF acknowledges the chaordic (meaning a combination of chaos and order, as coined by Dee Hock) nature of technology projects. It makes the fundamental assumption that continual change should be expected and that it is impossible to isolate a solution delivery project from these changes. In addition to changes due to purely external origins, SF advises teams to expect changes from stakeholders and even the team itself. For instance, it recognizes that project requirements can be difficult to articulate at the outset and that they will often undergo significant modifications as the possibilities become clearer to participants.

SF has designed both its Team and Process models to anticipate and manage change. The SF Team Model fosters agility to address new challenges by involving all team roles in important decisions, thus ensuring that issues are explored and reviewed from all critical perspectives. The SF Process Model, through its iterative approach to building project deliverables, provides a clear picture of the deliverable's status at each progressive stage. The team can more easily identify the impact of any change and deal with it effectively, minimizing any negative side-effects while optimizing the benefits.

Recent years have seen the rise of specific approaches to developing software that seek to maximize the principle of agility and preparedness for change. Sharing this philosophy, SF encourages the application of these approaches where appropriate. SF and agile methodologies are discussed later in this section.

Invest in Quality:

Quality, or lack thereof, can be defined in many ways. Quality can be seen simply as a direct reflection of the stability of a product or viewed as the complex trade-off of delivery, cost, and functionality. However you define it, quality is something that doesn't happen accidentally. Efforts need to be explicitly applied to ensure that quality is embedded in all products and services that an organization delivers.

Entire industries have evolved out of the pursuit of quality, as witnessed by the multitude of books, classes, theories, and approaches to quality management systems. Promoting effective quality involves a continual investment in the processes, tools, and guiding ideas of quality. All efforts to improve quality include a defined process for building quality into products and services through the deliberate evaluation and assessment of outcomes, that is, measurement. Enabling these processes with measurement tools strengthens them by developing structure and consistency.

Most importantly, such efforts encourage teams and individuals to develop a mindset centered around quality improvement. The idea of quality improvement complements the basic human desires for taking pride in our work, learning, and empowerment.

An investment in quality therefore becomes an investment in people, as well as in processes and tools. Successful quality management programs recognize this and incorporate quality into the culture of the organization. They all emphasize the need to continually invest in quality because the expectations of quality over time are increasing, and standing still is not a viable option.

Investing in Quality in SF:

The SF Team Model holds everyone on the team responsible for quality while committing one role to managing the processes of testing. The Test Role encourages the team to make the necessary investments throughout a project's duration to ensure that the level of quality meets all stakeholders' expectations. In the SF Process Model, as project deliverables are progressively produced and reviewed, testing builds in quality—starting in the first phase of the project life cycle and continuing through each of its five phases. The model defines important milestones and suggests interim milestones that measure the solution against quality criteria established by the team, led by the Test Role, and stakeholders. Conducting reviews at these milestones ensures a continuing focus on quality and provides opportunities to make midcourse corrections if necessary.

An important ingredient for instilling quality into products and services is the development of a learning environment. SF emphasizes the importance of learning through the Readiness Management Discipline, which identifies the skills needed for a project and supports their acquisition by team members. Obtaining the appropriate skills for a team represents an investment; time taken out of otherwise productive work hours plus funds for classroom training, courseware, mentors, or even consulting, can add up to a significant monetary commitment. The Readiness Management Discipline promotes up-front investment in staffing teams with the right skills, based on the belief that an investment in skills translates into an investment in quality.

Learn from All Experiences:

When you look at the marginal increase in the success rate of technology projects and when you consider that the major causes of failure have not changed over time, it would seem that as an industry we are failing to learn from our failed projects. Taking time to learn while on tight deadlines with limited resources is difficult to do, and tougher to justify, to both the team and the stakeholders. However, the failure to learn from all experiences is a guarantee that we will repeat them, as well as their associated project consequences.

Capturing and sharing both technical and non-technical best practices is fundamental to ongoing improvement and continuing success because it:
Allows team members to benefit from the success and failure experiences of others.
Helps team members to repeat successes.
Institutionalizes learning through techniques such as reviews and retrospectives.

Learning from All Experiences in SF:

SF assumes that keeping focus on continuous improvement through learning will lead to greater success. Knowledge derived from one project that then becomes available for others to draw upon in the next project will decrease uncertainty surrounding decision-making based on inadequate information. Planned milestone reviews throughout the SF Process Model help teams to make midcourse corrections and avoid repeating mistakes. Additionally, capturing and sharing this learning creates best practices from the things that went well.

SF emphasizes the importance of organizational- or enterprise-level learning from project outcomes by recommending externally facilitated project postmortems that document not only the success of the project, but also the characteristics of the team and process that contributed to its success. When lessons learned from multiple projects are shared within an environment of open communication, interactions between team members take on a forward, problem-solving outlook rather than one that is intrinsically backward and blaming.

### SF MODEL EXAMPLES

SF models represent the application of the above-described foundational principles to the “people and process” aspects of technology projects—those areas that have the greatest impact on project success. The SF Team Model and the SF Process Model are schematic descriptions that visually show the logical organization of project teams around role clusters and project activities throughout the project life cycle. These models embody the foundational principles and incorporate the core disciplines; their details are refined by important concepts and their processes are applied through proven practices and recommendations. As each model is described, the underlying foundational principles and disciplines can be recognized.

Team Model

FIG. 3 is a block diagram depicting an exemplary team model. The SF Team Model defines the roles and responsibilities of a team of peers working on information technology projects in interdependent multidisciplinary roles. FIG. 3 is a logical depiction of the model.

The SF Team Model is based on the premise that any technology project should achieve certain important quality goals in order to be considered successful. Reaching each goal requires the application of a different set of related skills and knowledge areas, each of which is embodied by a team role cluster (commonly shortened to role herein). The related skills and knowledge areas are called functional areas and define the domains of each role. The Program Management Role Cluster, for example, contains the functional areas of project management, solution architecture, process assurance, and administrative services. Collectively, these roles have the breadth to meet all of the success criteria of the project; the failure of one role to achieve its goals jeopardizes the project. Therefore, each role is considered equally important in this team of peers, and major decisions are made jointly, with each role contributing the unique perspective of its representative constituency. The associated goals and roles are shown in the following table:

### SF Team Model and Quality Goals

| Quality Goal | SF Team Role Cluster |
|---|---|
| Delivery within project | Program Management |
| constraints | |
| Delivery to product specifications | Development |
| Release after addressing all issues | Test |
| Smooth deployment and ongoing | Release Management |
| management | |
| Enhanced user performance | User Experience |
| Satisfied customers | Product Management |

The SF Team Model represents, in part, the compilation of industry best practices for empowered teamwork and technology projects that focus on achieving these goals. They are then applied within the SF Process Model to outline activities and create specific deliverables to be produced by the team. These primary quality goals both define and drive the team.

Note that one role is not the same as one person—multiple people can take on a single role, or an individual may take on more than one role—for example, when the model needs to be scaled down for small projects. What's important in the adoption of the SF Team Model is that all of the quality goals should be represented on the team and that the various project stakeholders should know who on the team is accountable for them.

The SF Team Model explains how this combination of roles can be used to scale up to support large projects with large numbers of people by defining two types of sub-teams: function and feature. Function teams are unidisciplinary sub-teams that are organized by functional role. The Development Role is often filled by one or more function teams. Feature teams, the second type, are multidisciplinary sub-teams that are created to focus on building specific features or capabilities of a solution.

The SF Team Model is perhaps the most distinctive aspect of SF. At the heart of the Team Model is the fact that technology projects should embrace the disparate and often juxtaposed quality perspectives of various stakeholders, including operations, the business, and users. The SF Team Model fosters this melding of diverse ideas, thus recognizing that technology projects are not exclusively an IT effort.

Process Model

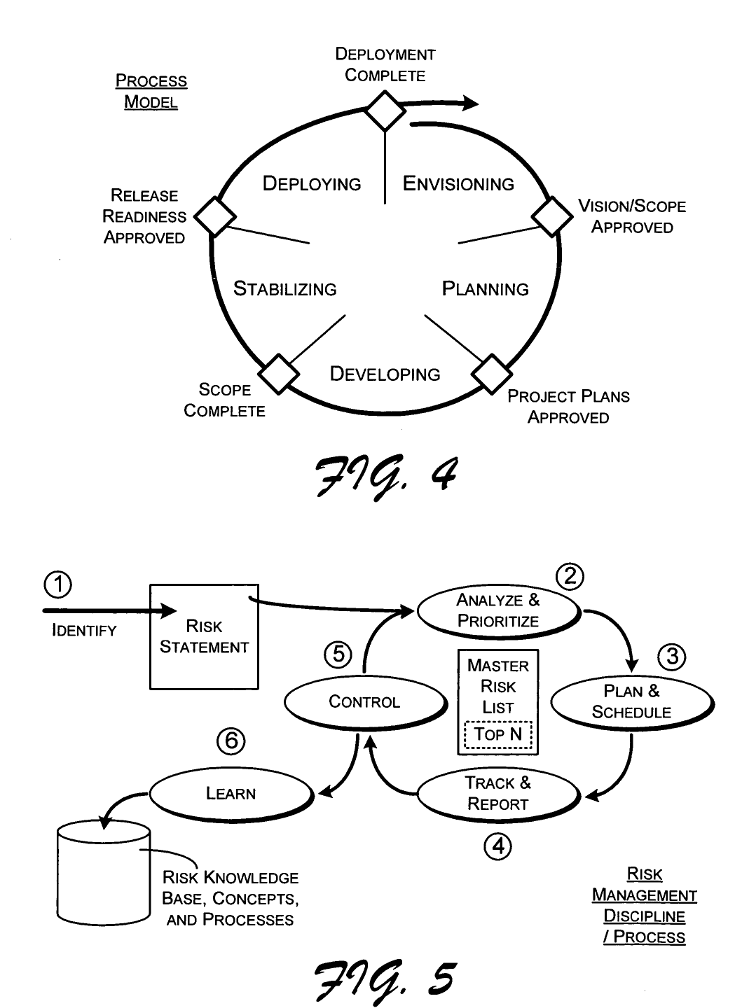

FIG. 4 is a block diagram depicting an exemplary process model. Every project goes through a life cycle, a process that includes all of the activities in the project that take place up to completion and transition to an operational status. The main function of a life cycle model is to establish the order in which project activities are performed. The appropriate life cycle model can streamline a project and help ensure that each step moves the project closer to successful completion. A simple view of the SF Process Model life cycle is shown in FIG. 4.

The SF Process Model combines concepts from the traditional waterfall and spiral models to capitalize on the strengths of each. The Process Model combines the benefits of milestone-based planning from the waterfall model with the incrementally iterating project deliverables from the spiral model.

The SF Process Model is based on phases and milestones. At one level, phases can be viewed simply as periods of time with an emphasis on certain activities aimed at producing the relevant deliverables for that phase. However, SF phases are more than this; each has its own distinct character and the end of each phase represents a change in the pace and focus of the project. The phases can be viewed successively as exploratory, investigatory, creative, single-minded, and disciplined.

Milestones are review and synchronization points for determining whether the objectives of the phase have been met. Milestones provide explicit opportunities for the team to adjust the scope of the project to reflect changing customer or business requirements and to accommodate risks and issues that may materialize during the course of the project. Additionally, milestones bring closure to each phase, enable a shift of responsibilities for directing many activities, and encourage the team to take a new perspective more appropriate for the goal of the following phase. Closure is demonstrated by the delivery of tangible outputs that the team produces during each phase and by the team and customer reaching a level of consensus around those deliverables. This closure, and the associated outputs, becomes the initiating point for the next phase.

The SF Process Model allows a team to respond to customer requests and to address changes in a solution midcourse, when necessary. It also allows a team to deliver important portions of the solution faster than would otherwise be possible by focusing on the highest priority features first and moving less critical ones to subsequent releases. The Process Model is a flexible component of SF that has been used successfully to improve project control, minimize risk, improve product quality, and increase development speed. The five phases of the SF Process Model make it flexible enough to be used for any technology project, whether application development, infrastructure deployment, or a combination of the two.

The integration of the SF Process Model with the SF Team Model makes a formidable combination for project success if effectively instilled into an organization. Collectively, they provide flexible but defined roadmaps for successful project delivery that take into account the uniqueness of an organization's culture, project types, and personnel strengths.

### SF DISCIPLINE EXAMPLES

The SF disciplines—Project Management, Risk Management, and Readiness Management—are areas of practice that employ a specific set of methods, terms, and approaches. These disciplines are important to the functioning of the SF Team and Process models. SF has embraced particular disciplines that align with its foundational principles and models and has adapted them as needed to complement other elements of the Framework. In general, SF has not tried to recreate these disciplines in full, but rather to highlight how they are adapted when applied in the context of SF. The disciplines are shared by SF and OF, and it is anticipated that additional disciplines will be adapted in the future.

SF Project Management Discipline

SF has a distributed team approach to project management that relates to the foundational principles and models stated above. In SF, project management practices improve accountability and allow for a great range of scalability from small projects up to very large, complex projects.

There are several distinct characteristics of the SF approach to project management that create the SF Project Management Discipline. Some of these are stated here and discussed more fully below:
Project management is a discipline embodied in a set of widely accepted knowledge areas and activities, as opposed to a role or title.
Most of the responsibilities of the role commonly known as “project manager” are encompassed in the SF Program Management Role Cluster.
In larger projects requiring scaled up SF teams, project management activities occur at multiple levels.
Some very large or complex projects require a dedicated project manager or project management team.
In SF, more focus is placed on the peer nature of the roles—for example, in consensus decision making. By contrast, many traditional project management methods stress the project manager as the important decision-maker with control and authority over the rest of the team. In SF, project management activities, such as planning and scheduling, are delegated to the most appropriate roles.

SF, as a framework for successful technology projects, acknowledges that project management is accomplished through responsibilities and activities that extend beyond those belonging to one individual on a team to all lead team members and the SF Program Management Role Cluster. The more widespread the need for these activities and responsibilities across the team, the greater the ability to create highly collaborative self-managing teams. However, the majority of the project management activities and responsibilities are encompassed in the SF Program Management Role Cluster. This role cluster focuses on the process and constraints of the project and on important activities in the discipline of project management.

In smaller projects, all the functional responsibilities are typically handled by a single person in the Program Management Role Cluster. As the size and complexity of a project grows, the Program Management Role Cluster may be broken out into two branches of specialization: one dealing with solution architecture and specifications, and the other dealing with project management. For projects that require multiple teams or layers of teams, the project management activities are designed to scale and allow for effective management of any single or aggregated team. This may require certain project management practices to be performed at multiple levels while other activities are contained within a specific team or level of the overall project and team. The exact distribution of project management responsibilities depends in a large part on the scale and complexity of the project.

SF Risk Management Discipline

Technology projects are undertaken by organizations to support their ventures into new businesses and technology territory with an anticipated return on their investment. Risk management is a response to the uncertainty inherent in technology projects, and inherent uncertainty means inevitable risks. This does not mean, however, that attempting to recognize and manage risks needs to get in the way of the creative pursuit of opportunity. Whereas many technology projects fail to effectively manage risk or do not consider risk management necessary for successful project delivery, SF uses risk management as an enabler of project success. SF views risk management as one of the SF disciplines that needs to be integrated into the project life cycle and embodied in the work of every role. Risk-based decision making is fundamental to SF. And by ranking and prioritizing risks, SF ensures that the risk management process is effective without being burdensome.

Proactive risk management means that the project team has a defined and visible process for managing risks. The project team makes an initial assessment of what can go wrong, determines the risks that should be dealt with, and then implements strategies for doing so (action plans). The assessment activity is continuous throughout the project and feeds into decision making in all phases. Identified risks are tracked (along with the progress of their action plans) until they are either resolved or turn into issues and are handled as such. FIG. 5 shows a diagram of an exemplary proactive risk management process.

FIG. 5 is a block diagram depicting an exemplary risk management discipline/process. This six-step risk management discipline or process is, for example, integrated with the Team Model through definitions of role responsibilities and with the Process Model through specified actions and milestone deliverables, creating a comprehensive approach to project risk management.

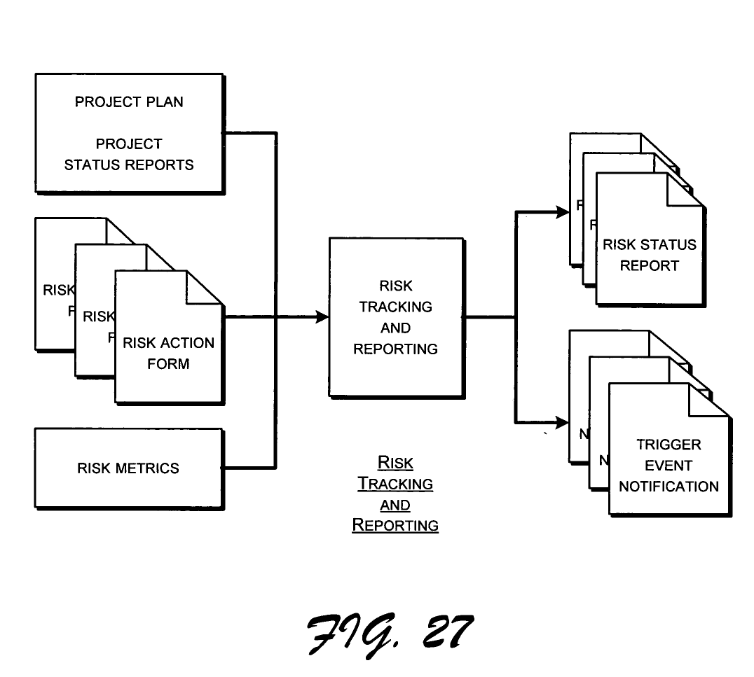

The process usually terminates with the learning step—the capture and retention of the project risks, mitigation and contingency strategies, and executed actions for future review and analysis. This knowledge warehouse of risk-related information is an important part of creating a learning organization that can utilize and build upon past project knowledge. The six steps, as well as risk statements, master risk lists, and risk knowledge bases, are described further herein below with particular reference to FIGS. 22-29.

SF's approach to risk management is distinctive in that the measure of success is what is done differently, rather than what forms are filled in. In many projects, risk management is paid lip-service and either ignored entirely (perhaps after an initial cursory risk assessment) or viewed as a bureaucratic ritual. SF avoids an overly-burdensome process, but places risk management at the heart of the project's decision making.

SF Readiness Management Discipline

The Readiness Management Discipline of SF defines readiness as a measurement of the current versus the desired state of knowledge, skills, and abilities (KSAs) of individuals in an organization. This measurement concerns the real or perceived capabilities of these individuals at any point during the ongoing process of planning, building, and managing solutions.

Readiness can be measured at many levels—organizational, team, and individual. At the organizational level, readiness refers to the current state of the collective measurements of individual capabilities. This information is used in both strategic planning and evaluating the capability to achieve successful adoption and realization of a technology investment. Readiness management guidance applies to such areas as process improvement and organizational change management.

The SF Readiness Management Discipline, however, focuses on the readiness of project teams. It provides guidance and processes for defining, assessing, changing, and evaluating the knowledge, skills, and abilities necessary for project execution and solution adoption.

Each person performing a specific role on the project team is preferably capable of fulfilling the important functions that go with that role. Individual readiness is the measurement of each team member's current state with regard to the knowledge, skills, and abilities needed to meet the responsibilities required by his or her assigned role. Readiness management is intended to ensure that team members are fully qualified for the work they will need to perform.

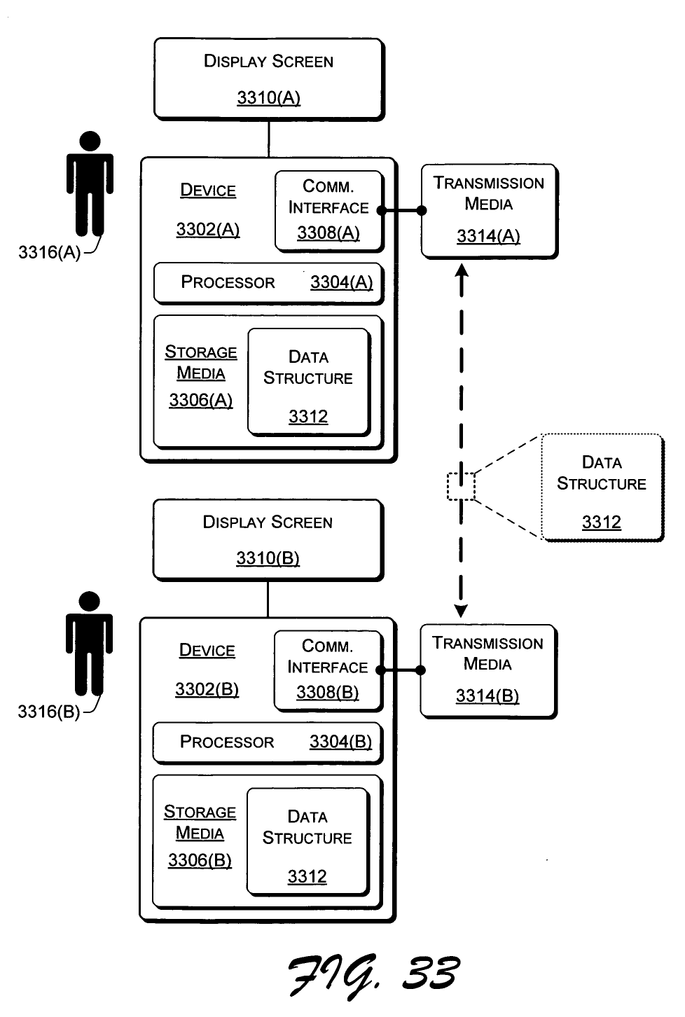

FIG. 6 is a block diagram depicting an exemplary readiness management discipline or process. The depicted exemplary readiness management discipline has four phases: define, assess, change, and evaluate. These four phases, as well as a knowledge, skills, and abilities (KDA) database, are described further herein below with particular reference to FIGS. 30-32.

The SF Readiness Management Discipline reflects the principles of open communication, investing in quality, and learning. This discipline acknowledges that projects inherently change the environment in which they are developed as well as the environment into which they are delivered. By proactively preparing for that future state, the organization puts itself in a position for better delivery as well as faster realization of the business value, the ultimate promise of the project.

Exemplary SF Process Model

The described SF process model describes a high-level sequence of activities for building and deploying IT solutions. Rather than prescribing a specific series of procedures, it is flexible enough to accommodate a broad range of IT projects. It combines two models: the waterfall and the spiral. This SF model can cover the life cycle of a solution from project inception to live deployment. This helps project teams focus on customer business value, which is pertinent because no value is realized until the solution is deployed and in operation.

The described SF is a milestone-driven process. Milestones are points in the project when important deliverables have been completed and can be reviewed. At each milestone, many important questions about the project are asked and answered, such as: Does the team agree on the project scope? Have we planned enough to proceed? Have we built what we said we would build? Is the solution working properly for the customer?

The SF process model is designed to accommodate changing project requirements by moving iterations through short development cycles and incremental versions of the solution.

A number of supporting practices are recommended that help project teams use the process model successfully.

Overview of Frameworks

To maximize the success of IT projects, packaged guidance on effectively designing, developing, deploying, operating, and supporting solutions is described herein. The guidance is organized into two complementary and well-integrated bodies of knowledge, or “frameworks.” These are the afore-mentioned SF and OF.

The SF provides a flexible and scalable framework for any size organization or project team. The SF guidance consists of principles, models, and disciplines for managing the people, process, technology elements, and their tradeoffs that most projects encounter.

The OF provides technical guidance that enables organizations to achieve mission-critical system reliability, availability, supportability, and manageability of IT solutions. The OF guidance addresses the people, process, technology, and management issues pertaining to operating complex, distributed, heterogeneous IT environments.

Process models establish the order of project activities. In this way, they can represent the entire life cycle of a project. Currently, businesses employ a variety of process models. The SF process model effectively combines some of the principles of other varied process models into a single model that may be applied across any project type—a phase-based, milestone-driven, and iterative model. This model may be applied to traditional application development environments, but is equally appropriate for the development and deployment of enterprise solutions for e-commerce, web-distributed applications, and other multi-faceted initiatives that may appear in the future.

Other Process Models

The waterfall model and the spiral model are used in the IT industry:

Waterfall Mode

FIG. 7 is a block diagram depicting an exemplary waterfall model. Milestones are shown as diamonds and phases are shown as arrows.

This model uses milestones as transition and assessment points. In the waterfall model, each set of tasks should be completed before the next phase can begin. The waterfall works best for projects where it is feasible to clearly delineate a fixed set of unchanging project requirements at the start. Fixed transition points between phases facilitate schedule tracking and assignment of responsibilities and accountability.

Spiral Model

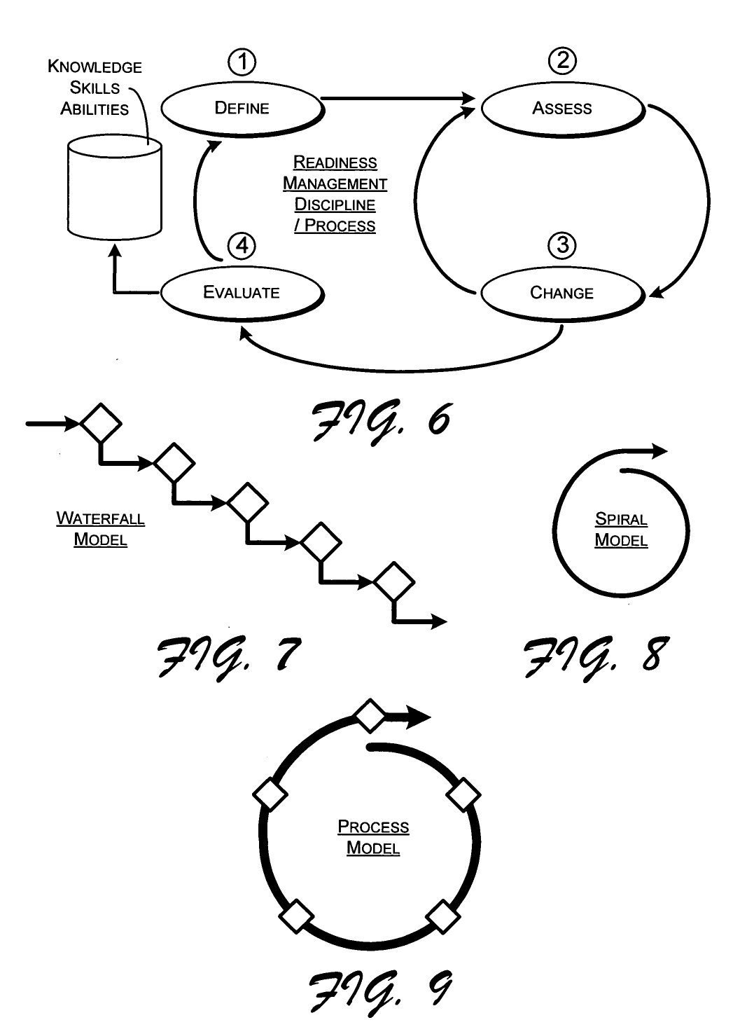

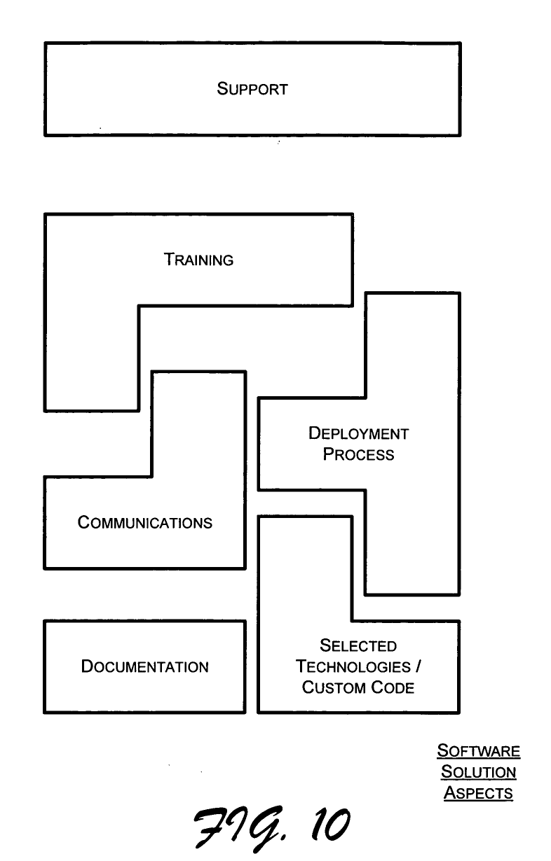

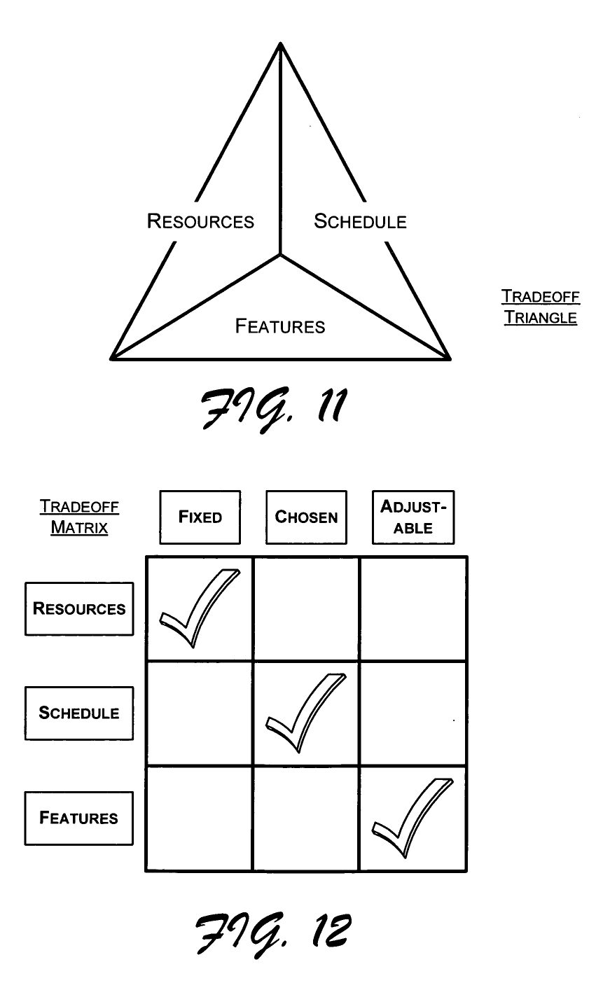

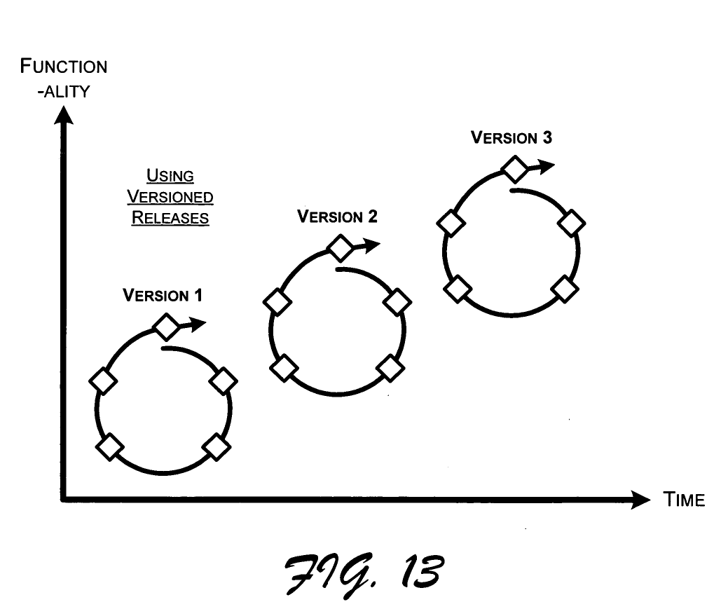

FIG. 8 is a block diagram depicting an exemplary spiral model. The spiral model is shown as a nearly-circular spiral.

This model focuses on the continual need to refine the requirements and estimates for a project. The spiral model can be very effective when used for rapid application development on a very small project. This approach stimulates great synergy between the development team and the customer because the customer provides feedback and approval for all stages of the project. However, since the model does not incorporate clear checkpoints, the development process may become chaotic.

### PROCESS MODEL EXAMPLE

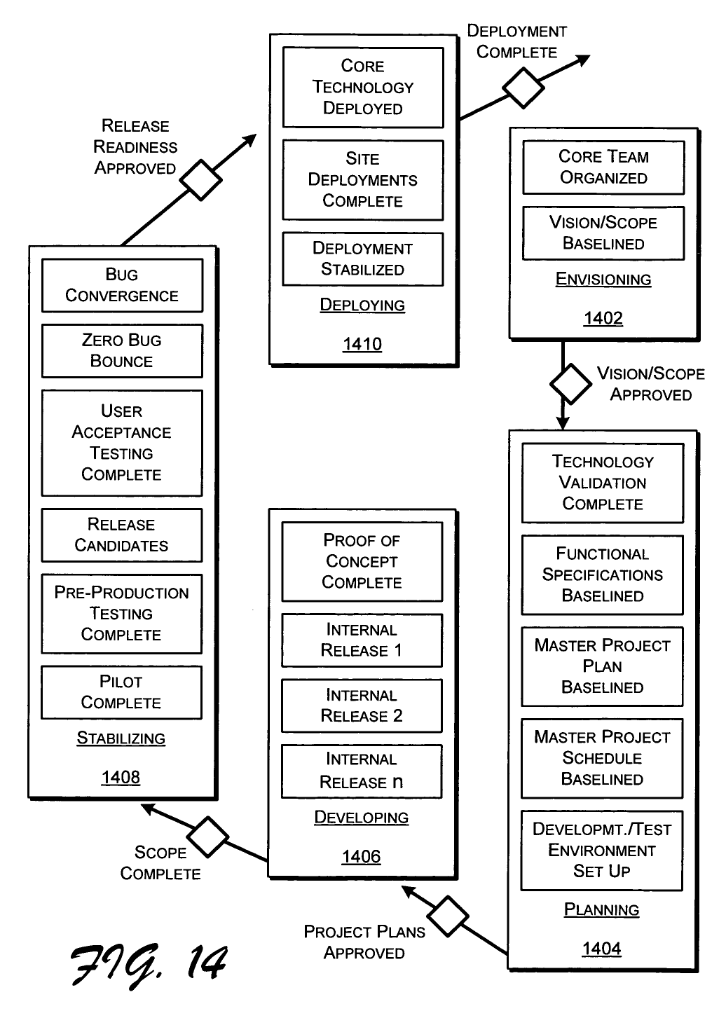

FIG. 9 is a block diagram depicting an exemplary hybrid process model. In certain exemplary implementations, an SF process model as shown in FIG. 9, may be used which, for example, combines the some principles of the waterfall and spiral models. It derives the benefits of predictability from the milestone-based planning of the waterfall model, as well as the benefits of feedback and creativity from the spiral model. Details of the milestones and phases, as illustrated in FIG. 4, are discussed herein below.

Exemplary Underlying SF Principles

The SF process model is associated with at least the following four SF principles:

(1) Work Toward a Shared Vision

Fundamental to the success of any joint activity is that team members and the customer have a shared vision—that is, a clear understanding as to what the goals and objectives are for the solution. Team members and customers all bring with them assumptions as to what the activity is going to do for the organization. A shared vision brings those assumptions to light and ensures that all participants are working to accomplish the same goal.

Clarifying and getting commitment to a shared vision is so important that the SF process model designates a phase (envisioning) and a major milestone (vision/scope approved) for that purpose.

(2) Stay Agile—Expect Things to Change

Traditional project management disciplines and the waterfall process model assume that requirements can be clearly articulated at the outset and that they will not change significantly during a project life cycle. SF, in contrast, makes the fundamental assumption that continual change should be expected and managed.

(3) Focus on Delivering Business Value

Successful solutions, whether targeted at organizations or individuals, should satisfy some basic need and deliver value or benefit to the customer. For individuals, the benefit may be in satisfying some emotional need, such as most computer games. For organizations, however, the important driver is business value.

A solution does not provide value until it is fully deployed into live production. For this reason, the life cycle of the SF process model includes both development and deployment phases of a solution.

(4) Foster Open Communication

Historically many organizations and projects have operated purely on a need-to-know basis. In other words, information is only given to people who can prove that they should have the information to do their job. This approach frequently leads to misunderstandings which impair the ability of a team to deliver a successful solution.

The SF process model prescribes an open and honest approach to communications, both within the team and with important stakeholders. A free flow of information not only reduces the chances of misunderstandings and wasted effort; it also ensures that all team members can contribute toward reducing uncertainties surrounding the project.

For these reasons, the SF process model provides review points. Documented deliverables keep the progress of the project visible and well communicated among the team, stakeholders, and the customer.

Exemplary Concepts for the SF Process Model

(1) Customers: SF distinguishes between the customer and the user. For consumer software products, games, and Web applications, the customer and the user can be the same.

For business solutions, however, the customer is the person or organization that commissions the project, provides funding, and who expects to get business value from the solution. Users are the people who interact with the solution in their work. For example, a team is building a corporate expense reporting system that allows employees to submit their expense reports using the company intranet. The users are the employees, while the customer is a member of management charged with establishing the new system.

(2) Customer participation: Customer involvement in IT projects is important for success. The SF process model allows the customer many opportunities to shape and modify requirements and to set checkpoints to review progress. These activities require time and commitment from the customer.

(3) Internal or external customers: Depending on the circumstances of the project, the customer and the team may not belong to the same organization. For example, the customer may be a “buyer” contracting with an external “supplier” (which may be a virtual team of various partnering organizations).

(4) Contracts: SF acknowledges that the contractual and legal relationship between a customer, its suppliers, and the solution team is very important and should be managed carefully. This approach, called Procurement Management, is described in the SF Project Management Discipline section. However, as there are many sources of guidance available on this subject, this topic is not covered in depth.

(5) Stakeholders: Stakeholders are individuals or groups who have an interest at stake in the outcome of the project. Their goals or priorities are not always identical to those of the customer. Each stakeholder will have requirements or features that are important to them. Responsibilities of the product management role include identifying the important stakeholders of the project, taking their needs into account, and managing stakeholder relationships. Examples of stakeholders commonly found in IT projects include: Departmental managers whose staff and business processes will be changed by the solution the team is building; IT operations staff that will be responsible for running and supporting the solution or who run other applications that may be affected by the solution; and Functional managers who are contributing resources to the project team.

Solution Description

In every day use, a solution is simply a strategy or method to solve a problem. It has become common marketing jargon in the IT industry to describe products as “solutions.” As such, there is confusion, even skepticism, over exactly what “solution” means.

In SF, the term “solution” has a more specific meaning. It is the coordinated delivery of the elements needed (such as one or more of technologies, documentation, training, and support) to successfully respond to a unique customer's business problem. While SF is used to develop commercial products for a mass market, it focuses mainly on delivering solutions tailored to a specific customer.

A solution may include one or more software products, but the difference between products and solutions should be understood. The differences are summarized in the table below:

| Products | SF Solution |
|---|---|
| Designed for the needs of a mass | Designed or tailored to fit |
| market. | individual customer needs. |
| Delivered as a packaged goods or “bits” | Delivered as a project. |
| (by way of download, CD-ROM, and so | |
| on). | |

FIG. 10 is a block diagram depicting exemplary main elements of a software-based solution. Projects may vary in complexity and the amount of effort necessary for development. Some of the elements shown in FIG. 10 may not be necessary in a relatively simple deployment. However, more complex, larger-scale projects most likely benefit from all of the elements illustrated above.

In addition, with reference to FIG. 10:
Selected technologies/custom code may be new, upgraded, updated, or include added components.
Technologies may include hardware, software, peripherals, or network components. Custom code is code developed for a specific project.
Training applies to everyone who will be using or supporting the solution that is to be deployed.
Documentation refers to the information needed to install, maintain, support, and use the solution.
Support processes include the procedures necessary to perform backups, restorations, disaster recovery, troubleshooting, and Help desk functions.
External communications involve keeping external stakeholders apprised of the progress of the deployment and the ways in which the solution will affect them.
Deployment processes include installation/uninstallation procedures for deploying hardware and software, automated deployment tools, and procedures for emergency rollback.
   Baselining

In the SF process model, a baseline is a measurement or known state by which something is measured or compared. Establishing baselines is a recurring theme in SF. Source code, server configurations, schedules, specifications, user manuals, and budgets are just some examples of deliverables that are baselined in SF. Without baselines, it is difficult to manage change.

Scope

Scope is the sum of deliverables and services to be provided in the project. The scope defines what should be done to support the shared vision. It integrates the shared vision, mapped against reality, and reflects what the customer deems essential for success of the release. As a part of defining the scope, less urgent functionality is moved to future projects.

The benefits of defining the scope include, for example:
Dividing a long-term vision into achievable chunks.
Defining the features that will be in each release.
Allowing flexibility for change.
Providing a baseline for trade-offs.

The scope of a solution's features should be defined and managed as well as the scope of work and services being provided by the project team.

The term “scope” has two aspects: the solution scope and the project scope. While there is a correlation between these two, they are not the same. Understanding this distinction helps teams manage the schedule and cost of their projects.

The solution scope describes the solution's features and the deliverables, including non-code deliverables. A feature is a desirable or notable aspect of an application or piece of hardware. For example, the ability to preview before printing is a feature of a word processing application; the ability to encrypt e-mail messages before sending is a feature of a messaging application. The accompanying user manual, online Help files, operations guides, and training are also features of the overall solution.

The project scope describes the work to be performed by the team in order to deliver each item described in the solution scope. Some organizations define project scope as a statement of work (SOW) to be performed.

Clarifying the project scope may provide one or more of the following exemplary benefits:
Focuses the team on identifying what work should be done.
Facilitates breaking down large, vague tasks into smaller, understandable ones.
Identifies specific project work that is not clearly associated with any specific feature, such as preparing status reports.
Facilitates subdividing the work among subcontractors or partners on the team.
Clarifies those parts of the solution that the team is responsible for as well as the ones for which it is not responsible.
Ensures that parts of the solution have a clear owner responsible for building or maintaining it. For large solutions especially, features are part of the solution, but not part of the project team's deliverables. For example, a team may be building a corporate procurement solution that interacts with a company's enterprise resource management (ERP) system. The integration is part of the overall solution scope, but not necessarily part of the project scope for that team.
   Managing Tradeoffs

Managing scope is critical for project success. Many IT projects fail, are completed late or go dramatically over-budget due to poorly managed scope. Managing scope includes clarifying the scope early and good project tracking and change control.

Due to the inherent uncertainty and risk involved with IT projects, making effective trade-offs is important to success.

The Tradeoff Triangle

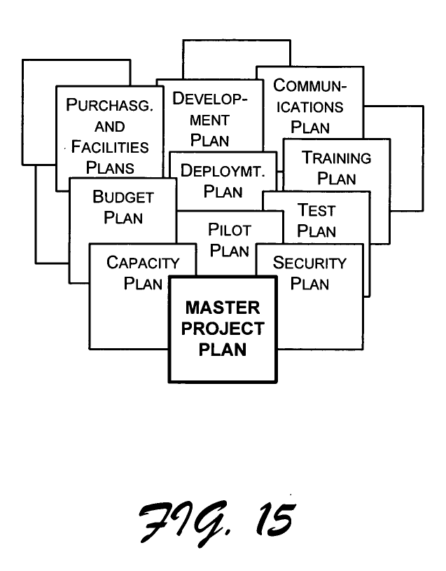

FIG. 11 is a block diagram depicting an exemplary tradeoff triangle. In projects, there is a relationship between the project variables of resources (people and money), schedule (time), and features (scope). These variables can be considered to exist in a triangular relationship as shown in FIG. 11.

After the triangle is established, any change to one of its sides requires a correction on one or both of the other sides to maintain project balance. This includes, potentially, the same side on which the change first occurred.

The key to deploying a solution that matches the customer's needs when they need it is to find the right balance between resources, deployment date, and features. Customers are sometimes reluctant to cut favorite features. The tradeoff triangle helps to explain the constraints and present tradeoff options.

Features have a fixed level of quality that is presumed to be non-negotiable. You can view quality as a fourth dimension which would transform the triangle into a tetrahedron (or three-sided pyramid), e.g., see FIG. 11. Although lowering the quality bar results in simultaneously reducing resources, shortening schedule, and increasing features, it is obviously a recipe for failure.

Project Tradeoff Matrix

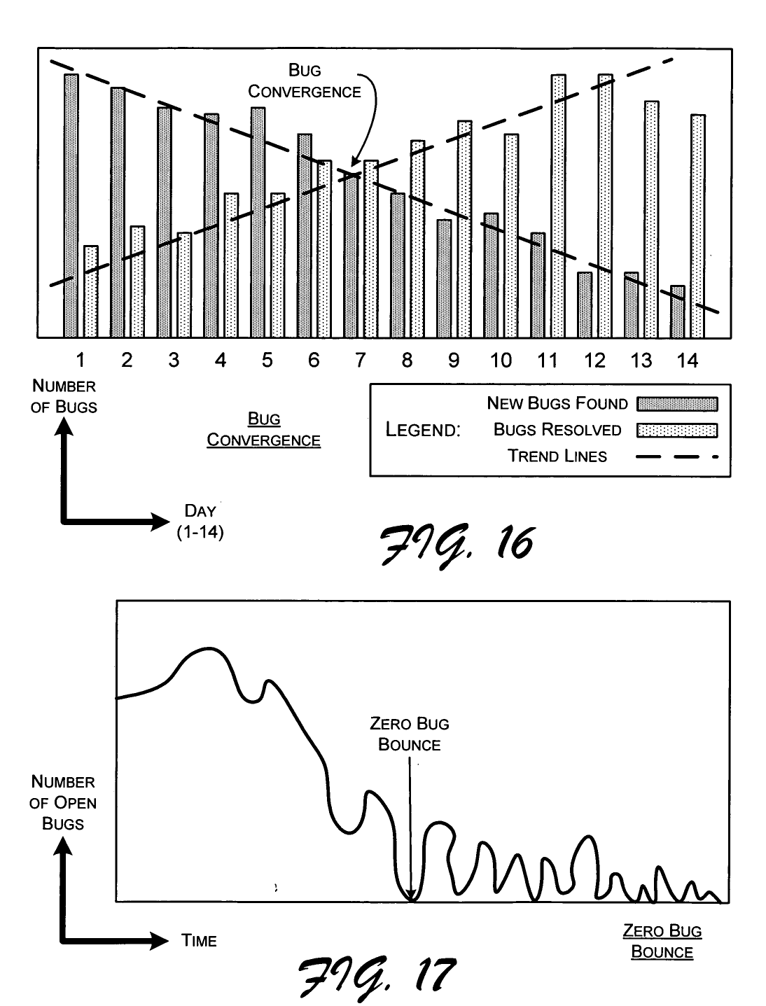

FIG. 12 is a block diagram depicting an exemplary tradeoff matrix. Another powerful tool to manage tradeoffs is this project tradeoff matrix. It is effectively an agreement between the team and customer, made early in the project, regarding the default priorities when making tradeoff decisions. There can be exceptions to the default priorities, if necessary. But the main benefit of establishing default priorities is to help make the tradeoffs less contentious.

FIG. 12 shows the typical tradeoff matrix used by product teams. This matrix helps identify project constraints that are essentially unchangeable (represented by the Fixed column), constraints that are desired priorities (represented by the Chosen column), and constraints (represented by the Adjustable column) that can be adjusted to accommodate those constraints that are Fixed and Chosen.

Features are not usually cut casually. Both the team and the customer should review all project constraints carefully and be prepared to make difficult choices.

To understand how the tradeoff matrix works, resource, schedule, and feature variables can be inserted in the blanks of the following sentence: Given fixed ______, we will choose a ______ and adjust ______ as necessary.

Some logical sentence possibilities are, for example:
Given fixed resources, we will choose a schedule and adjust the feature set as necessary.
Given fixed resources, we will choose a feature set and adjust the schedule as necessary.
Given a fixed feature set, we will choose a level of resources and adjust schedule as necessary.
Given a fixed feature set, we will choose a schedule and adjust resources as necessary.
Given a fixed schedule, we will choose a level of resources and adjust the features set as necessary.
Given a fixed schedule, we will choose a feature set and adjust resources as necessary.

It is important that the team and the customer are clear on the tradeoff matrix for the project.

Some Exemplary Characteristics of the Process Model

Three exemplary distinctive features of the SF process are:
A phase and milestone-based approach.
An iterative approach.
An integrated approach to building and deploying solutions.
   An Exemplary Milestone-Based Approach

Some exemplary characteristics of the Milestone-Based Approach are:
Milestones, a central theme in SF, are used to plan and monitor project progress. Major Milestones and Interim Milestones:
SF distinguishes between two types of milestones: Major milestones and interim milestones. Features of major and interim milestones are:
Major milestones serve to transition from one phase to another and to transition responsibility across roles.
SF defines specific major milestones that are generic enough for any type of IT project.
Interim milestones serve as early progress indicators and segment large work efforts into workable pieces.
Interim milestones vary depending on the type of project. SF provides a set of suggested interim milestones, but teams may define specific interim milestones that make sense for their projects.
   Milestones as Synchronization Points

The major milestones are points in the project life cycle when the entire team synchronizes the milestone's deliverables with each other and with customer expectations. At this time, project deliverables are formally reviewed by the customer, the stakeholders, and the team. Successful achievement of a major milestone represents team and customer agreement to proceed with the project.

Although it is possible to have a completely predictable project by picking an exceptionally late release date, this is costly and doesn't meet business needs. The milestones allow the customer and the team to either reconfirm the project scope or adjust the scope of the project to reflect changing customer requirements or to react to risks.

Milestone-Driven Accountability

Although the program management role orchestrates the overall process within each phase, the successful achievement of each milestone requires special leadership and accountability from each of the other team roles. As a project moves sequentially through each phase, the level of effort for each of the roles varies. The use of milestones helps to manage this ebb and flow of involvement in the project.

Different Roles Drive Different Phases

The alignment of team roles with each of the five external milestones clarifies which role is primarily responsible for achieving each milestone. This creates clear accountability. When the project moves to a different phase, part of the process often includes transitioning responsibility to other roles.

The chart below shows the roles which drive each milestone. Although the completion of each milestone is driven by one or two roles, all roles participate throughout the project life cycle.

| Milestone | Primary driver |
|---|---|
| Vision/Scope Approved | Product Management |
| Project Plans Approved | Program Management |
| Scope Complete | Development and User Experience |
| Release Readiness Approved | Testing and Release Management |
| Deployment Complete | Release Management |

Post-Milestone Reviews

Each major milestone provides an opportunity for learning and reflection on the progress of the phase just completed. Post-milestone reviews provide a good forum for this reflection. These are different in purpose from milestone review meetings, which are conducted with the customer and other stakeholders to evaluate milestone deliverables. The final post-milestone review occurs at the end of the project.

An Exemplary Iterative Approach

Characteristics of an Iterative Approach:

The practice of iterative development is a recurrent theme in SF. Code, documents, designs, plans, and other deliverables are developed in an iterative fashion.

Versioned Releases:

SF recommends that solutions be developed by building, testing and deploying core functionality. Later sets of features are added. This is known as a version release strategy. It is true that some small projects may only need one version. Nevertheless, it is a recommended practice to look for opportunities to break a solution into a multiple versions.

FIG. 13 is an illustrative graph depicting an exemplary process using versioned releases. It shows how functionality can develop over multiple versions. Versioned releases do not necessarily occur sequentially. Mature software products often are developed by multiple version teams working with overlapping release cycles. The time between versions varies on the size and type of project, as well as customer needs and strategy.

Create Living Documents:

To avoid spiraling out of control, iterative development requires documentation that changes as the project changes. These “living documents” are maintained in a different way than they are with a waterfall approach, where no development begins until all requirements and specifications are complete and locked down.

SF project documents are developed iteratively, much like code. Planning documents often start out as a high-level “approach.” These are circulated for review by the team and stakeholders during the envisioning phase. As the project moves into the planning phase, these are developed into detailed plans. Again these are reviewed and modified iteratively. The types and number of these plans vary with the size of the project.

To avoid confusion, planning documents that are started during the envisioning phase are referred to as “approaches.” For example, a brief test approach can be written during envisioning that evolves into a test plan in later phases.

Baseline Early, Freeze Late:

By creating and baselining project documents early in the process, team members are empowered to begin development work without the delays that may be incurred in excessive planning. By making the documents flexible by freezing them late within their corresponding phases, changes can be accommodated during development. This flexibility requires careful attention to the change control process. It is essential to track changes and ensure that no unauthorized changes occur.

Daily builds:

SF advocates preparing frequent builds of all the components of the solution for testing and review. This approach is recommended for developing code as well as for “builds” of hardware and software components. This approach enables the stability of the total solution to be well-understood, with ample test data, before the solution is released into production.

Larger, complex projects are often split into multiple segments, each of which is developed and tested by separate sub teams or feature teams, then consolidated into the whole. In projects of this type, typical in product development, the “daily build” approach is a fundamental part of the process. Core functionality of the solution or product is completed first, and then additional features are added. Development and testing occur continuously and simultaneously in parallel tracks. The daily build provides validation that all of the code is compatible, and allows the various sub teams to continue their development and testing iterations.

Note that these iterative builds are not deployed in the live production environment. Only when the builds are well-tested and stable are they ready for a limited pilot (or beta) release to a subset of the production environment. Rigorous configuration management is important to keeping builds in synchronization.

Configuration Management:

Configuration management is the formalized tracking and control of the state of various project elements. These elements include version control for code, documentation, user manuals and Help files, schedules, and plans. It also includes tracking the state of hardware, network, and software settings of a solution. The team should be able to reproduce or “roll back” to an earlier configuration of the entire solution if this is needed.

Configuration management is often confused with project change control, which is discussed below. The two are interrelated, but not the same. Configuration management is the tracking of the state of project deliverables and documents. Change control is the process used to review and approve changes. Configuration management provides the baseline data that the team needs in order to make effective change control decisions.

For example, a team is working on an electronic healthcare claims system for a chain of hospitals. They record the settings selected on a server and track changes as they are made during development and testing. This is an example of configuration management. To conform to new government regulations, someone has proposed adding a new EDI mapping schema. Important team members meet with the manager funding the project and members of the operations staff to review the proposed change, its technical risk, and impact to cost and schedule. This is an example of change control.

For organizations using OF, configuration management for the project can adapt many of the configuration management processes used for operations.

Some Exemplary Guidelines for Versioned Releases:

Versioned releases improve the team's relationship with the customer and ensure that the best ideas are reflected in the solution. Customers will be more receptive to deferring features until a later release if they trust the team to deliver the initial and subsequent solution releases in a timely fashion. Guidelines facilitating the adoption of versioned releases are:
Create a multi-release plan.
Deliver core functionality first.
Cycle through iterations rapidly.
Establish change control.
Stop creating new versions when they no longer add value.

Create a Multi-Release Plan:

Thinking beyond the current version enhances a team's ability to make good decisions about what to build now and what to defer. By providing a time table for future feature development, the team is able to make the best use of available resources and schedule constraints, as well as to prevent unwanted scope expansion.

Deliver Core Functionality First:

A basic, solid and usable solution in the customer's hands is of more immediate value than a deluxe version that won't be available for weeks, months, or years. By delivering core functionality first, developers have a solid foundation upon which to build, and benefit from customer feedback that will help drive feature development in subsequent iterations.

Prioritize Using Risk-Driven Scheduling:

Risk assessment by the team identifies which features are riskiest. The SF Risk Management Discipline is described further herein below. Schedule the riskiest features for completion first. Problems requiring major changes to the architecture can be handled earlier in the project, thereby minimizing the impact to schedule and budget.

Cycle through Iterations Rapidly:

A significant benefit of versioning is that it delivers usable solutions to the customer expediently, and improves them incrementally. If this process stalls, customer expectations for continual product improvement suffer. Maintain a manageable scope so that iterations are achievable within acceptable time frames.

Establish Change Control:

Once the specifications are baselined, all of the features and functionality of the solution should be considered to be under change control. It is important that the entire team and customer understands what this means and understands the change control process.

SF does not prescribe a specific set of change control procedures. These can be simple or very elaborate, depending on the size and nature of project. However, effective change control typically has the following elements:
Features are not added or changed without review and approval by both team and customer.
To facilitate review, requests to change features are submitted in writing. This allows tracking of groups of change requests.
Analyze each feature request for impact, feasibility and priority. Consider dependencies with other features, including user and operational documentation, training materials, and the operating environment.
Estimate the impact to cost and schedule for each change request (see the Bottom-Up Estimating section for more details).
Specify individuals (including the customer, program management, and some combination of stakeholders and other team members) to serve on a change control board to authorize changes. Such a group can take many forms, as long as it is authorized to approve changes to cost, schedule, and functionality.
Track changes and make them easy to access. For example, it is a good practice to maintain a change log section in functional specifications and other important documents.
Change control requires effective configuration management to be effective.

An Exemplary Integrated View of Development and Deployment

As stated previously, a solution does not provide value until it is fully deployed into live production. It is for this reason that the SF process model follows the trajectory of a solution until the point at which it begins delivering value—when deployment is complete.

Benefits of an Integrated Process Model

A process model that integrates application development and deployment provides the following benefits.

Focused on Enterprise Needs

Enterprises (especially business decision makers) generally perceive the building and deployment of a solution as a single consolidated undertaking. Even if a solution is developed successfully, business decision makers do not see return on investment until it is deployed to the enterprise.

Enhanced Support for Traditional Web Development

Web development teams today build and deploy (host) Web sites as a single planned, coordinated effort.

Enhanced Support for Web Services

Web services are designed and built for immediate deployment to their hosting environment. As Web services become a more frequently-used channel for software delivery, even commercial software vendors will find it makes sense to consider deployment as an integral part of their product lifecycle.

Removes “Over-the-Wall” Handoffs to Operations

It is common for development teams to build solutions without taking sufficient account of operational requirements. This results in applications with poor performance, availability, and manageability. SF's integrated process model transitions ownership from development to operations teams over a series of interim milestones, not in one “cold” handoff.

Notes for Using the Integrated Process Model:

Phases Not Equal in Duration

While the process model graphic shows equal sized phases, this is not to imply that each phase takes similar amounts of time. Depending on the project, the amount of time in each phase can vary dramatically.

Activities Often Span Phases

New practitioners of SF may think that the activities associated with a phase are only done during that phase. This is not the case. For example, planning does not only occur during the planning phase, testing occurs outside of the stabilizing phase, and development can be ongoing outside of the developing phase. Phases are characterized by the goals and deliverables and, to a lesser extent, by the typical activities that the team is focused on at various times.

Creating, updating, and refining plans continues throughout the project. However, the bulk of planning occurs during the planning phase and key plan deliverables get a full review during the planning phase.

“Pure” Application Development and Infrastructure Deployment Projects

Some projects do not involve both building and deploying solutions. Commercial software vendors building “shrink wrap” products obviously do not deploy that which they build for their customers, although they need to thoroughly understand what is involved. Likewise, teams on infrastructure deployment projects are not creating the technologies they are deploying, although development activities should take place, such as building automated installation scripts.

Teams on pure application development or pure infrastructure deployment projects may simply skip over references and interim milestones that do not apply to their type of project.

### Exemplary Process Model Phases and Milestones

In certain implementations, SF integrates application development (AD) and infrastructure deployment (ID). Consequently, a single model can follow the development of a solution from its inception to full deployment. By doing so, a five-phased pattern is used instead of four phases. Each phase culminates in an externally visible milestone.

FIG. 14 is a block diagram depicting an exemplary process model in terms of modules for the five phases and milestones thereof. The process model includes the following five phases: envisioning 1402, planning 1404, developing 1406, stabilizing 1408, and deploying 1410. These phases, along with milestones and/or deliverables thereof, are described further below.

Envisioning Phase 1402

Overview

The envisioning phase addresses one of the most fundamental requirements for project success—unification of the project team behind a common vision. The team should have a clear vision of what it wants to accomplish for the customer and be able to state it in terms that will motivate the entire team and the customer. Envisioning, by creating a high-level view of the project's goals and constraints, can serve as an early form of planning; it sets the stage for the more formal planning process that will take place during the project's planning phase.

The primary activities accomplished during envisioning are the formation of the core team (described below) and the preparation and delivery of a vision/scope document. The delineation of the project vision and the identification of the project scope are distinct activities; both are required for a successful project. Vision is an unbounded view of what a solution may be. Scope identifies the part(s) of the vision can be accomplished within the project constraints.

Risk management is a recurring process that continues throughout the project. During the envisioning phase, the team prepares a risk document and presents the top risks along with the vision/scope document. For more information, see the SF Risk Management Discipline section, which is described below with reference to FIGS. 22-29.

During the envisioning phase, business requirements should be identified and analyzed. These are refined more rigorously during the planning phase.

The primary (but not exclusive) team role driving the envisioning phase is the product management role.

Vision/Scope Approved Milestone

The vision/scope approved milestone culminates the envisioning phase. At this point, the project team and the customer have agreed on the overall direction for the project, as well as which features the solution will and will not include, and a general timetable for delivery.

Deliverables

The exemplary deliverables for the envisioning phase are: Vision/scope data structure; Risk assessment data structure; and Project structure data structure.

Team Focus during the Envisioning Phase

The following table describes the focus and responsibility areas of each team role during the envisioning phase.

| Role | Focus |
|---|---|
| Product | Overall goals; identify customer needs, requirements; |
| Management | vision/scope document |
| Program | Design goals; solution concept; project structure |
| Management | |
| Development | Prototypes; development and technology options; |
| | feasibility analysis |
| User Experience | User performance needs and implications |
| Testing | Testing strategies; testing acceptance criteria; |
| | implications |
| Release | Deployment implications; operations management and |
| Management | supportability; operational acceptance criteria |

Suggested Interim Milestones

Core Team Organized

This is the point at which key team members have been assigned to the project. Typically, the full team is not assembled yet. The initial team may often be playing multiple roles until all members are in place.

The project structure data structure includes information on how the team is organized and who plays which roles and has specific responsibilities. The project structure data structure also clarifies the chain of accountability to the customer and designated points of contact that the project team has with the customer. These can vary depending on the circumstances of the project.

Vision/Scope Drafted or Baselined

At this interim milestone, the first draft of the vision/scope data structure has been completed and is circulated among the team, customer, and stakeholders for review. During the review cycle, the data structure undergoes iterations of feedback, discussion, and change.

Planning Phase 1402

Overview

The planning phase is when the bulk of the planning for the project is completed. During this phase the team prepares the functional specification, works through the design process, and prepares work plans, cost estimates, and schedules for the various deliverables.

Early in the planning phase, the team analyzes and documents requirements in a list or tool. Requirements fall into four broad categories: business requirements, user requirements, operational requirements, and system requirements (those of the solution itself). As the team moves on to design the solution and create the functional specifications, it is important to maintain traceability between requirements and features. Traceability does not have to be on a one to one basis. Maintaining traceability serves as one way to check the correctness of design and to verify that the design meets the goals and requirements of the solution.

The design process gives the team a systematic way to work from abstract concepts down to specific technical detail. This begins with a systematic analysis of user profiles (also called “personas”) which describe various types of users and their job functions (operations staff are users too). Much of this is often done during the envisioning phase. These are broken into a series of usage scenarios, where a particular type of user is attempting to complete a type of activity, such as front desk registration in a hotel or administering user passwords for a system administrator. Finally, each usage scenario is broken into a specific sequence of tasks, known as use cases, which the user performs to complete that activity. This is called “story-boarding.”

There can be multiple levels in the design process, for example: conceptual design, logical design, and physical design. Each level is completed and baselined in a staggered sequence.

The results of the design process are documented in the functional specification(s). The functional specification describes in detail how each feature is to look and behave. It also describes the architecture and the design for all the features.

The functional specification serves multiple purposes, such as:
Instructions to developers on what to build.
Basis for estimating work.
Agreement with customer on exactly what will be built.
Point of synchronization for the whole team.

Once the functional specification is baselined, detailed planning can begin. Each team lead prepares a plan or plans for the deliverables that pertain to their role and participates in team planning sessions. Examples of such plans include a deployment plan, a test plan, an operations plan, a security plan, and/or a training plan. As a group, the team reviews and identifies dependencies among the plans.

All plans are synchronized and presented together as the master project plan. The number and types of subsidiary plans included in the master project plan will vary depending on the scope and type of project.

Team members representing each role generate time estimates and schedules for deliverables (see the Bottom-Up Estimating section for more details). The various schedules are then synchronized and integrated into a master project schedule.

At the culmination of the planning phase—the project plans approved milestone—customers and team members have agreed in detail on what is to be delivered and when. At the project plans approved milestone, the team re-assesses risk, updates priorities, and finalizes estimates for resources and schedule.

Project Plans Approved

At the project plans approved milestone, the project team and key project stakeholders agree that interim milestones have been met, that due dates are realistic, that project roles and responsibilities are well defined, and that mechanisms are in place for addressing areas of project risk. The functional specifications, master project plan, and master project schedule provide the basis for making future trade-off decisions.

After the team approves the specifications, plans, and schedules, the documents become the project baseline. The baseline takes into account the various decisions that are reached by consensus by applying the three project planning variables: resources, schedule, and features. After the baseline is completed and approved, the team transitions to the developing phase.

After the team defines a baseline, it is placed under change control. This does not mean that all decisions reached in the planning phase are final. But it does mean that as work progresses in the developing phase, the team should review and approve any suggested changes to the baseline.

For organizations using OF, the team submits a Request for Change (RFC) to IT operations at this milestone.

Deliverables

The following exemplary deliverables may be produced during the planning phase:
Functional specification
Risk management plan
Master project plan and master project schedule
   Team Focus during Planning

The following table describes the focus and responsibility areas of each team role during planning.

| Role | Focus |
|---|---|
| Product | Conceptual design; business requirements analysis; |
| Management | communications plan |
| Program | Conceptual and logical design; functional |
| Management | specification; master project plan and master project |
| | schedule, budget |
| Development | Technology evaluation; logical and physical design; |
| | development plan/schedule; development estimates |
| User Experience | Usage scenarios/use cases, user requirements, |
| | localization/accessibility requirements; user |
| | documentation/training plan/schedule for usability |
| | testing, user documentation, training |
| Testing | Design evaluation; testing requirements; test |
| | plan/schedule |
| Release | Design evaluation; operations requirements; pilot and |
| Management | deployment plan/schedule |

Suggested Interim Milestones

Technology Validation

During technology validation, the team evaluates the products or technologies that will be used to build or deploy the solution to ensure that they work according to vendor's specifications. This is the initial iteration of an effort that later produces a proof of concept and, ultimately, the development of the solution itself.

Often, technology validation involves competitive evaluations (sometimes called “shoot outs”) between rival technologies or suppliers.

Another activity that should be completed at this milestone is baselining the customer environment. The team conducts an audit (also known as “discovery”) of the “as is” production environment the solution will be operating in. This includes server configurations, network, desktop software, and relevant hardware.

Functional Specification Baselined:

At this milestone, the functional specification is complete enough for customer and stakeholder review. At this point the team baselines the specification and begins formally tracking changes.

The functional specification is the basis for building the master project plan and schedule. The functional specification is maintained as a detailed description, as viewed from the user perspective, of what the solution will look like and how it will behave. The functional specification can usually be changed only with customer approval.

The results of the design process are often documented in a design document that is separate from the functional specification. The design document is focused on describing the internal workings of the solution. The design document can be kept internal to the team and can be changed without burdening the customer with technical issues.

Master Plan Baselined:

In a described SF, the master project plan is a collection (or “roll up”) of plans from the various roles. It is not an independent plan of its own. Depending on the type and size of project, there will be various types of plans that are merged into the master project plan.

FIG. 15 is an illustrative diagram depicting an exemplary master project plan. Some of the plans that may be merged into a master project plan are illustratively shown in FIG. 15. These illustrated plans include, for example, a capacity plan, a pilot plan, a security plan, a budget plan, a deployment plan, a test plan, a training plan, a purchasing and facilities plan, a development plan, and a communications plan.

The benefits of having a plan made up of smaller plans are that it facilitates concurrent planning by various team roles and that it provides for clear accountability because specific roles are responsible for specific plans.

The benefits of presenting these plans as one are that they facilitate synchronization into a single schedule, facilitate reviews and approvals, and help to identify gaps and inconsistencies.

Master Schedule Baselined

The master project schedule includes all of the detailed project schedules, including the release date. Like the master project plan, the master project schedule combines and integrates the schedules from each team lead. The team determines the release date after negotiating the functional specification draft and reviewing the master project plan draft. Often, the team will modify some of the functional specification and/or master project plan to meet a required release date. Although features, resources, and release date may vary, a fixed release date likely causes the team to prioritize features, assess risks, and plan adequately.

Development and Test Environment Set Up

A working development environment allows proper development and testing of the solution so that it has no negative impact on production systems. It is generally a good idea to set up separate development servers that developers can use. The entire team should be informed that anything on such servers could become unstable and require re-installation.

This is also the environment where infrastructure components are developed, such as server configurations, deployment automation tools and hardware.

In order to avoid delay, the development and testing environment should be set up even as plans are being finalized and reviewed. This includes development workstations, servers, and tools. The backup system should be established if it is not already in place. CD-ROM images of standard server configurations are often used as machines and are often “wiped” or reformatted.

If the organization does not already have a suitable test lab in place, the team may build one. The test environment should be as close a simulation to the live environment as is reasonably feasible. While this can be expensive, it is important. Otherwise, certain bugs may go undetected until the solution is deployed “live” to production. Organizations using OF can take advantage of information contained in the enterprise Configuration Management Database (CMDB) as a kind of bill of materials for replicating the production environment.

Developing Phase 1406

Overview

During the developing phase the team accomplishes most of the building of solution components (documentation as well as code). However, some development work may continue into the stabilization phase in response to testing.

The developing phase involves more than code development and software developers. The infrastructure is also developed during this phase and multiple if not all roles are active in building and testing deliverables.

Scope Complete Milestone

The developing phase culminates in the scope complete milestone. At this milestone, the stipulated features are complete and the solution is ready for external testing and stabilization. This milestone is the opportunity for customers and users, operations and support personnel, and key project stakeholders to evaluate the solution and identify any remaining issues that should be addressed before the solution is released.

Some Exemplary Deliverables

The deliverables of the developing phase may include:
Source code and executables
Installation scripts and configuration settings for deployment
Frozen functional specification
Performance support elements
Test specifications and test cases
   Team Focus during Developing

The following table describes the focus and responsibility areas of each team role during developing.

| Role | Focus |
|---|---|
| Product Management | Customer expectations |
| Program Management | Functional specification |
| | management; project tracking; |
| | updating plans |
| Development | Code development; infrastructure |
| | development; configuration |
| | documentation |
| User Experience | Training; updated training plan; |
| | usability testing; graphic design |
| Testing | Functional testing; issues |
| | identification; documentation testing; |
| | updated test plan |
| Release Management | Rollout checklists, updated rollout |
| | and pilot plans; site preparation |
| | checklists |

Some Exemplary Recommended Interim Milestones

Proof of Concept Complete

The proof of concept tests important elements of the solution on a non-production simulation of the existing environment. The team walks operations staff and users through the solution to validate their requirements.

Internal Build n Complete, Internal Build n+1 Complete

Because the developing phase focuses on building the solution, the project needs interim milestones that can help the team measure build progress.

Developing is done in parallel and in segments, so the team benefits from a way to measure progress as a whole. Internal builds accomplish this by forcing the team to synchronize pieces at a solution level. How many builds and how often they occur will depend on the size and duration of the project.

Often it makes sense to set interim milestones to achieve a visual design freeze and a database freeze because of the many dependencies on these. For example, the screens that are needed to create documentation and the database schema form a deep part of the overall architecture.

Stabilizing Phase 1408

Overview

The stabilizing phase conducts testing on a solution whose features are complete. Testing during this phase emphasizes usage and operation under realistic environmental conditions. The team focuses on resolving and triaging (prioritizing) bugs and preparing the solution for release.

Early during this phase it is common for testing to report bugs at a rate faster than developers can fix them. There is no way to tell how many bugs there will be or how long it will take to fix them. There are, however, a couple of statistical signposts known as bug convergence and zero-bug bounce that helps the team project when the solution will reach stability. These signposts are described below with reference to FIGS. 16 and 17.

SF typically avoids the terms “alpha” and “beta” to describe the state of IT projects. These terms are widely used, but are interpreted in too many ways to be meaningful in industry. Teams can use these terms if desired, as long as they are defined clearly and the definitions understood among the team, customer, and stakeholders.

Once a build has been deemed stable enough to be a release candidate, the solution is deployed to a pilot group.

The stabilizing phase culminates in the release readiness milestone. Once reviewed and approved, the solution is ready for full deployment to the live production environment.

Release Readiness Milestone

The release readiness milestone occurs at the point when the team has addressed outstanding issues and has released the solution or placed it in service. At the release milestone, responsibility for ongoing management and support of the solution officially transfers from the project team to the operations and support teams.

Some Exemplary Deliverables

The deliverables of the stabilizing phase may include:
Golden release
Release notes
Performance support elements
Test results and testing tools
Source code and executables
Project documents
Milestone review
   Team Focus during Stabilizing

The following describes the focus and responsibility areas of each team role during the stabilizing phase.

| Role | Focus |
|---|---|
| Product Management | Communications plan execution; |
| | launch planning |
| Program Management | Project tracking; bug triage |
| Development | Bug resolution; code optimization |
| User Experience | Stabilization of user performance |
| | materials; training materials |
| Testing | Testing; bug reporting and status; |
| | configuration testing |
| Release Management | Pilot setup and support; deployment |
| | planning; operations and support |
| | training |

Recommended Interim Milestones

Bug Convergence

Bug convergence is the point at which the team makes visible progress against the active bug count. That is, the rate of bugs resolved exceeds the rate of bugs found.

FIG. 16 is a graph depicting an exemplary bug convergence paradigm. Days (1-14) are graphed versus the number of bugs. As indicated by the legend, new bugs found and bugs resolved are logged for each day. The trend lines are tracked to find their intersection; this intersection represents the approximate bug convergence.

Because the bug rate will still go up and down—even after it starts its overall decline—bug convergence usually manifests itself as a trend rather than a fixed point in time. After bug convergence, the number of bugs should continue to decrease (i.e., it usually does decrease) until zero-bug release. Bug convergence tells the team that the end is actually within reach.

Zero Bug Bounce

Zero-bug bounce is the point in the project when development finally catches up to testing and there are no active bugs—at least for the moment.

FIG. 17 is a graph depicting an exemplary zero bug bounce paradigm. Time is graphed versus the number of open bugs. At some point in time (e.g., some particular day), there is the first incidence of a moment in which no bugs are currently known to exist in a solution. This zero bug balance is indicated by the arrow.

After zero-bug bounce, the bug peaks usually become noticeably smaller and usually continue to decrease until the solution is stable enough for the team to build the first release candidate. Careful bug triaging is important because every bug that is fixed risks the creation of a new bug. Achieving zero-bug bounce is a clear sign that the team is in the endgame as it drives to a stable release candidate.

It should be noted that new bugs will certainly be found after this milestone is reached. However, zero-bug bounce marks the first time when the team can honestly report that that there are no active bugs—even if it is only for the moment—and it focuses the team on working to stay at that point.

Release Candidates:

A series of release candidates are prepared and released to the pilot group. Each release candidate can be considered an interim milestone. Other features of a release candidate are:
Each release candidate has all the elements it needs to be released to production.
Building a release candidate tests its fitness for release, that is, whether all necessary pieces are present.
The test period that follows generation of a release candidate determines whether a release candidate is ready to release to production or whether the team should generate a new release candidate with the appropriate fixes.
Testing release candidates, which is done internally by the team, requires highly focused and intensive efforts, and focuses heavily on flushing out showstopper bugs.
Testing requires a triage process for resolving any newly discovered bugs.
It is unlikely that the first release candidate will be the one that is released. Typically, show-stopping bugs will be found during the intensive testing of a release candidate.

Pre-Production Test Complete

The focus of this interim milestone is to prepare for a pilot release. This interim milestone is important because the solution is about to “touch” the live production environment. For this reason the team preferably tests as much of the entire solution as possible before the pilot test begins.

Activities that should be completed during this interim milestone are, for example:
Evaluate test results against success criteria.
Complete site preparation checklist and procedures.
Complete implementation procedures, scripts, and load sets.
Complete training material.
Resolve support issues.
Complete and test the rollback plan.

The pre-production test complete interim milestone is not complete until the team ensures that everything developed to deploy the solution is fully tested and ready.

User Acceptance Testing Complete

User acceptance testing and usability studies begin during the development phase and continue during stabilization. These are conducted to ensure that the new system is able to successfully meet user and business needs. This is not to be confused with customer acceptance, which occurs at the end of the project.

When this milestone has been achieved, users have tested and accepted the release in a non-production environment and verified that the system integrates with existing business applications and the IT production environment. The rollout and backout procedures should also be confirmed during this period.

Upon approval of release management, software developed in-house and any purchased applications are migrated from secure storage to a pristine archive location. Release management is responsible for building releases (assembling the release components) in the test environment from the applications stored in the pristine archive location.

User acceptance testing gives support personnel and users the opportunity to understand and practice the new technology through hands-on training. The process helps to identify areas where users have trouble understanding, learning, and using the solution. Release testing also gives release management the opportunity to identify issues that could prevent successful implementation.

Pilot Complete

During this interim milestone, the team will test as much of the entire solution in as true a production environment as reasonably possible. In SF, a pilot release is a deployment to a subset of the live production environment or user group. Depending on the context of the project, a pilot release can take the following exemplary forms:
In an enterprise, a pilot can be a group of users or a set of servers in a data center.
In Web development, pilot release takes the form of hosting site files on staging server(s) or folders that are live on the Internet, only with a test Web address.
Commercial software vendors often release products to a special group of early adopters prior to final release.

What these forms of piloting have in common is that they are instances of testing under live conditions.

The pilot complete interim milestone is not complete until the team ensures that the proposed solution is viable in the production environment and every component of the solution is ready for deployment. In addition, the following actions should be followed:
Prior to beginning a pilot, the team and the pilot participants should clearly identify and agree upon the success criteria of the pilot. These should map back to the success criteria for the development effort.
Any issues identified during the pilot should be resolved either by further development, by documenting resolutions and work-arounds for the installation teams and production support staff, or by incorporating them as supplemental material in training courses.
Before the pilot is started, a support structure and issue-resolution process should be in place. This may require that support staff be trained. The procedures used for issue resolution during a pilot may vary significantly from those used during deployment and when the solution is in full production.
In order to determine if the deployment process will work, it is helpful to implement a trial run or a rehearsal of all the elements of the deployment so that issues may be identified prior to the actual deployment.

Once enough pilot data has been collected and evaluated, the team is at a point of decision. It is at this point that one of the following strategies should be selected:
Stagger forward—Deploy a new release to the pilot group.
Roll back—The roll-back plan is executed and the pilot group is reverted back to the previous configuration state they had before the pilot (as closely as feasible). The pilot is tried again with a more stable release.
Suspend—Suspend the entire pilot.
Patch and continue—the pilot group is issued a “patch,” a fix to existing code.
Proceed to deploying phase.
   Deploying Phase 1410
   Overview

During this phase, the team deploys the core technology and site components, stabilizes the deployment, transitions the project to operations and support, and obtains final customer approval of the project. After the deployment, the team conducts a project review and a customer satisfaction survey.

Stabilizing activities may continue during this period as the project components are transferred from a test environment to a production environment.

Deployment Complete Milestone

The deployment complete milestone culminates the deploying phase. By this time, the deployed solution should be providing the expected business value to the customer and the team should have effectively terminated the processes and activities it employed to reach this goal.

The customer should agree that the team has met its objectives before it can declare the solution to be in production and close out the project. This requires a stable solution, as well as clearly stated success criteria. In order for the solution to be considered stable, appropriate operations and support systems should be in place.

Some Exemplary Deliverables

Deliverables may include, for example:
Operation and support information systems
Procedures and processes
Knowledge base, reports, logbooks
Documentation repository for all versions of documents, load sets, and code developed during the project
Project close-out report
Final versions of all project documents
Customer/user satisfaction data
Definition of next steps
   Team Focus during Deploying

The following describes the focus and responsibility areas of each team role during the deploying phase.

| Role | Focus |
|---|---|
| Product Management | Customer feedback, assessment, |
| | sign-off |
| Program Management | Solution/scope comparison; |
| | stabilization management |
| Development | Problem resolution; escalation |
| | support |
| User Experience | Training; training schedule |
| | management |
| Testing | Performance testing; problem |
| Release Management | Site deployment management; |
| | change approval |

Recommended Interim Milestones:

Core Technology Components Deployed

Most infrastructure solutions include a number of components that provide the framework or backbone for the entire solution. These components do not represent the solution from the perspective of a specific set of users or a specific site. However, the deployment of sites or users generally depends on this framework. In addition:
Components are the enabling technology of the enterprise solution. Examples include domain controllers, mail routers, remote access servers, database servers.
Site deployments depend on this technology.
Depending on the solution, the core technology may benefit from being deployed before or in parallel with site deployments.
To avoid delays, core components may be reviewed and approved for deployment in advance of other parts of the solution still being stabilized. The operations staff should generally feel confident making this commitment before the whole solution has been proved to be stable.

Site Deployments Complete Interim Milestone

At the completion of this milestone, targeted users have access to the solution. Each site owner has signed off that their site is operating, though there may be some issues.

Customer and user feedback might reveal some problems. The training may not have gone well, or a part of the solution may have malfunctioned after the team departed the site. Some sites may need to be revisited based on feedback from site satisfaction surveys.

At this point, the team makes a concentrated effort to finish deployment activities and close out the project.

Many projects, notably in web development, do not involve client-side deployments and therefore this milestone may not be applicable.

Deployment Stable Interim Milestone

At the deployment stable interim milestone, the customer and team agree that the sites are operating satisfactorily. However, it is to be expected that some issues will arise with the various site deployments. These continue to be tracked and resolved.

It can be difficult to determine when a deployment is “complete” and the team can disengage. Newly deployed systems are often in a constant state of flux, with a continuous process of identifying and managing production support issues. The team can find it difficult to close out the project because of the ongoing issues that will surface after deployment. For this reason, the team preferably defines a completion milestone for the deployment rather than attempt to reach a point of absolute finality.

If the customer expects members of the project team to be involved in ongoing maintenance and support, those resources should transition into a new role as part of the operations and support structure after project close-out.

At this late stage, team members and external stakeholders will likely begin to transition out of the project.

Part of disengaging from the project includes transitioning operations and support functions to permanent staff. In many cases, the resources to manage the new systems will already exist. In other cases, it may be necessary to design new support systems. Given the scope of the latter case, it may be wise to consider that as a separate project.

The period between the deployment stable and deployment complete milestones is sometimes referred to as a “quiet period.” Although the team is no longer active, team resources respond to issues that are escalated to them. Typical quiet periods are 15 to 30 days long.

The purpose of the quiet period is to measure how well the solution is working in normal operation and to establish a baseline for understanding how much maintenance will be involved to run the solution. Organizations using OF may measure the number of incidents, the amount of downtime, and collect performance metrics of the solution. This data can help form the assumptions used by the operations Service Level Agreement (SLA) on expected yearly levels of service and performance.

Recommended Practices for the SF Process Model

The following supporting practices can help teams apply the SF process model to their project.

Focus Creativity by Evolving Features and Constraining Resources

A general development approach is to constrain development resources and budget, which focuses creativity, forces decision-making, and optimizes the release date.

Establish Fixed Schedules

Internal time limits (a technique known as “time-boxing”) keep pressure on the project team to prioritize features and activities.

Schedule for an Uncertain Future

Add buffer (additional) time to project schedules to permit the team to accommodate unexpected problems and changes. The amount of buffer to apply depends on the amount of risk. By assessing risks early in the project, the likeliest risks can be evaluated for their impact on the schedule and compensated for by adding buffer time to the project schedule.

One way to think of buffer time is as an estimate for unknown tasks and events. No matter how experienced the team, not all project tasks can be known and estimated in advance. Yet, be assured that some project risks occur and impact the project. The corrective actions to respond to these risks will take time.

Recommended guidelines for using buffer time are

Buffer time should not be added by padding estimates for individual tasks. Since work expands to fill the time scheduled to do it (Parkinson's Law), the buffer will be absorbed by planned tasks, not unplanned events.
Buffer time should be scheduled as if it were another task. Typically, buffer is allocated immediately before major milestones, especially the later ones. It always should lie on the project's critical path. The critical path is the longest chain of dependent tasks in a project and directly determines the duration of the project.
As buffer time is expended over the course of the project, the remaining amount should be carefully tracked and conserved.
If a feature is added, or resources removed from the project, do not compensate by using buffer time. If you do, your ability to compensate for risk has been correspondingly reduced. Negotiate features, resources, and schedule using the tradeoff triangle as shown in FIG. 11.
If all of the buffer time has been used, make the whole team aware that any disruption or delay is very likely to have a “knock on” effect and jeopardize the end date.
   Use Small Teams, Working in Parallel with Frequent Synchronization Points

Even a large and complex project may be divided into smaller, more efficient teams that work in parallel, if the teams periodically synchronize their activities and deliverables. This maintains a focus on consistent quality across the project, helps the program manager in charting overall progress, and emphasizes accountability within each of the teams.

Break Large Projects into Manageable Parts

A fundamental development strategy is to divide large projects into multiple versioned releases, with little or no separate maintenance phase.

Apply No-Blame Milestone Reviews

At each major milestone the team, customer and key stakeholders meet to review the deliverables for that milestone and assess the overall progress of the project. For large projects, this is also done at selected interim milestones as well.

After these meetings, the team conducts an internal team-facing review to evaluate team project performance. This review should be considered a Quality Assurance activity that can in turn trigger changes in how the project is being conducted.

The composition of individual team members often changes over the course of the project. Be sure to capture the input and learning of departing team members at major milestones before they move on.

Use Prototyping

Prototyping allows pre-development testing from many perspectives, especially usability, and helps create a better understanding of user interaction. It also leads to improved product specifications.

Use Frequent Builds and Quick Tests

Regular builds of the solution are the most reliable indicator available that the project is on track with development and that the team is functioning well together. Within the deployment phase, pilot testing cycles serve a similar purpose.

Cycle Rapidly

Enterprise solutions should emphasize business agility. To do this they should accommodate continuous change in customer needs. Rapid development and deployment cycles will facilitate the creation of versioned releases, which allow the evolving solution to respond to changing needs and requirements.

Avoid Scope Creep

Use the vision statement and specifications to maintain focus on the stated business goals and to trace critical features back to the original requirements. Apply the vision statement and specifications as filters to identify, discuss, and remove additional features that may have been added without proper consideration after the project had been defined.

Bottom-Up Estimating

Estimates for IT projects should be made by those who will do the work. Bottom up estimating provides the following benefits:
Better accuracy. Estimates made by those who will do the work are more accurate because the person making the estimates has had experience executing similar work.
Accountability. Those who develop their own work estimates feel more accountable for their work. They also feel more accountable for success in meeting the estimates they have made.
Team empowerment. Having team-developed dates as opposed to management-dictated dates empowers the team because the schedule is built on estimates that team members can accept as realistic.
   Integrating Team Estimates

Each team lead is responsible for preparing time estimates needed to complete the deliverables their role is responsible for. (The development lead prepares estimates for developers; the user experience lead prepares estimates for UE deliverables, and so on.).

The program management role coordinates the team estimation process and integrates (“rolls up”) all the estimates into a master schedule and budget.

The integrated process model described thus far herein has one or more of the following attributes:
Clarifies how the AD and ID models interact.
Supports teams working on enterprise custom solutions and traditional web development, where building and deployment is typically a single consolidated undertaking.
Supports the emergence of web services. As these become a more frequently-used channel for software delivery, even commercial software vendors will find it makes sense to consider deployment as an integral part of their product lifecycle.
Facilitates the handoff of solutions from development to operations teams, especially those teams using OF.
   Exemplary SF Team Model:

The exemplary SF Team Model describes an approach to structuring people and their activities to enable project success. The model defines role clusters, functional areas, responsibilities, and guidance for team members to address so that they can reach their unique goals in the project lifecycle.

Some Exemplary Team Model Fundamentals

The SF team model was developed over a period of several years to compensate for some of the disadvantages imposed by the top-down, hierarchical structure of traditional project teams.

Teams organized under the SF team model are small and multidisciplinary, in which the members share responsibilities and balance each other's competencies to keenly focus on the project at hand. They share a common project vision, a focus on deploying the project, high standards for quality and communication, and a willingness to learn. This section describes the various role clusters within the team, along with their goals and functional areas. Guidance is also provided on using an approach to teaming when scaling for both small or large and complex projects.

The foundation principles, important concepts, and proven practices of SF as they apply to the team model are outlined below. The primary ideals are highlighted in this section and referenced herein throughout as additional details of the SF team model are discussed.

Underlying SF Foundation Principles

SF includes several foundational principles, cornerstones of the framework's approach. Some of the principles relating to working as a successful team are highlighted in this section.

Clear Accountability, Shared Responsibility

SF combines a shared responsibility for doing work with a clear accountability for ensuring it gets done.

The SF team model is based on the premise that each role has equal goals, presents a unique perspective on the project, and that no single individual can successfully represent all of the different quality goals. To resolve this dilemma, the team of peers needs to combine a clear line of accountability to the stakeholders with shared responsibility for overall success.

Within the team, each role is accountable to the team itself (and to their own respective organizations) for achieving their role's quality goal. In this sense, each role is accountable for a share of the quality of the eventual solution. Responsibility is shared across the team of peers (allocated in line with the team roles). It is interdependent for two reasons: first, out of necessity, since it is practically impossible to isolate each role's work; second, by preference, since the team is more effective if each role is aware of the full picture. This mutual dependency encourages all team members to comment and contribute outside their direct area of accountability, ensuring that the full range of the team's knowledge, competencies, and experience can be brought to bear. All team members own the success of the project; they share in the kudos and rewards of a successful project and are expected to improve their expertise by contributing to and learning from the lessons of a less successful one.

Empower Team Members

In an effective team, each member is empowered to deliver on their own commitments and has confidence that, where they depend on the commitments of other team members, that these will also be met. Likewise, the customer has a right to assume that the team will meet its commitments and will plan on this basis. At worst, the customer should be notified as soon as possible of any delay or change.

An SF team provides members with the degree of empowerment they need to meet their commitments. In return, it relies on the integrity and motivation of all team members to:
Be prepared to make commitments to others.
Clearly define the commitments they undertake.
Make every reasonable effort to deliver against those commitments.
Communicate honestly as soon as they realize that a commitment may be at risk.

As soon as more than one person is needed for an activity, each participant's efforts will be influenced by their dependencies on what other team members are doing. However they can't spend time monitoring every dependency on which their own work may rely. Effective teams develop confidence that their colleagues are empowered and committed to the team's objectives.

Consider the analogy of an athletic relay team. When the runner for the second leg starts running, the runner doesn't slow down and look backwards to see how close the fore-runner is. Instead, the runner concentrates on accelerating as fast as possible and then simply stretches back to receive the baton, confident that it will be delivered. This confidence is based on practice, experience, and trust.

In a complex project, team members need to develop a similar level of trust and this trust is built every time a commitment, however small, is met. A few simple guidelines for engendering trust are:
Empower team members to meet the commitments assigned to them. Empowerment requires that team members are given the resources necessary to perform their work, are responsible for the decisions that affect their work, and understand the limits to their authority and the escalation paths available to handle issues that transcend these limits.
Be prepared to make commitments to others. Preparation includes state of mind (approaching meetings with a willingness to take actions), readiness, and understanding the implications of a commitment and its impact on current workload and resources. The corollary to this is to defer making major commitments until their implications are understood. Instead, team members should propose a smaller commitment that they do understand, such as to research the implications and come back shortly with a firm commitment. Successful delivery on the smaller commitment will build team trust.
Clearly define the commitments that are undertaken. This avoids misunderstandings that can damage the confidence team members have in one another.
Make every reasonable effort to deliver against those commitments. If a team includes people from different organizations, expectations of what is reasonable may differ. For example, some team members may assume it's reasonable to work on weekends; others may see this as exceptional or may lack access to buildings on weekends.
Communicate honestly as soon as a commitment may be at risk. Inevitably there will be times when things change, either due to some reprioritization, an unexpected event, or simply that a task took longer than expected. Early communication enables other dependent team members the opportunity to plan accordingly. Perhaps they can even suggest an approach that solves the problem.

In most organizations these behaviors are embedded in the culture and regarded as so clear that they are rarely discussed. However, SF teams will occasionally need to work with organizations where these values are not fully understood and respected. These organizations often exhibit a high-blame culture that restricts an open flow of information. In these cases, the team leaders should clearly state their expectations in this regard and help new team members to adopt this way of working.

Focus on Business Value

The SF team model advocates basing team decisions on a sound understanding of the customer's business and on active customer participation in project delivery. The product management role acts as the customer advocate to the team and is often undertaken by a member of the customer organization. Product management owns the business case, which provides continuity from earlier strategic work. Part of product management's responsibility is to ensure that important project decisions are based on a sound business understanding.

The release management role is explicitly responsible for ensuring smooth deployment and operations. In doing so, this role acts as a bridge between solutions development, solutions deployment, and on-going operations, ensuring that the project delivery group is continually aware of the impact its decisions might have on value delivery during production operations.

Shared Project Vision

SF strongly advocates the adoption of a shared vision to focus the approach of a team, either towards delivery of an IT solution or towards provision of an IT service in an operating environment.

It is important to have a clear understanding of what the goals and objectives are for the project or process. This is because the team members and customers make assumptions on what the solution is going to do for the organization. A shared vision brings those assumptions to light and ensures that all participants are working to accomplish the same goal. The shared vision is one of the foundations of the SF team model.

When all participants understand and are working towards a shared vision, they are empowered by the ability to align their own decisions to the broader team purpose represented by that vision.

Without a shared vision, team members may have competing views of the goal, making it much more difficult to deliver as a cohesive group. And if the team does deliver, members will have difficulty determining their success because it depends on which vision they measure it by.

Stay Agile, Expect Change

SF assumes that things are continually changing and that it is impossible to isolate an IT solution delivery project from these changes. The SF Team Model ensures that all core roles are available throughout a project so that they can contribute to decisions arising from these changes. As new challenges arise, the SF Team Model fosters agility to address these issues. The contribution of all team roles to decision-making ensures that matters can be explored and reviewed from all critical perspectives.

Foster Open Communications

Historically, many organizations and projects have operated purely on a need-to-know basis, which frequently leads to misunderstandings and impairs the ability of a team to deliver a successful solution.

SF proposes an open and honest approach to communications, both within the team and with important stakeholders. A free-flow of information not only reduces the chances of misunderstandings and wasted effort, but also ensures that all team members can contribute to reducing uncertainties surrounding the project.

The team of peers approach involves all roles in important decisions. It is one reason why the shared team vision is regarded as the essential start to the solution delivery process. It is also a foundation to the SF risk management approach, which strongly advocates the involvement of all team members in risk identification and analysis and promotes a no-blame culture to encourage this. Open, honest discussion about what is working well and what can be improved provides the basis for the learning environment that SF seeks to create.

There are a few important factors that may constrain the openness of the team's communications, such as confidentiality of personal or commercial information. However, team members should question themselves whenever they decide to withhold information to ensure that the reasons for secrecy really are paramount. If they have built a relationship of trust through open communication, then on the rare occasions where they need to withhold information, they should be able to explain to their colleagues that there are over-riding reasons and ask for trust that these reasons are in the best interests of the project.

Some Important Concepts

Successful implementations of the SF team model share several characteristics. These characteristics have been captured and are presented as important concepts in this section:

Team of Peers

The “team of peers” concept places equal value on each role. This enables unrestricted communication between the roles, increases team accountability, and reinforces the concept that each of the six quality goals are equally important and should be achieved. To be successful with the team of peers, all roles should have ownership of the product's quality, should act as customer advocates, and should understand the business problem they are trying to solve.

Although each role has an equal value on the team, the team of peers exists between roles and should not be confused with consensus-driven decision making. Each role requires some form of internal organizational hierarchy for the purposes of distributing work and managing resources. Team leads for each role are responsible for managing, guiding, and coordinating the team while team members focus on meeting their individual goals.

Customer-Focused Mindset

Satisfied customers are priority number one for any great team. A customer focus throughout development includes a commitment from the team to understand and solve the customer's business problem. One way to measure the success of a customer focused mindset is to be able to trace each feature in the design back to a customer or user requirement. Also, an important way to achieve customer satisfaction is to have the customer actively participate in the design and offer feedback throughout the development process. This allows both the team and customer to better align their expectations and needs.

Product Mindset

The product mindset is not about whether you ship commercial software products or develop applications for internal customers. It is about treating the results of your labor as a product.

The first step to achieving a product mindset is to look at the work that you are doing as either a project by itself or contributing to a larger project. In fact, SF advocates the creation of project identities so that team members see themselves less as individuals and more as members of a project team. An example technique to accomplish this is to give projects code names. This helps to clearly identify the project, clearly identify the team, raise the sense of accountability, and serve as a mechanism for increasing team morale. Printing the team project code name on T-shirts, coffee mugs, and other group gift items are ways to create and reinforce team identity and spirit. This is particularly useful on projects with “virtual teams,” comprising elements from several different groups within an organization.

Once you understand that you work on a project, it's just a matter of understanding that whatever the final deliverable is, it should be considered a product. Principles and techniques that apply to creating products, like those advocated in SF, can be used to help ensure your project's successful delivery.

Having a product mindset also means being more focused on execution and what is being delivered at the end of the project and less focused on the process of getting there. That doesn't mean process is bad or unimportant, just that it should be used to accomplish the end goal and not just for the sake of using process. With the adoption of the product mindset, everyone on the team should feel responsible for the delivery of that product.

One program manager described a product mindset as applied to software development in the following manner: “Everybody . . . has exactly the same job. They have exactly the same job description. And that is to ship products. Your job is not to write code. Your job is not to test. Your job is not to write specs. Your job is to ship products. That's what a product development group does. “Your role as a developer or as a tester is secondary. I'm not saying it's unimportant—it's clearly not unimportant—but it's secondary to your real job, which is to ship a product. “When you wake up in the morning and you come in to work, you say, ‘What is the focus—are we trying to ship or are we trying to write code?’ The answer is, we are trying to ship. You're not trying to write code, you're trying not to write code.”

Zero-Defect Mindset

In a successful team, every member feels responsible for the quality of the product. Responsibility for quality cannot be delegated from one team member to another team member or function. Similarly, every team member should be a customer advocate, considering the eventual usability of the product throughout its development cycle.

Zero-defect mindset is a commitment to quality. It means that the team goal is to perform their work at the highest quality possible, so that if they have to deliver tomorrow, they can deliver something. It's the idea of having a nearly shippable product every day. It does not mean delivering code with no defects; it means that the product meets or exceeds the quality bar that was set by the project sponsor and accepted by the team during envisioning.

The analogy that best describes this concept is that of the automobile assembly line. Traditionally, workers put cars together from individual parts and were responsible for their own quality. When the car rolled off the line, an inspector checked it to see if its quality was high enough to sell. But the end of the process is an expensive time to find all of the problems because corrections are very costly at this point. Also, since the quality was not very predictable, the amount of time required at the end to determine if it was sellable was not predictable either.

More recently in car manufacturing, quality has become “job one.” That means that as work is being done (such as attaching a door or installing a radio), an inspector checks the work in progress to make sure that it meets the quality standards that are defined for that particular car. As long as this level of quality continues throughout the assembly process, then much less time and fewer resources are required at the end to ensure that the car is of acceptable quality. This makes the process much more predictable because the inspector needs to check only the integration of the parts, and not the individual work.

Willingness to Learn

Willingness to learn includes a commitment to ongoing self improvement through the gathering and sharing of knowledge. It allows team members to benefit from the lessons learned by making mistakes, as well as to repeat success by implementing proven practices of others. Conducting milestone reviews and blameless postmortems are components of the SF process model which help teams commit to communicating. Teams that commit time in the schedule for learning, reviews, and postmortems create an environment of ongoing improvement and continuing success. In addition, another way to be successful in creating a culture that is willing to learn is adding learning and knowledge sharing as part of individual review goals.

Motivated Teams Are Effective

Teams with low motivation suffer in two ways: Individually, the team members under-perform, leading to low quality and quantity of output; they also tend to work to narrow goals, and fail to appreciate the impact that their work has on colleagues. Both of these effects have a significant impact on IT projects, based as they are on a high degree of intellectual input and interaction.

SF advocates devoting effort to building team morale and motivation. Techniques that can be used to build motivation are:
Clarify team vision.
Build team identity, using project code-names and team paraphernalia—mascots, t-shirts, beakers, and so on.
Spend time getting to know colleagues by way of social or team events.
Schedule team-building sessions where team members can experiment with different ways of collaborating and interacting, normally outside the work setting.
Ensure that the individual's personal goals are considered, such as providing opportunities for personal or technical competency development, or managing the impact on work-life balance.
Maximize the empowerment felt by individuals and listening to their views.
Celebrate success.
   Proven Practices

The following proven practices are common actions to members of an SF team to ensure an ongoing focus for success.

Small, Multidisciplinary Teams

Small, multidisciplinary teams have inherent advantages, including the ability to respond more quickly than larger teams. Therefore, for large project teams it is better to create a team of teams—with smaller groups working in parallel. Team members with expertise or focus in specific areas are empowered with control to act where necessary.

Within teams or even within a role cluster, there are multiple disciplines that need a specific set of skills. People from various backgrounds, training, and specialization that comprise teams or roles all add to the overall product quality due to the unique perspective each brings to their role and ultimately the entire solution.

Working Together

One of the goals of the team model is to lower communications overhead so that teams have fewer obstacles to effective communication. Besides team structure, the geographic distribution and location of the team plays a major role in how effective a team can be with its internal and external communication.

Having teams work together at a single site also helps to enforce the sense of team identity and unity.

Co-location such as working in the same section of a building, sharing offices, or setting aside space specifically for teams to gather has in the past proven to be the most effective method to promote open communication, which is an essential ingredient to the SF team formula for success.

Although co-location is still the primary choice, the nature of business and the technological enhancements to communication available today do not prevent successful “virtual” teaming.

Virtual teams are teams of employees communicating and collaborating with each other primarily by electronic means. The communication occurs across organizational boundaries, space, and time. Collaborating in real time with colleagues through the Internet is profoundly changing the way people work and share information. The Internet is becoming a new standard of communication among team members, and collaborative software is paving the way for further productivity gains.

The notion of a virtual team is important, because without the organizational boundaries that encapsulate the roles into a coordinated unit, the virtual aspect requires even stronger communication, trust agreements, and relationships, explicit action plans, and automation tools that support tracking of projects and tasks so that action items do not get lost.

A vital component of a virtual team is the ability for each role to depend on and trust in the other roles to fulfill their responsibilities. This develops through a blend of culture, good management and, when possible, time spent working together at the same site.

Industry research finds that often little attention is given to communication skills or team fit when members are chosen for virtual teams. Analysts say this oversight is an important factor in the failure of many of these teams. When setting up a virtual team, look for members with the following characteristics:
Can work independently.
Demonstrate leadership skills.
Possess specific skills required for the solution.
Can share knowledge with the organization.
Can help develop effective methods of working.
   Total Participation in Design

Each role participates in creating the product specification because each role has a unique perspective of the design and its relationship to their individual objectives, as well as the team's objectives. This fosters a climate in which the best ideas from the various team perspectives can come to the surface.

Team Model Overview

SF is based on the belief that the six important quality goals should be achieved in order for a project to be considered successful. These goals drive the team and define the team model. While it is true that the entire team is responsible for the project's success, the team model associates the six quality goals with separate role clusters to ensure accountability and focus.

FIG. 18 is a block diagram depicting exemplary team model role clusters. The six role clusters of the team model—product management, program management, development, test, user experience, and release management define common ways to identify a combined set of functional areas and their associated responsibilities. Many times role clusters are simply referred to as roles. Either way, the concept is the same: the framework and the team model are scalable to meet the needs of a particular solution. A role, or a cluster, may be one or many people depending on the size and complexity of a project, as well as the skills required to fulfill the responsibilities of the functional areas.

The SF team model emphasizes the importance of aligning role clusters to business needs. Clustering associated functional areas and responsibilities, each of which requires a different discipline and focus, provides motivation for a well balanced team whose skills and perspective represent all of the fundamental project goals. Owning a clearly defined goal increases understanding of responsibilities and encourages ownership by the project team, which ultimately results in a better product. Since each goal is critical to the success of a project, the roles that represent these goals are seen as peers with equal say in decisions.

Note that these role clusters do not imply or suggest any kind of organization chart or set of job titles, because these will vary widely by organization and team. Most often, the roles will be distributed among different groups within the IT organization and sometimes with the business user community, as well as with external consultants and partners. The key is to have a clear determination of the individuals on the team that are fulfilling a specific role cluster and its associated functions, responsibilities, and contributions towards the goal.

| Role | | | |
|---|---|---|---|
| Cluster | Goal | Functional Areas | Responsibilities |
| Product | Satisfied | Marketing | Acts as customer advocate |
| Management | customers | Business Value | Drives shared project vision/scope |
| | | Customer Advocate | Manages customer requirements |
| | | Product Planning | definition |
| | | | Develops and maintains business |
| | | | case |
| | | | Manages customer expectations |
| | | | Drives features vs. schedule vs. |
| | | | resources tradeoff decisions |
| | | | Manages marketing, evangelizing |
| | | | and public relations |
| | | | Develops, maintains, and executes |
| | | | the communications plan |
| Program | Delivering the | Project Management | Drives development process to ship |
| Management | solution | Solution Architecture | product on time |
| | within project | Process Assurance | Manages product specification- |
| | constraints | Administrative | primary project architect |
| | | Services | Facilitates communication and |
| | | | negotiation within the team |
| | | | Maintains the project schedule and |
| | | | reports project status |
| | | | Drives implementation of critical |
| | | | trade-off decisions |
| | | | Develops, maintains, and executes |
| | | | the project master plan and |
| | | | schedule |
| | | | Drives and manages risk |
| | | | assessment and risk management |
| Development | Build to | Technology | Specifies the features of physical |
| | specification | Consulting | design |
| | | Implementation | Estimates time and effort to |
| | | Architecture and | complete each feature |
| | | Design | Builds or supervises building of |
| | | Application | features |
| | | Development | Prepares product for deployment |
| | | Infrastructure | Provides technology subject matter |
| | | Development | expertise to the team |
| Test | Approve for | Test Planning | Ensures all issues are known |
| | release only | Test Engineering | Develops testing strategy and plans |
| | after all | Test Reporting | Conducts testing |
| | product | | |
| | quality issues | | |
| | are identified | | |
| | and addressed | | |
| User | Enhanced user | Technical | Acts as user advocate on team |
| Experience | effectiveness | Communications | Manages user requirements |
| | | Training | definition |
| | | Usability | Designs and develops performance |
| | | Graphic Design | support systems |
| | | Internationalization | Drives usability and user |
| | | Accessibility | performance enhancement trade-off |
| | | | decisions |
| | | | Provides specifications for help |
| | | | features and files |
| | | | Develops and provides user training |
| Release | Smooth | Infrastructure | Act as advocate for operations, |
| Management | deployment | Support | support and delivery channels |
| | and ongoing | Operations | Manage procurement |
| | operations | Commercial Release | Manage product deployment |
| | | Mgmt. | Drive manageability and |
| | | | supportability trade-off decisions |
| | | | Manages operations, support, and |
| | | | delivery channel relationship |
| | | | Provide logistical support to the |
| | | | project team |

Satisfied Customers

Projects should meet the needs of customers and users in order to be successful. It is possible to meet budget and time goals but still be unsuccessful if customer needs have not been met.

Delivering the Solution within Project Constraints

An important goal for all teams is to deliver within project constraints. The fundamental constraints of any project include those of budget and schedule. Most projects measure success using “on time, on budget” metrics.

Build to Specification

The product specification describes in detail the deliverables to be provided by the team to the customer. It is important for the team to deliver in accordance with the specification as accurately as possible because it represents an agreement between the team and the customer as to what will be built.

Approve for Release Only after all Product Quality Issues Are Identified and Addressed

All software is delivered with defects. An important goal is to ensure those defects are identified and addressed prior to releasing the product. Addressing can involve everything from fixing the defect in question to documenting work-around solutions. Delivering a known defect that has been addressed along with a work-around solution is preferable to delivering a product containing unidentified defects that may surprise the team and customer later.

Enhanced User Effectiveness

In order for a product to be successful, it should enhance the way that users work and perform. Delivering a product that is rich in features and content but is not usable by its designated user is considered a failure.

Smooth Deployment and Ongoing Operations

Sometimes the need for a smooth deployment is overlooked. The perception of a deployment is carried over to the product itself, rightly or wrongly. For example, a faulty installation program may lead users to assume that the installed application is similarly faulty, even when this may not be true. Consequently, the team should do more than simply deploy; it should strive for a smooth deployment and prepare for the support and management of the product. This can include ensuring that training, infrastructure, and support are in place prior to deployment.

Team Model Role Clusters (see FIG. 18)

Product Management Role Cluster

The important goal of the product management role cluster is satisfied customers. Projects should meet the needs of customers in order to be successful. However, first the customer should be clearly identified and understood! In some cases the customer requesting a solution or set of features may be different from the sponsor who is paying or supporting effort. Thus there should be a clear distinction and requirements analysis for the success factors for both parties. Then can the responsibilities of setting and meeting the expectations be assigned to the appropriate function areas. It is possible to meet budget and time goals but still be unsuccessful if customer and business needs have not been met.

The SF team model separates functional areas for each role cluster in order to more narrowly define a set of responsibilities that when taken together often form a common skill set.

To achieve the goal of satisfied customers, the product management role cluster requires that several functional areas: product planning, business value, advocacy, and marketing.

Functional Areas:

Marketing

Drive marketing and public relations messages that have an impact on the target customer.
Be highly differentiated so the solution stands out from the competition.
Place the solution into distribution so that the target customer can easily acquire it.
Provide support so that customers have a positive experience buying and using the solution.
   Business Value
Define and maintain the business justification for the project.
Define and measure the business value realization and metrics.
   Customer Advocate
Drive a shared project and solution vision.
Manage customer expectations and communications.
   Product Planning
Gather, analyze, and prioritize customer and business requirements.
Perform market research, market demand, competitive intelligence/analysis.
Determine business metrics and success criteria.
Identify multi-version release plan.
   Marketing

Marketing is the process or technique of promoting, selling, and distributing a product, solution, or service. There are several facets of marketing: Launch marketing, sustained marketing, and public relations. Over the course of a solution lifecycle, the focus of marketing will shift. Knowing the location of your solution within the lifecycle will be critical to executing the appropriate level of activities.

Business Value

Within the business value functional area, product management provides customers, Business Decision Makers (BDMs), with as concise a predictive measure as they require for the financial and operational return to the business from investment in an IT solution.

To be effective in providing a useful solution, product management should gain knowledge about customers business, success factors, and important performance measures. The process of capturing this knowledge can be defined as business value assessment or identifying critical success factors. Clearly, knowing what will make the customer successful helps in determining and proposing appropriate solutions. With increasing regularity, IT investments are coming under intense scrutiny and many IT-side contacts require financial review before signing off on projects. By performing objective cost-benefit analysis, the likelihood of satisfying the customer is increased. The calculation of financial results completes the development of a business case for IT investment.

Customer Advocate

This functional area contains responsibilities for high-level communications and management of customer expectations. High-level communications include public relations, briefings to senior management/customers, marketing to users, demonstrations, and product launches. Managing expectations is the important role of product management once the vision is set. It is considered to be a primary role because it can determine the difference between success and failure.

The importance of effectively managing expectations can be illustrated with an example involving the anticipated delivery of ten product features from a team to a customer by a certain date. If the team delivers only two features when the customer expects the delivery of all ten, the project will be deemed a failure both by the customer and by the team.

If, however, product management maintains constant two-way communication with the customer during the feature development and production period, changes can be made with regard to customer expectations that can ensure success. Product management can include the customer in the tradeoff decision-making process and inform them of changing risks and other challenges. Unlike the previous scenario, the customer can assess the situation and agree with the team that delivery of all ten features within the specified time frame is unrealistic and that delivery of only two is acceptable. In this scenario, the delivery of two features now matches the customer's expectations and both parties will consider the project a success.

Product Planning

Product planning identifies the requirements and feature set(s) for multiple versions of a solution. A goal of product planning is to make it easy for a program manager or developer to understand a solution requirement in the least amount of time possible. This entails first, understanding the current requirements of a solution completely—what the needs of the business are, how customers will use it, what the support issues will be, and what alternatives are available. Second, the features that would add value to customers who use the solution are examined, such as the ability to enable entry into new business segments, integration with other systems, greater productivity, upgrading from other solutions, reducing support costs, and so on. Based on this knowledge, the product planner can recommend specific features that can be assigned to each solution release and prioritize the feature list.

At the core of product planning is research and analysis. Whether understanding the customer and business needs or understanding the competitive landscape, it comes down to appropriate attention to the research and analysis. This will prevent unnecessary features from being built into the solution.

Program Management Role Cluster

The focus of the program management role is to meet the goal of delivering the solution within project constraints. This can be viewed as ensuring that the project sponsor is satisfied with the outcome of the project. To meet this goal, program management owns and drives the schedule, the feature set, and the budget for the project. Program management ensures that the right solution is delivered at the right time and that the project sponsor's expectations are understood and managed throughout the project. Descriptions of selected functional areas are shown below:

Project Management

Track and manage budget.
Manage master project schedule.
Drive risk management process.
Facilitate communication and negotiation within the team.
Track progress and managing project status reporting.
Manage resource allocation
   Solution Architecture
Drive overall solution design.
Manage the functional specification.
Manage the solution scope and critical trade-off decisions.
   Process Assurance
Drive process quality assurance.
Define and recommend improvements.
   Administrative Services
Implement the project management processes and support the team leads in using them.
Provide a range of administrative services to support efficient team working.
   Project Management

As the owner of the schedule, project management collects all team schedules, validates them, and integrates them into a master schedule that is tracked and reported to the team and the project sponsor.

As the owner of the budget, project management facilitates the creation of the project budget by gathering resource requirements from all of the roles on the team. Project management should understand and agree with all resource decisions (hardware, software, and people) and should track the actual expenditure against the plan. The team and the project sponsor receive status reports.

In addition, project management coordinates resources, facilitates team communication, and helps drive critical decisions.

Solution Architecture

Solution architecture is the functional area of the program management role cluster responsible for the logical design of the solution and the functional specification. Solution architecture focuses on ensuring that a solution can be used by specified users to achieve specified goals with effectiveness, efficiency, and satisfaction.

Solution architect responsibilities include:
Driving overall solution design.
Managing functional specification.
Managing the solution scope and critical trade-off decisions.

Owning the logical design, solution architecture provides the vital link between the business side of the solution (as represented by product management in the conceptual design) and the technology side of the solution (as represented by development in the physical design). Solution architecture acts as the custodian of the functional specification. It drives the team to achieve consensus about the content and design of the solution among the demands of their other roles, and justifies the agreed-on approach to the project stakeholders. It is also responsible for ensuring traceability of features back to requirements (and ultimately to the generation of business value), so that all features can be seen to support stated requirements and so that the team can assess the impact of any feature changes on the value of the solution.

Solution architecture activities include:
Create the solution concept and align it with customer's enterprise architecture; devise versioned release strategy; review plans for requirements capture.
Capture requirements from architectural/standards groups and regarding interoperability; drive the logical design process;
provide a traceability map tracing features back to requirements and benefits; create the functional specification; define interim releases.
Manage changes to the functional specification; maintain traceability map; clarify the specification to other team roles and to external stakeholders; liaise with other project teams on interoperability issues.
Participate in triage process; manage project stakeholders expectations regarding solution content.
Provide updates to enterprise architecture team; update requirements for future versioned releases.

Solution architecture practitioners should be technically sound, with a broad base of knowledge and experience and the ability to relate the technical issues to the underlying needs of the business. While the solution architect may rely on the development team for expertise on the specific technologies being used in the solution, they should be able to grasp the implications of those technical details very rapidly and understand their inter-relationships and their impact on the environment into which the solution will be deployed. The solution architect should also be able to discuss those impacts with the customer's architects so as to resolve rapidly any conflicts between the proposed solution and the enterprise architecture.

Process Assurance

The process assurance functional area of program management ensures that the project team adopts processes that focus on meeting the overall project quality goals, with an emphasis on eliminating sources of defect. Process assurance is responsible for two main areas:
Defining the important project processes to be used by the team and providing advice and guidance to the team on their implementation
Undertaking reviews to validate the relevance and effectiveness of the processes, recommending improvements, and monitoring compliance.
   Process Assurance Focuses on the Following Activities:
Define project protocols and processes in line with the project design.
Provide advice and guidance on effective implementation of the project processes; validate compliance with processes; undertake milestone reviews; recommend process improvements.

Process assurance benefits from a degree of independence from the project team so that it can take an external perspective. For this reason, it is often managed from outside the project team, even if the project size does not make it a full-time role.

Administrative Services

This is the functional area of the program management role cluster that is responsible for implementation of the project management processes and for administrative support of the project team.

The project administration functional area ensures that the project team implements processes that meet the project design specification defined by project management. It is responsible for ensuring that the project team can operate effectively with the minimum of bureaucracy.

Project administration responsibilities include:
Implementing the project management processes and supporting the team leads in using them. This includes consolidating team input to maintain the master plan and schedule and assisting leads in progress reporting.
Providing a range of administrative services to support efficient team working, such as scheduling meetings, general procurement, and contract management.

Project administration focuses on:
Supporting project initiation processes, such as efficient recruitment of team members from third parties; manage contractual arrangements; organize team facilities (space, telephones, security access, and so on).
Establishing consistent planning framework; assist team leads in planning and scheduling; consolidate team input to create master plan and schedule; establish financial and progress reporting processes.
Assisting team leads in progress reporting; create overall progress and financial reports.
Ensuring closure of all administrative systems on project completion.
Performing general administrative support activities such as scheduling meetings, implementing risk and issue management processes; maintaining the master risk list, action list, and so on; generating financial and progress reports; managing team location to enhance morale.

The project administration role requires a combination of strong administrative capability and attention to detail with sound experience in project planning and scheduling techniques, as well as a good understanding of the policies and guidelines operative in the supplier organization. On a larger project it provides an excellent opportunity to work alongside project direction and build the experience needed to direct future projects.

Development Role Cluster

The “build to specification” goal is the focus for the development role cluster during an SF project. To succeed in meeting its quality goal, the role of development is to build a solution that meets the customer's expectations and specifications as expressed in the functional specification. The development role cluster adheres to the solution architecture and designs that, together with the function specification, form the overall specifications of the solution.

In addition to being the solution builders, development serves the team as the technology consultant. As technology consultant, development provides input into design and technology selection decisions, as well as constructing functional prototypes to validate decision-making and mitigate development risks.

As builders, development provides low-level solution and feature design, estimates the effort required to deliver on that design, and then builds the solution. Development estimates its own effort and schedule because it works daily with all developmental contingency factors. SF refers to this concept as bottom-up estimating, and it is a fundamental part of the SF philosophy. Its goal is to achieve a higher quality of schedule and to increase accountability of those providing the estimates and of their work performance.

Technology Consulting Functional Area
Serve the team as a technology consultant.
Evaluate and validate technologies.
Participate actively in the creation and review of the functional specification.
Contribute to defining development standards for the organization.

Implementation architecture and design functional area
Map the Enterprise Architecture (EA) to the solution's implementation architecture by providing solution-specific detail for application, data, and technology views of the architecture.
Own and implement the logical and physical designs of the solution.

Application Development Functional Area
Code features to meet the design specifications.
Conduct code reviews during development to share knowledge and experience.
Carry out unit testing as defined in the test plan with the support of the test role.

Infrastructure Development Functional Area
Develop features that meet the design specifications.
Conduct code reviews during development to share knowledge and experience.
Carry out unit testing as defined in the test plan with the support of the test role.
Develop scripts for automated deployment.
Develop deployment documentation.
   Technology Consulting Functional Area

The technology consulting functional area serves as a technical resource throughout the project lifecycle. As a technology consultant, development should provide input into high-level designs, evaluate and validate technologies, and conduct research to mitigate development risks early in the development process.

During the envisioning phase, this functional area focuses on analyzing the requirements of the user/customer from an implementer's perspective. The functional area contributes to the definition of the vision/scope document by evaluating the technical implications of the project for implementation feasibility within the initial parameters of the project. It provides guidance on the pros and cons of possible implementation approaches and validates initial technology choices. In this process the functional area may conduct research, consult with counterparts in the organization or elsewhere, and hold discussions with technology providers. For additional validation, the functional area may develop a limited-functionality prototype to serve as a proof of concept. This is particularly relevant for projects that require the use of new technologies or in areas where the project team lacks experience.

Implementation Architecture and Design Functional Area

The implementation architecture and design functional area describes a set of responsibilities relating to the definition of an implementation architecture for the solution and the development of solution designs during an SF project.

From a design standpoint, program management is responsible for the overall architecture of the solution and its positioning in the enterprise architecture. Development is responsible for mapping the enterprise architecture to the solution's implementation architecture by providing solution-specific detail for the application, data, and technology views of the solution.

SF proposes a three-tiered design process: Conceptual design, logical design, and physical design. Program management and product management co-own conceptual design. Conceptual design includes user scenarios, high-level usability analysis, conceptual data modeling, and initial technology options. Development owns the logical and physical aspects of the solution design. Logical and physical designs require knowledge of relevant technology and the impact of technology choices on the design of a solution.

Application Development Functional Area

The application development functional area describes a set of responsibilities relating to the development of a software application during an SF project. The development role's primary responsibility within this functional area is to build the features of the desired solution to specifications and designs, conduct unit testing, address quality issues identified in the testing process, and carry out the integration of solution components to produce the final deliverable.

The development role contributes to the definition of standards and adheres to these during solution development. Code reviews are conducted by development to assess the quality level of the application's features at the unit level. Reviews allow team members to share development knowledge and experience, supporting the SF goal of “willingness to learn” for project teams. The development role is required to conduct and document results of satisfactory unit-level testing of the features implemented. The test role works actively with the development role to plan for and conduct the assessment of the quality of the solution feature independently and as part of the complete solution.

Infrastructure Development Functional Area

The infrastructure development functional area describes a set of responsibilities relating to the development of a systems and software infrastructure for a solution during an SF project. The systems infrastructure includes the network infrastructure for a distributed computing environment, the client and server systems, and any supporting components. The software infrastructure includes the operating systems for clients and servers, as well as the software products that provide the required platform software services, for example, directory, messaging, database, enterprise application integration, systems management, network management, and so on.

During infrastructure development, the development role “develops” the infrastructure specified in the design. This includes configuring the foundation technology infrastructure for the solution, for example networking support, and the client and server systems as defined by the design. Aspects of the infrastructure can be influenced by the requirements of applications to be supported and vice versa. For example, a mission-critical high-performance solution may need to accommodate clustering and load-balancing of the back-end servers. Operating systems and platform products for the solution need to be appropriately “developed.” The various software platform products should be installed, configured, and optimized to meet solution needs. After suitable testing and stabilizing, the infrastructure solution is deployed on a broad scale under the charge of the release management role, which has managed the acquisition of the solution's infrastructure requirements.

Test Role Cluster

The goal of the test role cluster is to approve for release only after all product quality issues are identified and addressed. All software is delivered with defects. An important goal is to ensure those defects are identified and addressed prior to releasing the product. Addressing can involve everything from fixing the defect in question to documenting work-around solutions. Delivering a known defect that has been addressed along with a work-around solution is preferable to delivering a product containing unidentified defects that may surprise the team and customer later.

To be successful, the test team role cluster should focus on certain important responsibilities. Those responsibilities are grouped within the three important functional areas.

Test Planning

Develop testing approach and plan.
Participate in setting the quality bar.
Develop test specification.
   Test Engineering
Develop and maintains automated test cases, tools, and scripts.
Conduct tests to accurately determine the status of product development.
Manage the build process.
   Test Reporting
Provide the team with data related to product quality.
Track all bugs and communicates issues to ensure their resolution before product release.
   Test Planning

The test planning functional area is the part of the test role cluster that focuses on how the team will ensure that all product quality issues are identified and addressed.

The test role develops testing approaches and plans, and by doing so outlines the strategy the team will use to test the solution. These plans include the specific types of tests, specific areas to be tested, test success criteria, and information on the resources (both hardware and people) required to test.

An important part of the test planning functional area is participation in setting the quality bar by providing input to the project team on quality control measures and criteria for success of the solution.

The final activity within the test planning functional area is to develop the test specification. This is a detailed description of the tools and code necessary to meet the needs defined in the test plan.

Test Engineering

The test engineering functional area, as part of the test role cluster, focuses on carrying out the activities defined in test planning required to ensure that all product quality issues are identified and addressed. Among the responsibilities defined within this area are specific duties to develop and maintain test cases; development of tools, scripts, and documentation to perform testing functions; management of daily builds to ensure that test procedures can be performed and reported on a single frame of reference; and conducting tests to accurately determine the status of product development-running through the test cases, tools, and scripts to identify issues with the current build

Tracking and Reporting

The tracking and reporting functional area, as part of the test role cluster, focuses on articulating clearly to the project team what is currently wrong with the solution and what is currently right so that the status of development is accurately portrayed.

Issue tracking is performed to ensure that all identified issues have been resolved before product release. Document issue status, including assignment, priority, resolution, and work-arounds are completed on a frequent basis to provide the team with data related to current product quality status and detailed trend analysis.

User Experience Role Cluster

The goal of the user experience role cluster is enhanced user effectiveness. User experience is comprised of six functional areas: Accessibility, internationalization, technical communications, training, usability, and graphic design. The user experience role cluster has several responsibilities within each functional area that should be managed for the solution to be successful. Following is a listing of the functional areas and related responsibilities.

Accessibility
Drive accessibility concepts and requirements into design.

Internationalization
Improve the quality and usability of the solution in international markets.

Technical Communications
Design and develops documentation for support systems (Helpdesk manuals, KB articles, and more).
Document Help/assistance.

Training
Develops and executes learning strategy (build/buy/deliver).

Usability
Gather, analyze, and prioritize user requirements.
Provide feedback and input to solution design.
Develop usage scenarios and use cases.
Act as the user advocate to the project team.

Graphic Design
Drives user interface design.
   Accessibility

The accessibility functional area focuses on ensuring that solutions are accessible to those with disabilities by driving accessibility concepts and requirements into the design. Accessibility is important for many reasons. Primarily, accessibility is important because products and solutions need to be accessible and usable by all people regardless of their capabilities. A product or solution that does not account for accessibility will fall short of full adoption. Additionally, accessibility compliance will often be required to meet government regulations.

Accessibility concepts and requirements should be represented throughout the solution development cycle and should include:
The incorporation of an accessibility section within each feature specification.
Integrating accessibility information into the solution help section.
Ensuring that accessibility documentation is complete.
Ensuring that accessibility documentation is presented in accessible formats.
   Internationalization

The responsibility within the internationalization functional area is to improve the quality and usability of the solution in international markets. The internationalization functional area is composed of both globalization and localization processes.

Globalization

Globalization is the process of defining and developing a solution that takes into account the need to localize the solution and its content without modification or unnecessary workarounds by the localizers. In other words, a released solution that is globalized properly is ready to localize with a minimum of difficulty.

Localization

Solution localization involves modifications to the solution's user interface, Help files, printed and online documentation, marketing materials, and Web sites. Occasionally, these materials may require changes in graphical elements for a particular language version, or even content modifications.

Technical Communications

The technical communications functional area focuses on the development of solution document support systems.

A major responsibility of the technical communications functional area is the creation of tools components such as the Help tool. The Help tool empowers the user by providing answers to basic questions, keyword descriptions, error explanations, and frequently asked questions. Tools such as Help benefit both the user and the organization. Users benefit because they get responses to issues and questions in a timely and effective manner. The organization benefits by a reduction in support costs.

An additional responsibility of the technical communications functional area is designing and developing documentation for the solution. This may include the development of installation, upgrade, operations, and troubleshooting guides.

Training

The training functional area focuses on enhancing user performance by providing the skills knowledge needed to effectively use the solution. This skills knowledge transfer is achieved by implementing a learning strategy. The development of the learning strategy is the responsibility of the user experience team role cluster.

The development of the learning strategy may take place within the organization, or it may be outsourced to an organization that specializes in training and development. Regardless of who actually develops the learning strategy, the approach will most often include:
Making an analysis of the user and the goals and objectives of the organization.
Setting the desired skill level set.
Developing and implementing a training plan.
Upon implementation, measuring the training plan for effectiveness and modifying the training plan as appropriate, to assure success.

The learning strategy may comprise one or more of the following delivery mechanisms: Instructor-led training, technology delivered training, self study or the use of job aids. Many organizations choose a blended approach that adapts to the individuals own learning style.

Usability

The usability functional area focuses on ensuring that a solution can be used by specified users to achieve specified goals with high levels of effectiveness, efficiency, and satisfaction.

A major responsibility defined within the usability functional area is usability research, which includes gathering, analyzing, and prioritizing user requirements. By investing time to understand the user early on and throughout the solution development effort, the project will have a much higher likelihood of effectively meeting the needs of the users.

Another major responsibility as defined within the usability functional area is developing usage scenarios and use cases. The important idea here is to step back and look at how the entire solution will likely be used. This effort helps the development team understand how a user approaches the solution from a conceptual and literal standpoint and often will lead to design improvements resulting in increased efficiency.

Another major responsibility as defined within the usability functional area is providing feedback and input to the solution. By taking the time to provide user feedback to the developers throughout the development cycle, the solution will benefit by achieving a higher rate of user satisfaction.

Graphic Design

The graphic design functional area focuses on ensuring that graphical elements within the solution are designed appropriately. The major responsibility of the graphic design functional area is driving the design of the user interface. This involves designing the objects that the user is going to interact with (and the actions applied to those objects), as well as the major screens in the interface.

Release Management Role Cluster

The goal of the release management role cluster is smooth deployment and on-going operations. Release management is the role that directly involves operations on the SF team. It includes the following functional areas of responsibility:
Acts as primary advocate between project development and operations groups.
Manages tool selection for release activities and drives optimizing automation.
Sets operational criteria for release to production.
Participates in design, focusing on manageability, supportability, and deployability.
Drives training for operations.
Drives and sets up support for pilot deployment(s).
Plans and manages solution deployment into production.
Ensures that stabilization measurements meet acceptance criteria.

Infrastructure:
Enterprise infrastructure planning.
Coordinate physical environment use and planning across geographies (data centers, labs, field offices).
Provide the team with policies and procedures for consistent infrastructure management and standards.
Provide infrastructure services to the SF team (building servers, standard images, installing software).
Manage hardware/software procurement for the team.
Build test and staging environments that accurately mirror production environments.

Support:
Provide primary liaison and customer service to the IT users.
Support the business by managing the SLA with the customer and ensuring commitments are met.
Provide incident and problem resolution; rapid response to user requests and logged incidents.
Give feedback to development and design team.
Develop failover and recovery procedures.

Operations:
Account and system setup controls; manage user accounts and permissions.
Messaging, database, telecom operations; network operations.
Systems administration, batch processing.
Firewall management; security administration.
Application services.
Host integration services.
Directory service operations.

Commercial Release Management:
Product registration codes; registration verification process.
Licensing management.
Packaging.
Manage distribution channel.
Print and electronic publication.

Infrastructure:

The infrastructure functional area describes a set of responsibilities relating to the operations infrastructure that should be satisfied during an SF project. It is part of the SF release management role cluster. For projects using OF, these correspond to the responsibilities of the OF infrastructure role cluster.

Support:

This functional area focuses on ensuring that the solution built and deployed is supportable. For projects using OF, these correspond to the responsibilities of the OF support role cluster.

Operations:

This functional area describes a set of operations responsibilities that should be satisfied during an SF project. This functional area focuses on ensuring that the solution built and deployed is operable and compatible with other services in operation. For projects using OF, these correspond to the responsibilities of the OF support role cluster.

Commercial Release Management:

This functional area describes a set of responsibilities relating to releasing commercial software products. Commercial release management focuses on getting the product into the channel.

Scaling the Team Model

The SF team model advocates breaking down large teams (those greater than ten people) into small, multidisciplinary feature teams. These small teams work in parallel, with frequent opportunities to synchronize their efforts.

In addition, function teams may be used where multiple resources are required to meet the needs of a particular role and are grouped accordingly within that role.

Feature Teams

Each role cluster in the team model comprises one or more resources organized in a hierarchical structure (although generally as flat as possible). For example, testers report to a test manager or lead.

Overlaid on this structure are feature teams. These are smaller sub-teams that organize one or more members from each role into a matrix organization. These teams are then assigned a particular feature set and are responsible for all aspects of it, including its design and schedule. For example, a feature team might be dedicated to the design and development of printing services.

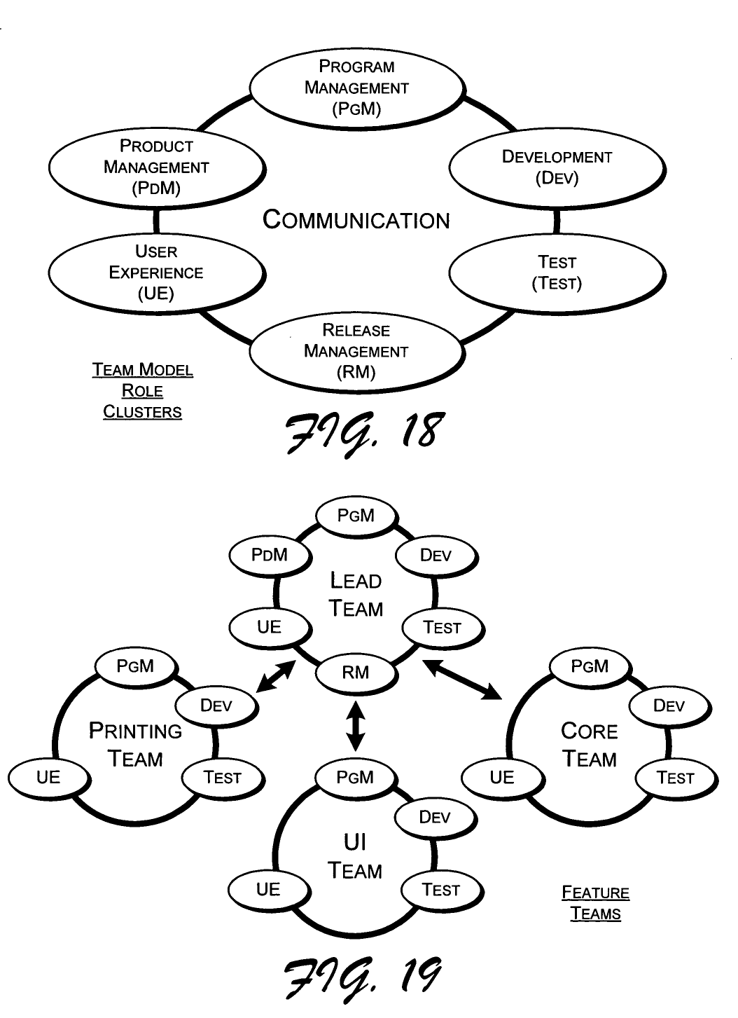

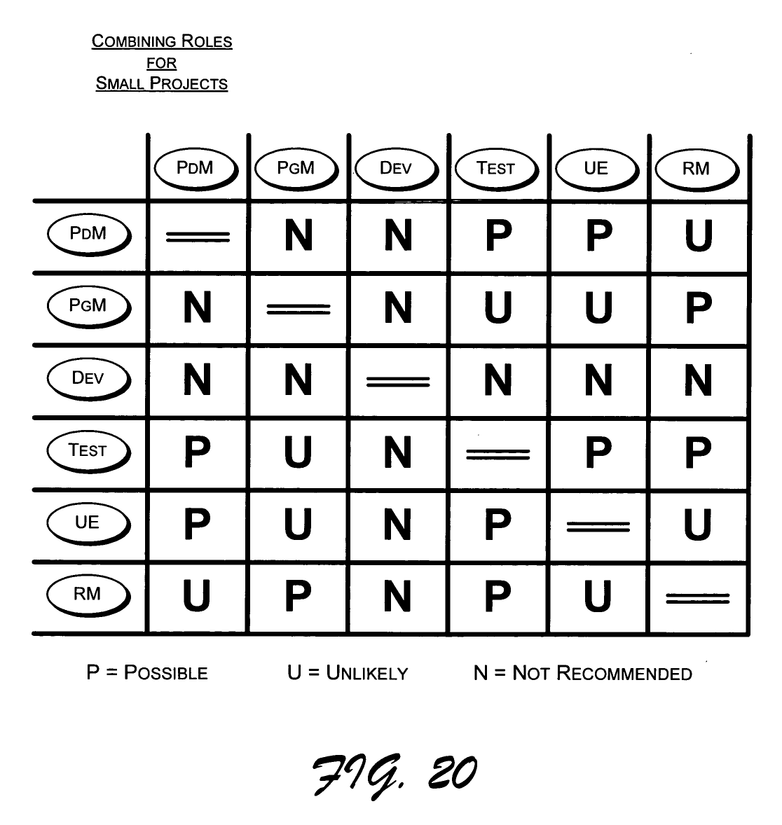

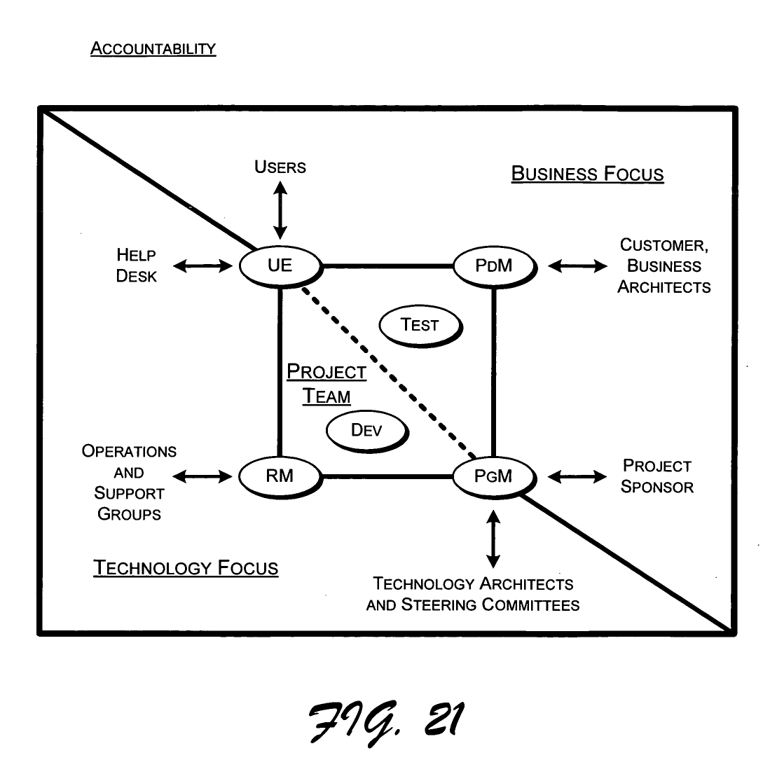

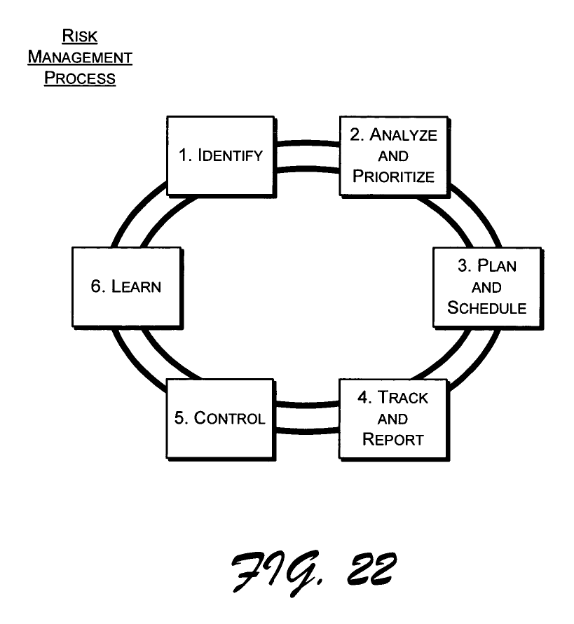

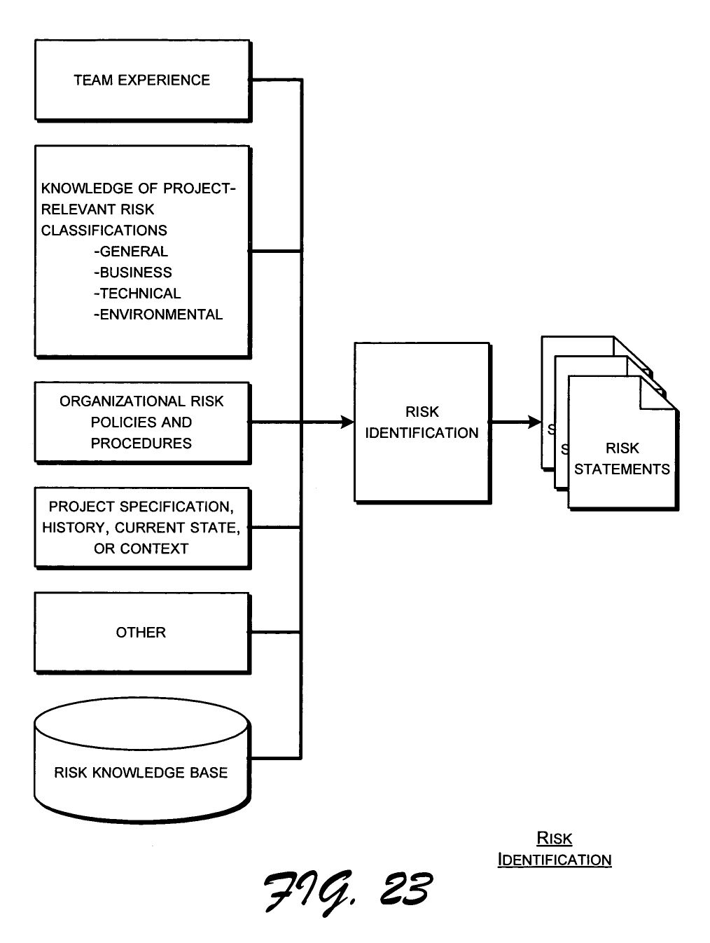

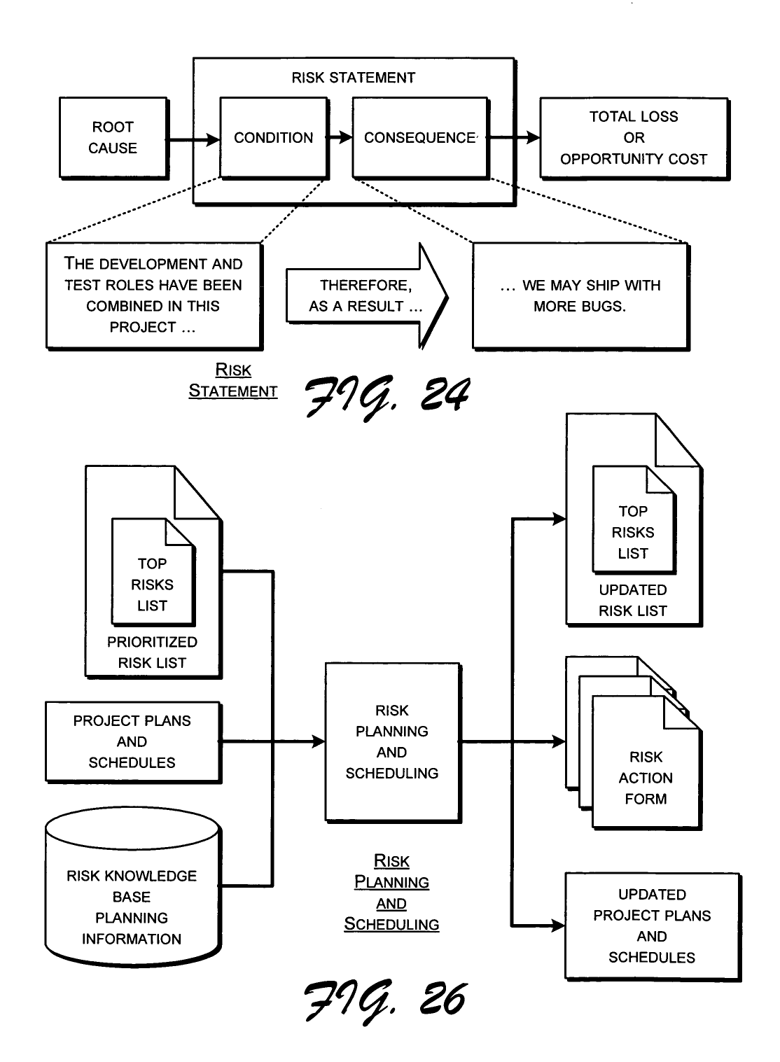

FIG. 19 is a block diagram depicting exemplary feature teams. The exemplary feature teams include a lead team, a printing team, a core team, and a UI team. However, the graphical example in FIG. 19 does not represent requirements for the organization of feature teams. For example, not all feature teams require the role of User Experience; the teams should be organized as required to meet the goal of their solution focus.

Function Teams

Function teams are teams that exist within a role. They are the result of a team or project being so large that it requires the people within a role to be grouped into teams based upon their functionality. For example, it is common at some institutions for a product development team to have a product planner and a product marketer. Both jobs are an aspect of product management: One focuses on getting the features the customer really wants and the other focuses on communicating the benefits of the product to potential users.

This can also be true for development, where developers may be grouped by the service layer they work on: user, business, or data. It is also common for developers to be grouped on the basis of whether they are solution builders or component builders. Component builders are usually low-level C developers who create reusable components that can be leveraged by the enterprise. Solution builders build enterprise applications by “gluing” these components together.

Often function teams include a hierarchical structure internal to that group. For example many program managers report up through lead program managers, with the leads reporting to a group program manager. A structure like this can also occur for the functional areas rather than at the role cluster level. The important thing to keep in mind is that the hierarchy does not hinder the team model at the project level. The goals of the roles remain the same as well at their overall accountability to the project team.

Sharing Roles

Even though the team model consists of six roles, a team doesn't need a minimum of six people. It also doesn't require one person per role. The important point is that six goals have to be represented on every team. Typically, having at least one person per role helps to ensure that someone looks after the interests of each role, but not all projects have the benefit of filling each role in that fashion. Often, team members should share roles.

On smaller teams, roles should be shared across team membership. Two, principles guide role sharing. The first is that development team members do not share a role. Developers are the project builders and they should not be distracted from their main task. To give additional roles to the development team only makes it more likely that schedules will slip due to these other responsibilities.

The second guiding principle is to try not to combine roles that have intrinsic conflicts of interest. For example, product management and program management have conflicting interests and should not usually be combined. Product management wants to satisfy the customer whereas program management wants to deliver on time and on budget. If these roles were combined and the customer were to request a change, the risk is that either the change will not get the consideration it deserves to maintain customer satisfaction or that it will be accepted without understanding the impact to the project. Having different team members represent these roles helps to ensure that each perspective receives equal weight. This is also true if trying to combine testing and development.

FIG. 20 is a block diagram depicting an exemplary process for combining roles. For example, it illustrates risky (as indicated by “N/Not Recommended” or “U/Unlikely” symbols) and synergistic (as indicated by “P/Possible” symbols) combinations of roles, but as with any teaming exercise, successful role sharing comes down to the actual members themselves and what experience and skills they bring with them.

The row column intersections with the N indicate that these roles are not recommended to be combined unless absolutely necessary because of conflicting interests and unless the associated risks can be addressed with associated risk mitigation and contingency plans. It is clear the goals of the roles have varying levels of conflict which both makes the team model dynamic and in turn increases the possibility of problems when trying to combine. That said, role combinations are not uncommon—and if the team chooses smart combinations and actively manages the associated risks, the problems that occur should be minimal.

Escalation and Accountability:

The SF Team Model is not Intended as an Organization Chart

One question that often arises when applying the SF team model is: “Who is in charge?” An organization chart describes who is in charge and who reports to whom. In contrast, the SF team model describes important roles and responsibilities for a project team, but does not define the management structure of the team from a personnel administration perspective. In many cases, the project team includes members from several different organizations, some of whom may report administratively to a different manager.

There are certain situations that may arise, however, in which the team cannot come to consensus on an issue. After spending due diligence in trying to come to agreement, there are times that the role of program management should step up and take the primary lead in order to move the project forward. The primary goal of the program management role is delivery within project constraints, one which is time. Thus, to fulfill the goal of this role and of the team, there are times when the role of program management temporarily becomes a top down decision making authority in order to get the project back on track. It is during these instances that the leadership that has typically been shared throughout the roles understands the need for this shift and creates a stronger level of acceptance from the team and buy-in on the authoritative decision made for the purpose of reaching the project goals. As soon as the issue has been resolved and the team is able to get back into consensus there is an immediate shift back into the shared leadership responsibilities. The team of peers has proven to be flexible and adaptable enough to successfully handle these challenges yet remain a non-hierarchical approach to project teaming.

External Coordination—Who Is Accountable?

In order for a team to be successful, it should interact, communicate, and coordinate with other external groups. These range from customers and users to other development teams. In most cases, the customer requires explicit accountability for the solution to reside within one point of contact on the team. And although the team of peers requires a shared accountability within for the successful delivery of the solution, it is important to have a clear distinction of the accountability and reporting structure documented in the communications plan so that both the customer and the development team know how who on the team is responsible for facilitating this information.

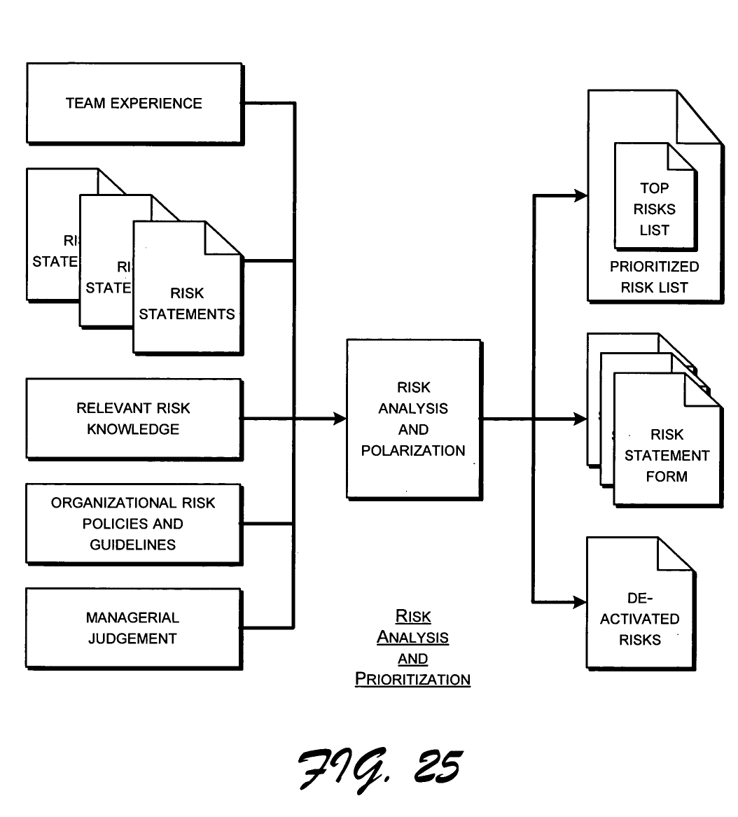

FIG. 21 is a block diagram depicting an exemplary accountability paradigm. It illustrates where responsibilities typically lie for coordination either with a business focus or a technology focus. Program management, product management, user experience, and release management are the primary facilitators. These roles are both internally and externally focused, whereas development and testing are internally focused and insulated from external communications.

This does not mean that developers and testers should be isolated from the outside world. Contact with the customer organization and with real users can be invaluable to build the customer-focused mindset that SF teams look to achieve, especially in the earlier, formative stages of a project. Such communications should not, however, provide the formal communications since they would suffer badly as the development and testing teams focus on solution delivery during the latter stages of a project.

The diagram of FIG. 21 represents a high-level perspective. Typically, teams have to coordinate with many more external groups, such as quality assurance, finance, and legal. It is important that the interfaces with any external groups be explicit and understood and that development and testing continue to be insulated so that they can work effectively without unnecessary disruptions.

In addition it is important to emphasize that, while external coordination through the various roles can provide input and recommendations, neither individual members of the team or the team as a whole have the authority to change the priority or specifics of the project trade offs, such as features, schedule, and resources. Those changes are at the prerogative of the project customer or sponsor and implemented by the project team. This also provides an example of how a team of equal partners or peers defers to and aligns with organizational authorities, hierarchies, and structures.

The SF team model is not a guarantee for project success. More factors than just team structure determine the success or failure of a project, but team structure is important.

A project that lacks team structure can fail despite having hard working and intelligent participants. The SF team model is meant to address just that point. Proper team structure is fundamental to success, and implementing this model and using its underlying principles will help make teams more effective and therefore successful.

SF Risk Management Discipline

Risk management is an important discipline of SF. SF recognizes that change and the resulting uncertainty are inherent aspects of the IT life cycle. The SF Risk Management Discipline advocates a proactive approach to dealing with this uncertainty, assessing risks continuously, and using them to influence decision-making throughout the life cycle. The discipline describes principles, concepts, and guidance together with a five-step process for successful, ongoing risk management: Identify risks, analyze risks, plan contingency and mitigation strategies, control the status of risks, and learn from the outcomes.

Introduction

SF defines a process for continually identifying and assessing risks in a project, prioritizing those risks, and implementing strategies to deal with those risks proactively throughout the project life cycle as defined by the SF Process Model.

This section presents the basic concepts of the SF Risk Management Discipline, which describes the principles, concepts, guidance, and a six-step process for successful management of IT project risk. The approach is a proactive risk management process.

SF Risk Management Discipline extends project-focused, risk management process into alignment with enterprise IT strategy through knowledge asset recovery and tight integration with all phases of the project life cycle. Within SF, risk management is the process of identifying, analyzing, and addressing project risks proactively so that they do not become a problem and cause harm or loss.

SF Risk Management Discipline has the following defining characteristics:
It is comprehensive, attempting to address most if not all of the elements in a project: People, processes, and technology elements.
It incorporates a stepwise, systematic, reproducible process for project risk management.
It is applied continuously throughout the project life cycle.
It is proactive and not reactive in orientation.
It has a commitment to individual and enterprise level learning.
It is flexible and can accommodate a wide range of quantitative and qualitative risk analysis methodologies.
   Some Exemplary Risk Fundamentals

An important aspect of project management is controlling the inherent risks of a project. Risks arise from uncertainty surrounding project decisions and outcomes. Most individuals associate the concept of risk with the potential for loss in value, control, functionality, quality, or timeliness of completion of a project. However, project outcomes may also result in failure to maximize gain in an opportunity and the uncertainties in decision making leading up to this outcome can also be said to involve an element of risk. In SF, a project risk is broadly defined as any event or condition that can have a positive or negative impact on the outcome of a project. This wider concept of speculative risk is utilized by the financial industry where decisions regarding uncertainties may be associated with the potential for gain as well as losses, as opposed to the concept of pure risk used by the insurance industry where the uncertainties are associated with potential future losses only.

Risks differ from problems or issues because a risk refers to the future potential for adverse outcome or loss. Problems or issues, however, are conditions or states of affairs that exist in a project at the present time. Risks may, in turn, become problems or issues if they are not addressed effectively. Within SF, risk management is the process of identifying, analyzing, and addressing project risks proactively. The goal of risk management is to maximize the positive impacts (opportunities) while minimizing the negative impacts (losses) associated with project risk. An effective policy of understanding and managing risks will ensure that effective trade-offs are made between risk and opportunity.

IT projects have characteristics that make effective risk management important for success. Competitive business pressures, regulatory changes, and technical standards evolution can sometimes force IT project teams to modify plans and directions in the middle of a project. Changing user requirements, new tools and technologies, evolving security threats, and staffing changes all result in additional pressure for change being brought upon the IT project team that force decision-making in the face of uncertainty (risk).

Some Foundation Principles

The SF Risk Management Discipline is founded on the belief that it should be addressed proactively; it is part of a formal and systematic process that approaches risk management as a positive endeavor. This discipline is based on foundational principles, concepts, and practices that are central to SF. The SF foundational principles contribute to effective project risk management. However, the following principles are especially important for the SF Risk Management Discipline.

Stay Agile-Expect Change

The prospect of change is one of the main sources of uncertainty facing a project team. Risk management activities should not be limited to a single phase of the project life cycle. All too often, teams start out a project with the good intention of applying risk management principles, but fail to continue the effort under the pressures of a tight schedule all the way through project completion. Agility demands that the team continuously assess and proactively manage risks throughout-the phases of the project life cycle because the continuous change in various aspects of the project means that project risks are continuously changing as well. A proactive approach allows the team to embrace change and turn it into opportunity to prevent change from becoming a disruptive, negative force.

Foster Open Communications

SF proposes an open approach toward discussing risks, both within the team as well as with important stakeholders external to the team. Team members should be involved in risk identification and analysis. Team leads and management should support and encourage development of a no-blame culture to promote this behavior. Open, honest discussion of project risk leads to more accurate appraisal of project status and better informed decision making both within the team and by executive management and sponsors.

Learn from All Experiences

SF assumes that keeping focus on continuous improvement through learning will lead to greater success. Knowledge captured from one project will decrease uncertainty surrounding decision-making with inadequate information when it becomes available for others to draw upon in the next project. SF emphasizes the importance of organizational or enterprise level learning from project outcomes by incorporating a step into the risk management process. Focusing directly on capturing project outcome experiences encourages team-level learning (from each other) through the fostering of open communications among all team members.

Shared Responsibility, Clear Accountability

No one person “owns” risk management within SF. Everyone on the team is responsible for actively participating in the risk management process. Individual team members are assigned action items specifically addressing project risk within the project schedule and plans, and each holds personal responsibility for completing and reporting on these tasks in the same way that they do for other action items related to completion of the project. Activities may span all areas of the project during all phases of the project and risk management process cycles. It includes risk identification within areas of personal expertise or responsibility and extends to include risk analysis, risk planning, and the execution of risk control tasks during the project. Within the SF team model, the project management functional area of the program management role cluster holds final accountability for organizing the team in risk management activities, and ensuring that risk management activities are incorporated into the standard project management processes for the project.

Important Concepts

Risk Is Inherent in any Project or Process

Although different projects may have more or fewer risks than others, no project is completely free of risk. Projects are initiated so an organization can achieve a goal that delivers value in support of the organization's purpose. There are always uncertainties surrounding the project and the environment that can affect the success of achieving this goal. By always keeping in mind that risk is inherent and everywhere, SF practitioners seek ways to continuously make the right trade-off decisions between risk and opportunity and not to become too focused on minimizing risk to the exclusion of all else.

Proactive Risk Management Is Most Effective

SF adopts a proactive approach to identifying, analyzing, and addressing risk by focusing on the following:
Anticipate problems rather than just reacting to them when they occur.
Address root causes instead of just dealing with symptoms.
Have problem resolution plans ready ahead of time—before a problem occurs.
Use a known, structured, repeatable process for problem resolution.
Use preventative measures whenever possible.

Effective risk management is not achieved by simply reacting to problems. The team should work to identify risks in advance and to develop strategies and plans to manage them. Plans should be developed to correct problems if they occur. Anticipating potential problems and having well-formed plans in place ahead of time shortens the response time in a crisis and can limit or even reverse the damage caused by the occurrence of a problem.

The defining characteristics of proactive risk management are risk mitigation and risk impact reduction. Mitigation may occur at the level of a specific risk and target the underlying immediate cause, or it may be achieved by intervention at the root cause level (or anywhere in the intervening causal chain). Mitigation measures are best undertaken in the early stages of a project when the team still has the ability to intervene in time to effect project outcome.

Identification and correction of root causes has high value for the enterprise because corrective measures can have far-reaching positive effects well beyond the scope of an individual project. For example, absence of coding standards or machine naming conventions can clearly result in adverse consequences within a single development or deployment project and thus be a source of increased project risk. However, creation of standards and guidelines can have a positive effect on all projects performed within an enterprise when these standards and guidelines are implemented across the entire organization.

Treat Risk Identification as Positive

Effective risk management depends on correct and comprehensive understanding of the risks facing a project team. As the variety of challenges and the magnitude of potential losses becomes evident, risk activity can become a discouraging activity for the team. Some team members may even take the view that identifying risks is actually looking for reasons to undermine the success of a project. In contrast, SF adopts the perspective that the very process of risk identification allows the team to manage risks more effectively by bringing them out into the open, and thereby increases the prospects for success by the team. Open, documented discussion of risk frees team members to concentrate on their work by providing explicit clarification of roles, responsibilities, and plans for preventative activities and corrective measures for problems.

The team (and especially team leaders) should regard risk identification in a positive way to ensure contribution of as much information as possible about the risks it faces. A negative perception of risk causes team members to feel reluctant to communicate risks. The environment should be such that individuals identifying risks can do so without fear of retribution for honest expression of tentative or controversial views. Examples of negative risk environments are easy to find. For example, in some environments reporting new risks is viewed as a form of complaining. In this setting a person reporting a risk is viewed as a troublemaker and reaction to the risk is directed at the person rather than at the risk itself. People generally become wary of freely communicating risks under these circumstances and then begin to selectively present the risk information they decide to share to avoid confrontation with team members. Teams creating a positive risk management environment by actively rewarding team members who surface risks will be more successful at identifying and addressing risks earlier than those teams operating in a negative risk environment.

To achieve the goal of maximizing the positive gains for a project, the team should be willing to take risks. This requires viewing risks and uncertainty as a means to create the right opportunity for the team to achieve success.

Continuous Assessment

Many information technology professionals misperceive risk management as, at best, a necessary but boring task to be carried out at the beginning of a project or only at the introduction of a new process.

Continuing changes in project and operating environments require project teams to regularly re-assess the status of known risks and to re-evaluate or update the plans to prevent or respond to problems associated with these risks. Project teams should also be constantly looking for the emergence of new project risks. Risk management activities should be integrated into the overall project life cycle in such a way as to provide appropriate updating of the risk control plans and activities without creating a separate reporting and tracking infrastructure.

Maintain Open Communications

Although risks are generally known by some team members, this information is often poorly communicated. It is often easy to communicate information about risks down the organizational hierarchy, but difficult to pass information about risks up the hierarchy. At every level, people want to know about the risks from lower levels but are wary of upwardly communicating this information. Restricted information flow regarding risks is a potent contributor to project risk because it forces decision making about those risks with even less information. Within the hierarchical organization, managers need to encourage and exhibit open communications about risk and ensure that risks and risk plans are well understood by everyone.

Specify, then Manage

Risk management is concerned with decision making in the face of uncertainty. Generic statements of risk leave much of the uncertainty in place and encourage different interpretations of the risk. Clear statements of risk aid the team in:
Ensuring that all team members have the same understanding of the risk.
Understanding the cause or causes of the risk and the relationship to the problems that may arise.
Providing a basis for quantitative, formal analysis and planning efforts.
Building confidence by stakeholders and sponsors in the team's ability to manage the risk.

SF advocates that risk management planning be undertaken with attention to specific information to minimize execution errors in the risk plan that render preventative efforts ineffective or interfere with recovery and corrective efforts.

Don't Judge a Situation Simply by the Number of Risks

Although team members and important stakeholders often perceive risk items as negative, it is important not to judge a project or operational process simply on the number of communicated risks. Risk, after all, is the possibility, not the certainty of a loss or suboptimal outcome. The SF Risk Management Process advocates the use of a structured risk identification and analysis process to provide decision makers with not only information on the presence of risks but the importance of those risks as well.

Risk Management Planning

During the envisioning and planning phases of the SF process model, the team should develop and document how they plan to implement the risk management process within the context of the project. Questions to be answered with this plan include:
What are the assumptions and constraints for risk management?
How will the risk management process be implemented?
What are the steps in the process?
What are the activities, roles, responsibilities, and deliverables for each step?
Who will perform risk activities?
What are the skill requirements?
Is there any additional training?
How does risk management at the project relate to enterprise level efforts?
What kinds of tools or methods will be used?
What definitions are used to classify and estimate risk?
How will risks be prioritized?
How will contingency and risk plans be created and executed?
How will risk control activities be integrated into the overall project plan?
What activities will team members be doing to manage risk?
How will status be communicated among the team and project stakeholders?
How will progress be monitored?
What kind of infrastructure will be used (databases, tools, repositories) to support the risk management process?
What are the risks of risk management?
What resources are available for risk management?
What are the critical dates in the schedule for implementing risk management?
Who is the sponsor and who are the stakeholders?

Risk management planning activities should not be viewed in isolation from the standard project planning and scheduling activities, just as risk management tasks should not be viewed as being “in addition” to the tasks team members perform to complete a project. Because risks are inherent in all phases of all projects from start to finish, resources should be allocated and scheduled to actively manage risks. Risk management planning that is carried out by the team during the envisioning and planning phases of the SF Process Model, and the risk plan that documents those plans, should contribute defined action items assigned to specific team members within the work breakdown structure. These action items should appear on the project plan and master project schedule.

Exemplary Risk Management Process

Overview of the SF Risk Management Process

The SF Risk Management Discipline advocates proactive risk management, continuous risk assessment, and integration into decision-making throughout the project or operational life cycle. Risks are continuously assessed, monitored, and actively managed until they are either resolved or turn into problems to be handled.

FIG. 22 is a block diagram depicting an exemplary risk management process. The SF Risk Management Process depicted in FIG. 22 defines six logical steps through which the team manages current risks, plans and executes risk management strategies, and captures knowledge for the enterprise.

The six steps in the SF Risk Management Process are:
Identification
Analysis and Prioritization
Planning and Scheduling
Tracking and Reporting
Control
Learning

Risk Identification allows individuals to surface risks so that the team becomes aware of a potential problem. As the input to the risk management process, risk identification should be undertaken as early as possible and repeated frequently throughout the project life cycle.

Risk Analysis transforms the estimates or data about specific project risks that developed during risk identification into a form that the team can use to make decisions around prioritization. Risk Prioritization enables the team to commit project resources to manage the most important risks.

Risk Planning takes the information obtained from risk analysis and uses it to formulate strategies, plans, and actions. Risk Scheduling ensures that these plans are approved and then incorporated into the standard day-to-day project management process and infrastructure to ensure that risk management is carried out as part of the day-to-day activities of the team. Risk scheduling explicitly connects risk planning with project planning.

Risk Tracking monitors the status of specific risks and the progress in their respective action plans. Risk tracking also includes monitoring the probability, impact, exposure, and other measures of risk for changes that could alter priority or risk plans and project features, resources, or schedule. Risk tracking enables visibility of the risk management process within the project from the perspective of risk levels as opposed to the task completion perspective of the standard operational project management process. Risk Reporting ensures that the team, sponsor, and other stakeholders are aware of the status of project risks and the plans to manage them.

Risk Control is the process of executing risk action plans and their associated status reporting. Risk control also includes initiation of project change control requests when changes in risk status or risk plans could result in changes in project features, resources or schedule.

Risk Learning formalizes the lessons learned and relevant project artifacts and tools and captures that knowledge in reusable form for reuse within the team and by the enterprise.

It should be noted that these steps are logical steps and that they do not need to be followed in strict chronologic order for any given risk. Teams will often cycle iteratively through the identification-analysis-planning steps as they develop experience on the project for a class of risks and only periodically visit the learning step for capturing knowledge for the enterprise.

Furthermore, it should not be inferred from the diagram that all project risks pass through this sequence of steps in lock-step. Rather, the SF Risk Management Discipline advocates that each project define during the project planning phase of the SF process model when and how the risk management process will be initiated and under what circumstances transitions between the steps should occur for individual or groups of risks.

Identifying Risks

Introduction

Risk identification is the initial step in the SF Risk Management Process. Risks should be identified and stated clearly and unequivocally so that the team can come to consensus and move on to analysis and planning. During risk identification, the team focus should be deliberately expansive. Attention should be given to learning activity and directed toward seeking gaps in knowledge about the project and its environment that may adversely affect the project or limit its success.

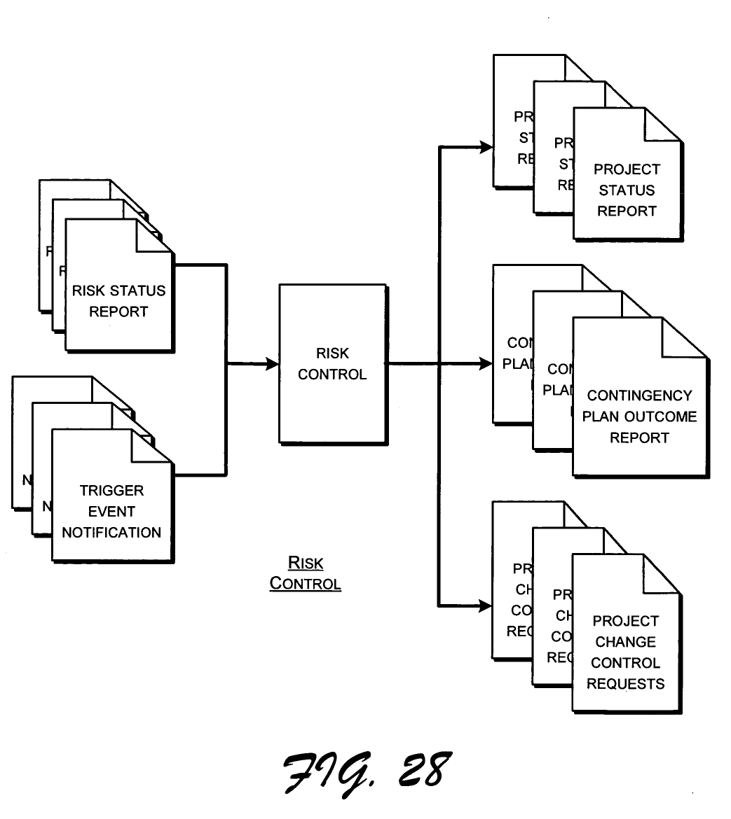

FIG. 23 is a block diagram depicting an exemplary risk identification paradigm that produces at least one or more risk statements. It graphically depicts the inputs, outputs, and activities for the risk identification step.

Goals

The goal of the risk identification step is for the team to create a list of the risks that they face. This list should be comprehensive, covering many if not all areas of the project.

Inputs

The inputs to the risk identification step are the available knowledge of general and project specific risk in relevant business, technical, organizational, and environmental areas. Additional considerations are the experience of the team, the current organizational approach toward risk in the forms of policies, guidelines, templates, and so forth, and information about the project as it is known at that time, including history and current state. The team may choose to draw upon other inputs-anything that the team considers relevant to risk identification should be considered.

At the start of a project, it is useful to use group brainstorming, facilitated sessions, or even formal workshops to collect information on project team and stakeholder perceptions on risks and opportunities. Industry classification schemes such as the SEI Software risk taxonomy, project checklists, previous project summary reports, and other published industry sources and guides may also be helpful in assisting the team in identifying relevant project risks.

Risk Identification Activities

During risk identification, the team seeks to create an unambiguous statement or list of risks articulating the risks that they face. At the start of the project it is easy to organize a workshop or brainstorming session to identify the risks associated with a new situation. Unfortunately many organizations regard this as a one-time activity, and never repeat the activity during the project or operations life cycle. SF Risk Management Discipline emphasizes that risk identification should be undertaken at periodic intervals during a project.

Risk identification can be schedule-driven (for example, daily, weekly, or monthly), milestone-driven (associated with a planned milestone in the project plan), or event-triggered (forced by significant disruptive events in the business, technology, organizational or environmental settings). Risk identification activities should be undertaken at intervals and with scope determined by each project team. For example, a team may complete a global risk identification session together at major milestones of a large development project, but may choose in addition to have individual feature teams or even individual developers repeat risk identification for their areas of responsibility at interim milestones or even on a weekly scheduled basis.

During the initial risk identification step in a project, interaction between team members and stakeholders is very important as it is a powerful way to expose assumptions and differing viewpoints. For this reason, SF Risk Management Discipline advocates involvement of as wide a group of interests, skills, and backgrounds from the team as is possible during risk identification.

Risk identification also may also involve research by the team or involvement of subject matter experts to learn more about the risks within the project domain.

Structured Approach

SF advocates the use of a structured approach toward risk management where possible. For software development and deployment projects, use of risk classification during the risk identification step is a helpful way to provide a consistent, reproducible, measurable approach. Risk classification provides a basis for standardized risk terminology needed for reporting and tracking and is critical in creating and maintaining enterprise or industry risk knowledge bases. Within the risk identification step, risk classification lists help the team be comprehensive in their thinking about project risk by providing a ready-made, list of project areas to consider from a risk perspective that is derived from previous similar projects or industry experience. Risk statement formulation is the main technique used within SF for evaluating a specific project and for guiding prioritization and development of specific risk plans.

Risk classification

Risk classifications, or risk categories, sometimes called risk taxonomies, serve multiple purposes for a project team. During risk identification they can be used to stimulate thinking about risks arising within different areas of the project. During brainstorming risk classifications can also ease the complexities of working with large numbers of risks by providing a convenient way for grouping similar risks together. Risk classifications also may be used to provide a common terminology for the team to use to monitor and report risk status throughout the project. Finally, risk classifications are critical for establishing working industry and enterprise risk knowledge bases because they provide the basis for indexing new contributions and searching and retrieving existing work.

The following table illustrates an exemplary high-level classification for sources of project risk.

People
Customers
End-users
Sponsors
Stakeholders
Personnel
Organization
Skills
Politics
Morale
Process
Mission and goals
Decision making
Project characteristics
Budget, cost, schedule
Requirements
Design
Building
Testing
Technology
Security
Development and test environment
Tools
Deployment
Support
People
Operational environment
Availability
Environmental
Legal
Regulatory
Competition
Economic
Technology
Business

There are many taxonomies or classifications for general software development project risk. Well-known and frequently-cited classifications that describe the sources of software development project risk include Barry Boehm, Caper Jones, and the SEI Software Risk Taxonomy. Lists of risk areas covering limited project areas in greater detail are also available. For example, schedule risk is a common area for project teams.

Different kinds of projects (e.g., infrastructure or packaged application deployment), projects carried out with specialized technology domains (such as security, embedded systems, safety critical, EDI), vertical industries (healthcare, manufacturing, and so on.) or product-specific projects may carry well-known project risks unique to that area. Within the area of information security, risks concerning information theft, loss, or corruption as a result of deliberate acts or accidents are often referred to as threats. Projects in these areas will benefit from the review of alternative risk (threat) classifications or extensions to the well-known general purpose risk classifications to ensure breadth of thinking on the part of the project team during the risk identification step.

Other sources for project risk information include industry project risk databases such as the Software Engineering Information Repository (SEIR) or internal enterprise risk knowledge bases.

Risk Statements

FIG. 24 is a block diagram of an exemplary risk statement. A risk statement is a natural language expression expressing a causal relationship between a real, existing project state of affairs or attribute, and a potential, unrealized second project event, state of affairs or attribute. The first part of the risk statement is called the condition and it provides the description of an existing project state of affairs or attribute that the team feels may result causally in a project loss or reduction in gain. The second part of the risk statement is a second natural language statement called the consequence that describes the undesirable project attribute or state of affairs. The two statement are linked by a term such as “therefore” or “and as a result” that implies an uncertain (in other words, less than 100%) but causal relationship. Along with a schematic depiction, an example is provided in FIG. 24.

The two-part formulation process for risk statements has the advantage of coupling the risk consequences with observable (and potentially controllable) risk conditions within the project early in the risk identification stage. Use of alternative approaches where the team focuses only on identification of risk conditions within the project during the risk identification stage usually requires that the team backup to recall the risk condition later on in the risk management process when they develop management strategies.

Note that risk statements are not actually “if-then” statements, but rather statements of fact exploring the possible but unrealized consequences. During the analysis and planning steps considering hypothetical “if-then” statements may be helpful in weighing alternatives and formulating plans using decision trees. However, during risk identification, the goal is to identify as many risks as possible deferring what-if analysis for the planning phase. Early in the project there should be an abundance of risk statements with conditions that describe the team's lack of knowledge, such as “we do not yet know about X, therefore . . . . ”

When formulating a risk statement, the team should consider both the cause of the potential, unrealized less desirable outcome as well as the outcome itself. The risk statement includes the observed state of affairs (condition) within the project as well as the observable state of affairs that might occur (consequence). As part of a thorough risk analysis, team members should look for similarities and natural groupings of the conditions of project risk statements and backtrack up the causal chain for each condition seeking a common underlying root cause. It is also valuable to follow the causal chain downstream from the condition-consequence pair in the risk statement to examine effects on the organization and environment outside the project to gain a better appreciation for the total losses or missed opportunities associated with a specific project condition.

During risk identification it is not uncommon for the team to identify multiple consequences for the same condition. Sometimes a risk consequence identified in one area of the project may become a risk condition in another. These situations should be recorded by the team so that appropriate decisions can be made during risk analysis and planning to take into account causal dependencies and interactions among the risks. Depending on the relationships among risks, closing one risk may close a whole group of dependent risks and change the overall risk profile for the project. Documenting these relationships early during the risk identification stage can provide useful information for guiding risk planning that is flexible, comprehensive, and which uses available project resources efficiently by addressing root or predecessor causes. The benefits of capturing such additional information at the identification step should be balanced against rapidly moving through the subsequent analysis and prioritization and then re-examining the dependencies and root causes during the planning phase for the most important risks.

Outputs

The minimum output from the risk identification activities is a clear, unambiguous, consensus statement of the risks being faced by the team, recorded as a risk list. If the risk condition-consequence approach is used as described within the publications from the SEI, NASA and earlier versions of SF, then the output will be a collection of risk statements articulating the risks that the project team has identified within the project. The risk list in tabular form is the main input for the next stage of the Risk management process-analysis. The risk identification step frequently generates a large amount of other useful information, including the identification of root causes and downstream effects, affected parties, owner, and so forth.

SF Risk Management Discipline recommends that a tabular record of the risk statements and the root cause and downstream effect information developed by the team should be created. Additional information for classifying the risks (by project area or attribute) may also be helpful when using project risk information to build or use an enterprise risk knowledge base when a well-defined taxonomy exists. Other helpful information may be recorded in the risk list to define the context of the risk to assist other members of the team, external reviewers or stakeholders in understanding the intent of the team in surfacing a risk. Risk context information that some project teams may choose to record during risk identification to capture team intent includes:
Conditions
Constraints
Circumstances
Assumptions
Contributing factors
Dependencies among risks
Related issues
Business asset owner
Team concerns

The tabular risk list (with or without conditions, root causes, downstream effects or context information) will become the master risk list used during the subsequent risk management process steps. An example of a new master risk list is depicted in the following table.

| | | | Downstream |
|---|---|---|---|
| Root Cause | Condition | Consequence | effect |
| Inadequate | The roles of | We may ship | Reduced |
| staffing | development and | with more bugs | customer |
| | testing have been | | satisfaction |
| | combined | | |
| Technology | Our developers | Development | We get to the |
| change | are working with | time will be | market later and |
| | a new | longer | lose market share |
| | programming | | to competitors |
| | language | | |
| Organization | the development | Communication | Delays in product |
| | team is divided | among the team | shipment with |
| | between London | will be difficult | additional rework |
| | and Los Angeles | | |

Analyzing and Prioritizing Risks

Introduction

Risk analysis and prioritization is the second step in the SF Risk Management process (of FIG. 22). Risk analysis involves conversion of risk data into a form that facilitates decision-making. Risk prioritization ensures that the team members address the most important project risks first.

During this step, the team examines the list of risk items produced in the risk identification step and prioritizes them for action, recording this order in the master risk list.

FIG. 25 is a block diagram depicting an exemplary risk analysis and prioritization paradigm that produces at least a prioritized risk list, deactivated risks, and one or more risk statement forms. From the master risk list, the team can determine a list of “top risks” for which they will commit resources for planning and executing a specific strategy. The team can also identify which risks, if any, are of such low priority for action that they may be dropped from the list. As the project moves toward completion and as project circumstances change, risk identification and risk analysis will be repeated and changes made to the master risk list. New risks may appear and old risks that no longer carry a sufficiently high priority may be removed or “deactivated.” These described inputs and outputs are depicted in FIG. 25.

Goal

The chief goal of the risk analysis step is to prioritize the items on the risk list and determine which of these risks warrant commitment of resources for planning.

Inputs

During the risk analysis step the team will draw upon its own experience and information derived from other relevant sources regarding the risks statements produced during risk identification. Relevant information to assist the transformation of the raw risk statements into a prioritized master risk list may be obtained from the organization's risk policies and guidelines, industry risk databases, simulations, analytic models, business unit managers, and domain experts among others.

Risk Analysis Activities

Many qualitative and quantitative techniques exist for accomplishing prioritization of a risk list. One easy-to-use technique for risk analysis is to use consensus team estimates of two widely accepted components of risk, probability, and impact. These quantities can then be multiplied together to calculate a single metric called risk exposure.

Risk Probability

Risk probability is a measure of the likelihood that the state of affairs described in the risk consequence portion of the risk statement will actually occur. Using a numerical value for risk probability is desirable for ranking risks. Risk probability should be greater than zero, or the risk does not pose a threat. Likewise, the probability should be less than 100 percent or the risk is a certainty—in other words, it is a known problem. Probabilities are notoriously difficult for individuals to estimate and apply, although industry or enterprise risk databases may be helpful in providing known probability estimates based on samples of large numbers of projects.

Most project teams, however, can verbalize their experience, interpret industry reports, and provide a spectrum of natural language terms that map back to numeric probability ranges. This may be as simple as mapping “low-medium-high” to discrete probability values (17%, 50%, 84%) or as complex as mapping different natural language terms, such as “highly unlikely,” “improbable,” “likely,” “almost certainly,” etc. expressing uncertainty against probabilities. The following table demonstrates an example of a three-value division for probabilities. The next table demonstrates a seven-value division for probabilities.

| | Probability | Natural | |
|---|---|---|---|
| Probability | value used for | language | |
| range | calculations | expression | Numeric score |
| 1% through 33% | 17% | Low | 1 |
| 34% through 67% | 50% | Medium | 2 |
| 68% through 99% | 84% | High | 3 |
| 1% through 14% | 7% | Extremely unlikely | 1 |
| 15% through 28% | 21% | Low | 2 |
| 28% through 42% | 35% | Probably not | 3 |
| 43% through 57% | 50% | 50-50 | 4 |
| 58% through 72% | 65% | Probably | 5 |
| 73% through 86% | 79% | High likelihood | 6 |
| 87% through 99% | 93% | Almost certainly | 7 |

It should be noted that the probability value used for calculation represents the midpoint of a range. With the aid of these mapping tables, an alternative method for quantifying probability is to map the probability range or natural language expression agreed upon by the team to a numeric score. When using a numeric score to represent risk, it is beneficial to use the same numeric score for all risks for the prioritization process to work.

Regardless of the technique used for quantifying uncertainty, the team also develops an approach for deriving a single value for risk probability that represents their consensus view regarding each risk.

Risk Impact

Risk impact is an estimate of the severity of adverse effects, or the magnitude of a loss, or the potential opportunity cost should a risk be realized within a project. It should be a direct measure of the risk consequence as defined in the risk statement. It can either be measured in financial terms or with a subjective measurement scale. If all risk impacts can be expressed in financial terms, use of financial value to quantify the magnitude of loss or opportunity cost has the advantage of being familiar to business sponsors. The financial impact might be long-term costs in operations and support, loss of market share, short-term costs in additional work, or opportunity cost.

In other situations a subjective scale from 1 to 5 or 1 to 10 is more appropriate for measuring impact. As long as all risks within a master risk list use the same units of measurement, simple prioritization techniques will work. It is helpful to create translation tables relating specific units such as time or money into values that can be compared to the subjective units used elsewhere in the analysis, as illustrated in the following table. This approach provides a highly adaptable metric for comparing the impacts of different risks across multiple projects at an enterprise level.

The particular example map in the table below is a logarithmic transformation where the score is roughly equal to the log₁₀($loss)-1. High values indicate serious loss. Medium values show partial loss or reduced effectiveness. Low values indicate small or trivial losses.

| Score | Monetary Loss |
|---|---|
| 1 | Under $100 |
| 2 | $100-$1000 |
| 3 | $1000-$10,000 |
| 4 | $10,000-$100,000 |
| 5 | $100,000-$1,000,000 |
| 6 | $1,000,000-$10 million |
| 7 | $10 million-$100 million |
| 8 | $100 million-$1 billion |
| 9 | $1 billion-$10 billion |
| 10 | Over $10 billion |

When monetary losses cannot be easily calculated the team may choose to develop alternative scoring scales for impact that capture the appropriate project areas. Hall (1998) provides the example in the next table.

| Criterion | Cost overrun | Schedule | Technical |
|---|---|---|---|
| Low | Less than 1% | Slip 1 week | Slight effect on |
| | | | performance |
| Medium | Less than 5% | Slip 2 weeks | Moderate effect on |
| | | | performance |
| High | Less than 10% | Slip 1 month | Severe effect on |
| | | | performance |
| Critical | 10% or more | Slip more than 1 | Mission cannot be |
| | | month | accomplished |

The scoring system selected for estimating impact should reflect the team and organization's values and policies. A $10,000 monetary loss which is tolerable for one team or organization may be unacceptable for another. Use of a catastrophic impact scored where an artificially high value such as 100 is assigned will ensure that a risk with even a very low probability will rise to the top of the risk list and remain there.

Risk Exposure

Risk exposure measures the overall threat of the risk, combining information expressing the likelihood of actual loss with information expressing the magnitude of the potential loss into a single numeric estimate. The team can then use the magnitude of risk exposure to rank risks. In a relatively simple form of quantitative risk analysis, risk exposure is calculated by multiplying risk probability and impact.

When scores are used to quantify probability and impact, it is sometimes convenient to create a matrix that considers the possible combinations of scores and assigns them to low risk, medium risk, and high risk categories. For the use of tripartite probability score where 1 is low and 3 is high, the possible results may be expressed in the form of a table where each cell is a possible value for risk exposure. In this case it is easy to classify risks as low, medium, and high depending on their position within the diagonal bands of increasing score.

| Probability | | | |
|---|---|---|---|
| impact | Low = 1 | Medium = 2 | High = 3 |
| High = 3 | 3 | 6 | 9 |
| Medium = 2 | 2 | 4 | 6 |
| Low = 1 | 1 | 2 | 3 |

Low exposure=1 or 2
Medium exposure=3 or 4
High exposure=6 or 9

The advantage of this tabular format is that it allows risk levels to be included within status reports for sponsors and stakeholders using colors (e.g., red for the high risk zone in the upper right corner, green for low risk in the lower left corner, and yellow for medium levels of risk along the diagonal) and easy-to-understand, yet well-defined terminology (“high risk” is easier to comprehend than “high exposure”).

Additional Quantitative Techniques

Since the goal of risk analysis is to prioritize the risks on the risk list and to drive decision-making regarding commitment of project resources toward risk control, it should be noted that each project team should select a method for prioritizing risks that is appropriate to the project, the team, the stakeholders, and the risk management infrastructure (tools and processes). Some projects may benefit from use of weighted multi-attribute techniques to factor in other components that the team wishes to consider in the ranking process such as required timeframe, magnitude of potential opportunity gain, or reliability of probability estimates and physical or information asset valuation.

An example of a weighted prioritization matrix that factors in not only probability and impact, but critical time window and cost to implement an effective control is shown in the following table, where the formula for the ranking value is calculated using the formula:
Ranking value=0.5(probability×impact)−0.2(when needed)+0.3(control cost x probability control will work).

| | | | | Cost to | Likelihood |
|---|---|---|---|---|---|
| | | Impact | When | implement | of |
| Ranking | | (thousands | needed | (thousands | control |
| value | Probability | of dollars) | (weeks) | of dollars) | working |
| 125.025 | 0.5 | 500 | 1 | 2 | 0.5 |
| 83.596 | 0.84 | 200 | 4 | 4 | 0.33 |
| 37.64 | 0.33 | 200 | 2 | 20 | 0.84 |
| 4.9816 | 0.33 | 30 | 4 | 3 | 0.84 |

This method allows a team to factor in risk exposure, schedule criticality (when a risk control or mitigation plan should be completed to be effective), and incorporate the cost and efficacy of the plan into the decision-making process. This general approach enables a team to rank risks in terms of the contribution toward any goals that they have set for the project and provides a foundation for evaluating risks both from the perspective of losses (impact) and from opportunities (positive gains).

Selecting the “right” risk analysis method or combination of methods depends on making the right trade-off decision between expending effort on risk analysis or making an incorrect or indefensible (to stakeholders) prioritization choice. Risk analysis should be undertaken to support prioritization that drives decision making, and should not become analysis for the sake of analysis. The results from quantitative or semi-quantitative approaches to risk prioritization should be evaluated within the context of business goals, opportunities, and sound management practices and should not be considered an automated form of decision making by itself.

Outputs

Risk analysis provides the team with a prioritized risk list to guide the team in risk planning activities. Within SF Risk Management Discipline, this is called the master Risk list. Detailed risk information including project condition, context, root cause, and the metrics used for prioritization (e.g., probability, impact, exposure) are often recorded for each risk in the risk statement form.

Master Risk List

SF Risk Discipline refers to the list of risks as the master risk list. In tabular form, the master risk list identifies the project condition causing the risk, the potential adverse effect (consequence), and the criterion or information used for ranking, such as probability, impact, and exposure. When sorted by the ranking critertion level (high-to-low), the master risk list provides a basis for prioritization in the planning process.

An example master risk list using the two-factor (probability and impact) estimate approach is shown in the following table.

| | | | Prob- | | |
|---|---|---|---|---|---|
| Priority | Condition | Consequence | ability | Impact | Exposure |
| 1 | Long project | Loss of funding | 80% | 3 | 2.4 |
| | schedule | at end of year | | | |
| 2 | No coding | Ship with | 45% | 2 | 0.9 |
| | standards | more bugs | | | |
| | for new | | | | |
| | programming | | | | |
| | language | | | | |
| 3 | No written | Some product | 30% | 2 | 0.6 |
| | requirements | features | | | |
| | specification | will not be | | | |
| | | implemented | | | |

Low impact=1, medium impact=2, high impact=3 Exposure=Probability×Impact

The master risk list is the compilation of all risk assessment information at an individual project list level of detail. It is a living document that forms the basis for the ongoing risk management process and should be kept up-to-date throughout the cycle of risk analysis, planning, and monitoring.

The master risk list is the fundamental document for supporting active or proactive risk management. It enables team decision making by providing a basis for:
Prioritizing effort
Identifying critical actions
Highlighting dependencies

A list of items that may be maintained in the master risk list is included in the next table. The method that is used to calculate the exposure rendered by a risk should be documented carefully in the risk management plan and care should be taken to ensure that the calculations accurately capture the intentions of the team in weighing the importance of the different factors.

| Item | Purpose | Status |
|---|---|---|
| Risk Statement | Clearly articulate a risk | Required |
| Probability | Quantify likelihood of | Required |
| | occurrence | |
| Impact | Quantify severity of | Required |
| | loss or magnitude of | |
| | opportunity cost | |
| Ranking criterion | Single measure of | Required |
| | importance | |
| Priority (rank) | Prioritize actions | Required |
| Owner | Ensure follow through | Required |
| | on risk action plans | |
| Mitigation Plan | Describe preventative | Required |
| | measures | |
| Contingency plan and | Describe corrective | Required |
| triggers | measures | |
| Root cause | Guide effective | Optional |
| | intervention planning | |
| Downstream effect | Ensure appropriate | Optional |
| | impact estimates | |
| Context | Document background | Optional |
| | information to capture | |
| | intent of team in | |
| | surfacing risk | |
| Time to implementation | Capture importance that | Optional |
| | risk controls be | |
| | implemented within a | |
| | certain timeframe | |

Additional Analysis Methods

Some teams may choose to perform additional levels of analysis to clarify their understanding of project risk. Additional techniques that can be performed by the team to provide additional clarification of project risk are discussed in standard project management and risk management textbooks. Techniques such as decision tree analysis, causal analysis, Pareto analysis, simulation, and sensitivity analysis have all been used to provide a richer quantitative understanding of project risk. The decision to use these tools should be based on the value that the team feels that they bring in either driving prioritization or in clarifying the planning process to offset the resource cost.

Risk Statement Forms

When analyzing each individual project risk or during risk planning activities related to a specific risk, it is convenient to view all of the information on that risk from a single data structure, called the risk statement form.

The risk statement form typically contains the fields from the master risk list created during identification and assessment and may be augmented with additional information needed by the team during the risk management process. When risks will be assigned follow-up action by a separate team or by specific individuals, it is sometimes easier to treat it as a separate data structure from the master risk list.

Exemplary information the team can consider when developing a risk statement form is listed in the following table.

| Item | Purpose |
|---|---|
| Risk Identifier | The name the team uses to identify a risk uniquely for |
| | reporting and tracking purposes. |
| Risk Source | A broad classification of the underlying area from which |
| | the risk originates, used to identify areas where recurrent |
| | root causes of risks should be sought. |
| Risk Condition | A phrase describing the existing condition that might |
| | lead to a loss. This forms the first part of a risk |
| | statement. |
| Risk | A phrase describing the loss that would occur if the risk |
| Consequence | became certain. This forms the second part of a risk |
| | statement. |
| Risk | A probability greater than zero and less than 100 percent |
| probability | that represents the likelihood that the risk condition will |
| | actually occur, resulting in a loss. |
| Risk Impact | A broad classification of the type of impact a risk might |
| Classification | produce. |
| Risk Impact | The magnitude of impact should the risk actually occur. |
| | This number could be the dollar value of a loss or simply |
| | a number between 1 and 10 that indicates relative |
| | magnitude |
| Risk Exposure | The overall threat of the risk, balancing the likelihood of |
| | actual loss with the magnitude of the potential loss. The |
| | team uses risk exposure to rate and rank risks. Exposure |
| | is calculated by multiplying risk probability and impact |
| Risk Context | A paragraph containing additional background |
| | information that helps to clarify the risk situation. |
| Related Risks | A list of risk identifiers the team uses to track |
| | interdependent risks |

Top Risks List

Risk analysis weighs the threat of each risk to help the team decide which risks merit action. Managing risks takes time and effort away from other activities, so it is important for the team reduce if not minimize the effort applied to manage them.

A simple but effective technique for monitoring risk is a top risks list of the major risk items. The top risks list is externally visible to all stakeholders and can be included in the critical reporting data structures, such as the vision/scope data structure, project plan, and project status reports.

Typically, a team will identify a limited number of major risks that should be managed (usually 10 or fewer for most projects) and allocate project resources to address them. Even where the team will eventually want to manage more then the top 10 risks, it is often more effective to concentrate effort on a small number of the greatest risks first and then to move to the less critical risks once the first group is under control.

After ranking the risks, the team should focus on a risk management strategy and how to incorporate the risk action plans into the overall plan.

Deactivating Risks

Risks may be deactivated or classified as inactive so that the team can concentrate on those risks that require active management. Classifying a risk as inactive means that the team has decided that it is not worth the effort needed to track that risk. The decision to deactivate a risk is taken during risk analysis.

Some risks are deactivated because their probability is effectively zero and likely to remain so, i.e., they have extremely unlikely conditions. Other risks are deactivated because their impact is below the threshold where it's worth the effort of planning a mitigation or contingency strategy; it's simply more cost-effective to suffer the impact if the risk arises. Note that is not advisable to deactivate risks above this impact threshold even if their exposure is low, unless the team is confident that the probability (and hence the exposure) will remain low in all foreseeable circumstances. Also note that deactivating a risk is not the same as resolving one; a deactivated risk might reappear under certain conditions and the team may choose to reclassify the risk as active and initiate risk management activities.

Risk Planning and Scheduling

Introduction

Risk planning and scheduling is the third step in the risk management process (of FIG. 22). The planning activities carried out by the team translate the prioritized risk list into action plans. Planning involves developing detailed strategies and actions for each of the top risks, prioritizing risk actions, and creating an integrated risk management plan. Scheduling involves the integration of the tasks required to implement the risk action plans into the project schedule by assigning them to individuals and actively tracking their status.

FIG. 26 is a block diagram depicting an exemplary risk planning and scheduling paradigm that produces at least an updated risk list, updated project plans and schedules, and one or more risk action forms. It is a schematic depiction that includes an associated top risks list with the updated risk list. The master risk list is updated with additional information for the top risks identified during risk analysis. Sometimes it is convenient to present those parts of the master risk list used during planning as a separate risk action form for use by team members who have been assigned risk action items.

Goals

The main goal of the risk planning and scheduling step is to develop detailed plans for controlling the top risks identified during risk analysis and to integrate them with the standard project management processes to ensure that they are completed.

Inputs

SF Risk Management Discipline advocates that risk planning be tightly integrated into the standard project planning processes and infrastructure. Inputs to the Risk planning process includes not only the master risk list, top risks list, and information from the risk management knowledge base, but also the project plans and schedules (as shown in FIG. 26).

Planning Activities

When developing plans for reducing risk exposure, the following actions may be implemented:
Focus on high-exposure risks.
Address the condition to reduce the probability.
Look for root causes as opposed to symptoms.
Address the consequences to minimize the impact.
Determine the root cause, then look for similar situations in other areas that may arise from the same cause.
Be aware of dependencies and interactions among risks.

Several exemplary approaches are possible to reduce risk:
For those risks the team can control, apply the resources needed to reduce the risk.
For those risks outside the control of the team, find a work-around or transfer (escalate) the risk to individuals that have the authority to intervene.

During risk action planning, the team may consider any of the following exemplary six alternatives when formulating risk action plans.
Research. Do we know enough about this risk? Do we need to study the risk further to acquire more information and better determine the characteristics of the risk before we can decide what action to take?
Accept. Can we live with the consequences if the risk were actually to occur? Can we accept the risk and take no further action?
Avoid. Can we avoid the risk by changing the scope?
Transfer. Can we avoid the risk by transferring it to another project, team, organization or individual?
Mitigation. Can the team do anything to reduce the probability or impact of the risk?
Contingency. Can the impact be reduced through a planned reaction?

Research

Much of the risk that is present in projects is related to the uncertainties surrounding incomplete information. Risks that are related to lack of knowledge may often be resolved or managed most effectively by learning more about the domain before proceeding. For example, a team may choose to pursue market research or conduct user focus groups to learn more about user baseline skills or willingness to use a given technology before completing the project plan. If the decision by the team is to perform research, then the risk plan should include an appropriate research proposal including hypotheses to be tested or questions to be answered, staffing, and any needed laboratory equipment.

Accept

Some risks are such that it is simply not feasible to intervene with effective preventative or corrective measures, but the team elects to simply accept the risk in order to realize the opportunity. Acceptance is not a “do-nothing” strategy and the plan should include development of a documented rationale for why the team has elected to accept the risk but not develop mitigation or contingency plans. It is prudent to continue monitoring such risks through the project life cycle in the event that changes occur in probability, impact or the ability to execute preventative or contingency measures related to this risk. These ongoing commitments to monitor or watch a risk should have appropriate resources committed and tracking metrics established within the overall project management process.

Avoid

On occasion, a risk will be identified that can be most easily controlled by changing the scope of the project in such a fashion as to eliminate the risk all together. The risk plan should then include documentation of the rationale for the change, and the project plan should be updated and any needed design change or scope change processes initiated.

Transfer

Sometimes it is possible for a risk to be transferred so that it may be managed by another entity outside of the project. Examples where risk is transferred include:
Insurance
Using external consultants with greater expertise
Purchasing a component instead of building it
Outsourcing services

Risk transfer does not mean risk elimination. In general a risk transfer strategy will generate risks that still requirement proactive management, but reduce the level of risk to an acceptable level. For instance, using an external consultant may transfer technical risks outside of the team, but may introduce risks in the project management and budget areas.

Mitigation

Risk mitigation planning involves actions and activities performed ahead of time to either prevent a risk from occurring altogether or to reduce the impact or consequences of its occurring to an acceptable level. Risk mitigation differs from risk avoidance because mitigation focuses on prevention and minimization of risk to acceptable levels, whereas risk avoidance changes the scope of a project to remove activities having unacceptable risk.

The main goal of risk mitigation is to reduce the probability of occurrence. For example, using redundant network connections to the Internet reduces the probability of losing access by eliminating the single point of failure.

Not every project risk has a reasonable and cost-effective mitigation strategy. In cases where a mitigation strategy is not available, it is essential to consider effective contingency planning instead.

Contingency Planning

Risk contingency planning involves creation of one or more fallback plans that can be activated in case efforts to prevent the adverse event fail. Contingency plans are necessary for all risks, including those that have mitigation plans. They address what to do if the risk occurs and focus on the consequence and how to minimize its impact. To be effective, the team should make contingency plans well in advance. Often the team can establish trigger values for the contingency plan based on the type of risk or the type of impact that will be encountered.

There are two types of contingency triggers:
Point-in-time triggers are built around dates, generally the latest date by which something has to happen.
Threshold triggers rely on things that can be measured or counted.

It is important for the team to agree on contingency triggers and their values with the appropriate managers as early as possible so that there is no delay committing budgets or resources needed to carry out the contingency plan.

Scheduling Activities

Scheduling risk management and control activities does not differ from the standard approach recommended by SF toward scheduling project activities in general. It is important that the team understand that risk control activities are an expected part of the project and not an additional set of responsibilities to be done on a voluntary basis. All risk activities should be accounted for within the project scheduling and status reporting process.

Outputs

The output from the risk action planning should include specific risk action plans implementing one of the six approaches discussed above at a step-by-step level of detail. The tasks to implement these plans should be integrated into the standard project plans and schedules. This includes adjustments in committed resources, schedule, and feature set, resulting in a set of risk action items specifying individual tasks to be completed by team members. The master risk list should be updated to reflect the additional information included in the mitigation and contingency plans. It is convenient to summarize the risk management plans into a single data structure.

Risk Action Items

Risk action items are logged in the team's normal project activity-tracking system so that they are regarded as just as important as any other actions.

Like properly documented actions in general, they should be associated with a due date for completion and a personnel assignment, so there is no confusion over who is responsible for their completion.

Risk Action Forms

The team should develop additional planning information for each risk in the top risk list to document the mitigation and contingency plans, triggers, and actions in detail. Information the team might consider when developing a risk action form or data structure includes the following:
Risk Identifier. The name the team uses to identify a risk uniquely for reporting and tracking purposes.
Risk Statement. A natural language statement describing the condition that might lead to a loss and the loss that would occur if the risk were to become certain.
Risk Mitigation Strategy. A paragraph or two of text describing the team strategy for mitigating a specific risk, including any assumptions that have been made.
Risk Mitigation Strategy Metrics. The metrics the team will use to determine whether the planned risk mitigation actions are achieving the desired results.
Risk Action Items. A list of actions the team is taking to implement the strategy for a specific risk, including the due date for completion and the person responsible.
Risk Contingency Strategy. A paragraph or two describing the team strategy in the event that the actions planned to manage the risk don't work. The team would execute the risk contingency strategy if the risk contingency trigger were reached.
Contingency Trigger Values. Contingency triggers are the criteria that teams use to determine when to execute contingency plans.
Risk Contingency Strategy Metrics. The metrics used by the team to determine if the contingency strategy is working.
Risk Plan Responsibility. The team role and individual(s) that hold responsibility for implementing the risk action plan.

Updated Project Schedule and Project Plan

Planning data structures related to risk should be integrated into the overall project planning data structures and the master project schedule updated with the new tasks generated by the plans.

Risk Tracking and Reporting

Risk tracking is the fourth step in the SF Risk Management Process (of FIG. 22). Risk tracking is essential to implementing action plans effectively. It ensures that assigned tasks implementing preventative measures or contingency plans are completed in a timely fashion within project resource constraints. During risk tracking the principal activity performed by the team is monitoring the risk metrics and triggering events to ensure that the planned risk actions are working.

FIG. 27 is a block diagram depicting an exemplary risk tracking and reporting paradigm that produces at least a risk status report and a trigger event notification. Tracking is the monitoring function of the risk action plan.

Goals

The goals of the risk tracking step are to monitor the status of the risk action plans (progress toward completion of contingency and mitigation plans), to monitor project metrics that have been associated with a contingency plan trigger, and to provide notification to the project team that contingency plan triggers have been exceeded so that a contingency plan can be initiated.

Inputs

The principal inputs to the risk tracking step are:
The risk action forms that contain the specific mitigation and contingency plans and which specify the project metrics and trigger values to be monitored.
The relevant project status reports that are used to track progress within the standard project management infrastructure.

Depending on the specific project metrics being tracked by the team, other sources of information such as project tracking databases, source code repositories or check-in systems, or even human resources management systems may provide tracking data for the project team.

Tracking Activities

During the risk tracking step the team executes the actions in the mitigation plan as part of the overall team activity. Progress toward these risk-related action items and relevant changes in the trigger values are captured and used to create the specific risk status reports for each risk.

Examples of project metrics that might be assigned trigger metrics and continuously tracked include:
Unresolved (open bugs) per module or component.
Average overtime hours logged per week per developer.
Number of requirement revisions (changes) per week.

Risk Status Reporting

Risk reporting should operate at two levels. For the team itself, regular risk status reports should consider four possible risk management situations for each risk:
A risk is resolved, completing the risk action plan.
Risk actions are consistent with the risk management plan, in which case the risk plan actions continue as planned.
Some risk actions are at variance to the risk management plan, in which case corrective measures should be defined and implemented.
The situation has changed significantly with respect to one or more risks and will usually involve re-analyzing the risks or re-planning an activity.

For external reporting to the project stakeholders, the team should report the top risks and then summarize the status of risk management actions. It is also useful to show the previous ranking of risks and the number of times each risk has been in the top risk list. As the project team takes actions to manage risks, the total risk exposure for the project should begin to approach acceptable levels.

Outputs

The purpose of the risk status report is to communicate changes in the status of the risk and report progress for mitigation plans. Information that is useful in the risk status report includes:
Risk name
Risk classification (project area)
Probability, Impact, and Exposure at identification
Current Probability, Impact, and Exposure
Risk level (low, medium, high)
Summary of mitigation and contingency plan(s)
Status toward completion of mitigation plans (completed actions)
Readiness of contingency plans
Trigger values
Planned actions
Risk owner

The purpose of an executive or stakeholder risk status report is to communicate the overall risk status of the project. Useful information to include in this report includes:
Project name
Risk level by project area
Risk trend
Summary of mitigation and contingency plan activity

This report may be included within the standard project status report, for example.

Risk Control

The fifth step in the SF Risk Management Process (of FIG. 22) is risk control. During this step the team is actively performing activities related to contingency plans because triggers have been reached. This step is depicted in FIG. 28.

FIG. 28 is a block diagram depicting an exemplary risk control paradigm that produces at least a project status report, a contingency plan outcome report, and one or more project change control requests.

Corrective actions are initiated based on the information gained from risk tracking. SF Risk Management Discipline uses standard project management processes and infrastructure to:
Control risk action plans.
Correct for variations from plans.
Respond to triggering events.

The results and lessons learned from execution of contingency plans are then incorporated into a contingency plan status and outcome report so that the information will become part of the project and enterprise risk knowledge base. It is beneficial to capture as much information as is possible about problems when they incur or about a contingency plan when it is invoked to determine the efficacy of such a plan or strategy on risk control.

Goals

The goal of the risk control step is successful execution of the contingency plans that the project team has created for top risks.

Inputs

The inputs to the risk control step are the risk action forms that detail the activities to be carried out by project team members and risk status reports that document the project metric values that indicate that a trigger value has been exceeded.

Control Activities

Risk control activities can utilize standard project management processes for initiating, monitoring, and assessing progress along a planned course of action. The specific details of the risk plans will vary from project to project, but the general process for task status reporting can be used. It can be beneficial to maintain continuous risk identification to detect secondary risks that may appear or be amplified because of the execution of the contingency plan.

Outputs

The output from the risk control step is the standard project status report documenting progress toward the completion of the contingency plan. It is helpful for the project team to also summarize the specific lessons learned (for example, what worked, what did not work) around the contingency plan in the form of a contingency plan outcome summary. Changes in risk status which could require changes in schedule, resources, or project features (for example, execution of a contingency plan) should also result in creation of a change control request in those projects having formal change control processes.

Learning from Risk

Introduction

Learning from risk is the sixth step in the SF Risk Management Process (of FIG. 22) and adds a strategic, enterprise, or organizational perspective to risk management activities. This step is sometime referred to as risk leverage, emphasizing the value that is returned to the organization by increased capabilities and maturing at the team, project, or organizational levels, and improvement of the risk management process. Risk learning should be a continuous activity throughout the SF Risk Management Process and may begin at any time. It focuses on three important objectives:
Providing quality assurance on the current risk management activities so that the team can gain regular feedback.
Capturing lessons learned, especially around risk identification and successful mitigation strategies, for the benefit of other teams; this will contribute to the risk knowledge base.
Improving the risk management process by capturing feedback from the team.

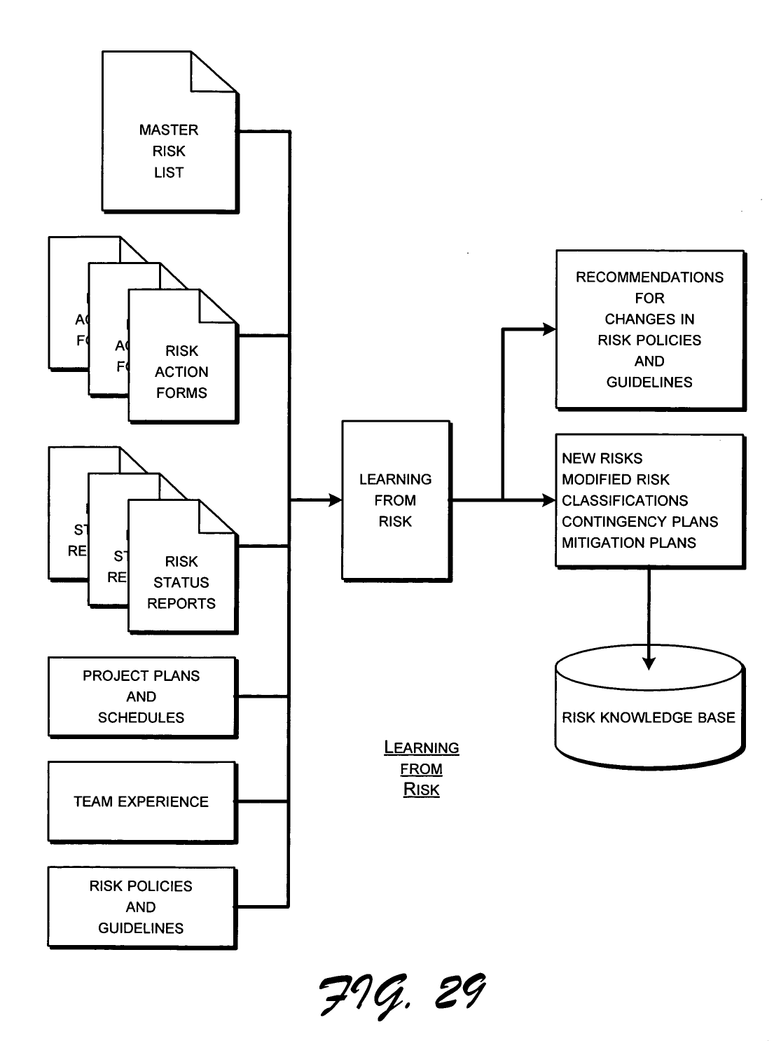

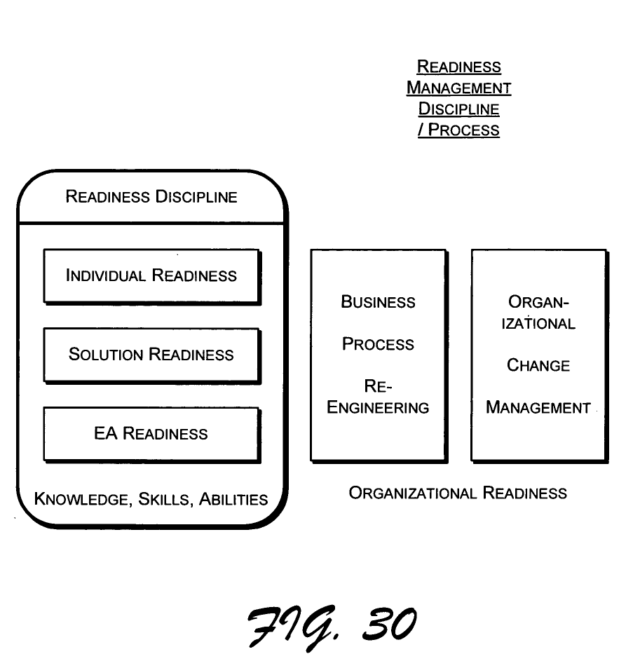

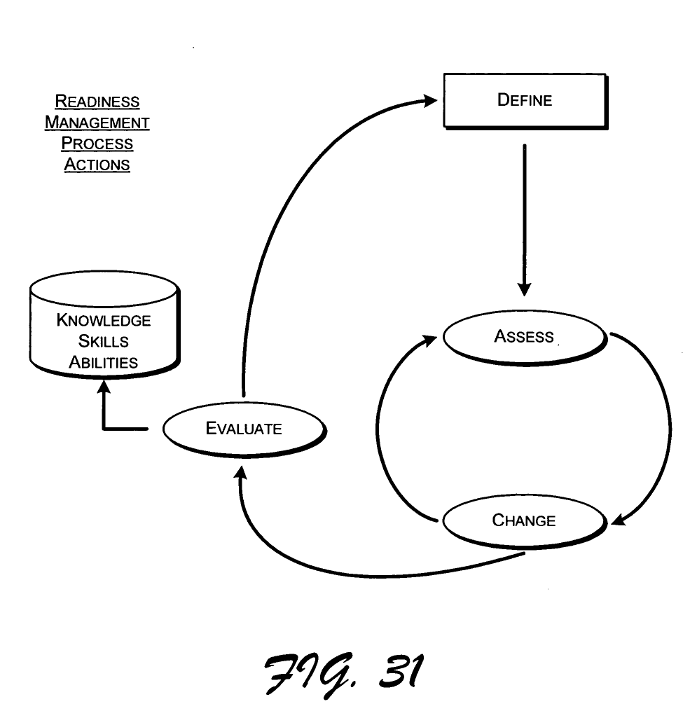

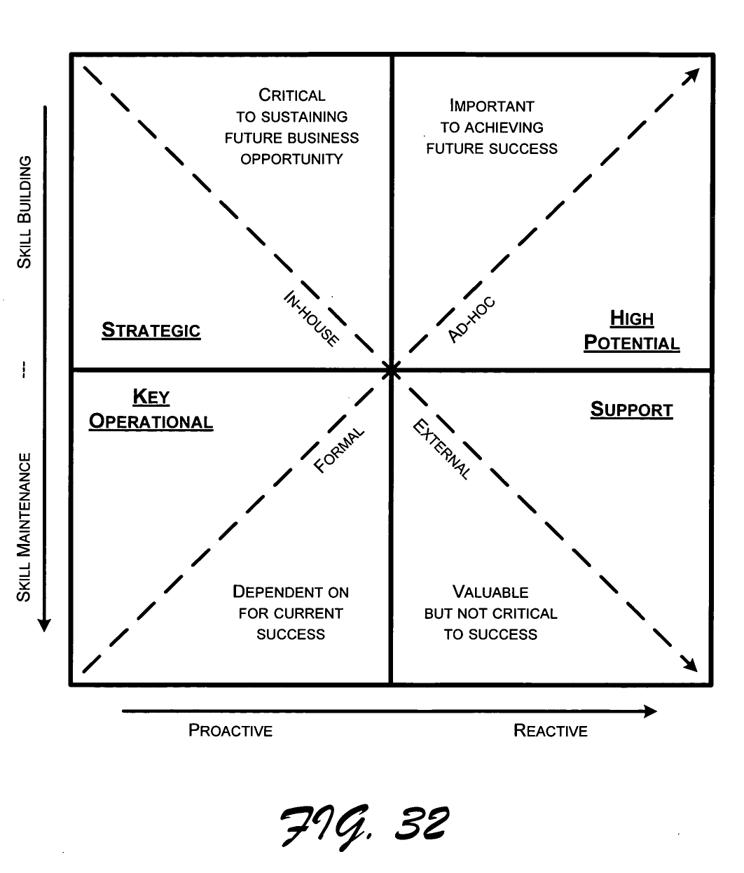

FIG. 29 is a block diagram depicting an exemplary learning-from-risk paradigm that produces at least a risk knowledge base. Risk review meetings provide the forum for learning from risk. They should be held on a regular basis and, like other SF reviews, they benefit from advance planning, development of a clear, published agenda in advance, participation by all participants, and free, honest, communication in a “blame-free” environment. FIG. 29 depicts the learning phase schematically.

Capturing Learning about Risk

Risk classification definition is a powerful means for ensuring that lessons learned from previous experience are made available to teams performing future risk assessments. Two important aspects of learning are often recorded using risk classifications:
New risks. If a team encounters an issue that had not been identified earlier as a risk, it should review whether any signs (leading indicators) could have helped to predict the risk. It may be that the existing risk lists need to be updated to help future identification of the risk condition. Alternatively, the team might have identified a new project risk which should be added to the existing risk knowledge base.
Successful mitigation strategies. The other important learning point is to capture experiences of strategies that have been used successfully (or even unsuccessfully) to mitigate risks. Use of a standard risk classification provides a meaningful way to group related risks so that teams can easily find details of risk management strategies that have been successful in the past.

Managing Learning from Risks

Organizations using risk management techniques often find that they need to create a structured approach to managing project risk. Conditions to successfully facilitate this requirement include:
An individual should be given ownership of a specific risk classification area and responsibility for approving changes.
Risk classifications should balance the need for a comprehensive coverage of risks against complexity and usability. Sometimes creating different risk classifications for different project types can improve usability dramatically.
A risk knowledge base should be set up to maintain risk classifications, definitions, diagnostic criteria, and scoring systems, and to capture feedback on the team's experience with using them.
The risk review process should be well managed to ensure all learning is captured. For a project team, reviews may be held at the project closure review, when the results of risk management should be apparent to all.

Context-Specific Risk Classifications

Risk identification can be refined by developing risk classifications for specific repeated project contexts. For example a project delivery organization may develop classifications for different types of projects. As more experience is gained on work within a project context, the risks can be made more specific and associated with successful mitigation strategies.

Risk Knowledge Base

The risk knowledge base is a formal or informal mechanism by which an organization captures learning to assist in future risk management. Without some form of knowledge base, an organization may have difficulty adopting a proactive approach to risk management. The risk knowledge base, although possibly comprising a database at least in part, differs from the risk management database which is used to store and track individual risk items, plans, and status during the project.

Developing Maturity in Managing Knowledge about Risk

The risk knowledge base is an important driver of continual improvement in risk management.

At the lowest level of maturity, project and process teams have no form of knowledge base. Each team has to start fresh every time it undertakes risk management. In this environment, the approach to risk management is normally reactive, but may transition to the next higher level of active risk management. However, the team does not manage risks proactively.

The next level of maturity involves an informal knowledge base, using the implicit learning gained by more experienced members of the organization. This is often achieved by implementing a risk board where experienced practitioners can review how each team is performing. This approach encourages active risk management and might lead to limited proactive management through the introduction of policies. An example of a proactive risk management policy is “all projects of more than 20 days need a risk review before approval to proceed.”

The first level of formality in the knowledge base comes through providing a more structured approach to risk identification. The SF Risk Management Discipline advocates the use of risk classifications for this purpose. With formal capture and indexing of experience, the organization is capable of much more proactive management as the underlying causes of risks start to be identified.

Finally, mature organizations record not only the indicators likely to lead to risk, but also the strategies adopted to manage those risks and their success rate. With this form of knowledge base the identification and planning steps of the risk process can be based on shared experience from many teams and the organization can start to optimize its costs of risk management and return on project investment.

When contemplating implementation of a risk knowledge base, the following are relevant:
The value of the risk knowledge base increases as more of the work becomes repetitive (such as organizations focusing on similar projects, or for on-going operational processes).
When an organization is focused on one-of projects, a less complex knowledge base is easier to maintain.

It is not advisable that risk management become an automatic process that obviates the need for the team to think about risks. Even in repetitive situations, the business environment, customer expectations, team skills, and technology are always changing. The team, therefore, should assess the appropriate risk management strategies for their specific project situation.

Integrated Risk Management in the Project Lifecycle

The SF Risk Management Process is closely integrated into the overall project life cycle. Risk assessment can begin during envisioning as the project team and stakeholders begin to frame the project vision and begin setting constraints. With each constraint and assumption that is added to the project, additional risks will begin to emerge. The project team should begin risk identification activities as early in the project as possible. During the risk analysis and planning stages, the needed risk mitigation and contingency plans should be built directly into the project schedule and master plan. Progress of the risk plan should be monitored by the standard project management process.

Although the risk management process will generally start with scheduled initial risk identification and analysis sessions, thereafter the risk planning, tracking, and controlling steps will be completed as different blocks of activity for different risks on the master risk list. Within SF Risk Discipline, continuous risk management assumes that the project team is “always” simultaneously in the state of risk identification and risk tracking. They will engage in risk control activities when called for by triggering events and the project schedule and plan. However, over the full project life cycle, new risks will emerge and require initiation of additional analysis and planning sessions. There is no requirement to synchronize any one of the risk management steps with any of specific project life cycle milestones. Some teams will initiate risk identification and analysis activity at major milestones as convenient opportunities to reassess the state of the project. It is convenient to summarize learning around risk at the same time.

In general, risk identification and risk tracking are continuous activities. Team members should be constantly looking for risks to the project and surfacing them for the team to consider, as well as tracking continuously the progress against specific risk plans. Analyzing and re-analyzing risks as well as modifying the risk management action plans are more likely to be intermittent activities for the team, sometimes proactively scheduled (perhaps around major milestones), and sometime as a result of a unscheduled project event (discovery of additional risks during tracking and control). Learning is most often a scheduled event occurring around major milestones and certainly at the end of the project.

Over the course of the project the nature of risks being addressed should change as well. Early in the project, business, scope, requirements, and design related risks will dominate. As time progresses, technical risks surrounding implementation become more prominent, and then transition to operational risks. It is helpful to utilize risk checklists or review risk classification lists at each major phase transition within the project life cycle to guide risk identification activity.

Risk Management in the Enterprise

To achieve maximum return on risk management efforts it is important to maintain an enterprise view that treats risk management across the enterprise.

Creating a Risk Management Culture

While few project delivery organizations argue against managing risks in their projects, many find it difficult to fully adopt the discipline associated with a proactive risk management process. Often they might undertake a risk assessment at the start of each project, but fail to maintain the process as the project proceeds.

Two reasons are frequently put forward to explain this approach:
Pressure of time on the project team.
Concern that focus on risks will undermine the customer's confidence or present a negative impression.

The root cause for these beliefs is often that managers themselves do not understand the value that risk management delivers to a project. As a result they are reluctant to propose adequate time for risk management (and indeed other project management activities) in the project budget. Conversely, they might sacrifice these activities first if the budget comes under pressure.

It is therefore especially important to ensure that all stakeholders appreciate the importance of managing risks in order to establish a culture where risk management can thrive. The following steps have been found effective in establishing risk management as a consistent discipline:
Secure management sponsorship.
Seek advice and mentorship from a risk manager who can bring personal experiences and knowledge of failures.
Educate all stakeholders about the importance of managing risks and the costs that can be incurred from failure.
Train a core set of risk managers who can provide role models and mentorship for others; an effective training approach is to combine a workshop on the theory of risk management with real exercises based on a live project.
Invite all project stakeholders to risk review meetings and ensure that status reports are circulated to them.
Introduce a recognition scheme for project team members who effectively identify and/or manage risks.
Ensure that project teams consider risks in project scheduling and making important decisions.
Seek feedback from stakeholders on the effectiveness of the risk management process and review it regularly to ensure that it is seen to add value.
Reward team members that surface risks.
   Managing a Portfolio of Projects

Project delivery organizations can benefit from introducing a process to manage risks across their portfolio of projects. Typically the benefits include the following:
Resources and effort can be assigned to projects across the portfolio according to the risks they face.
Each project's risk manager has an external escalation point to provide a second opinion on the team's assessments.
Project teams can learn more rapidly from experience elsewhere.
Quality assurance on the risk management processes is applied within each project.

It should be noted that the portfolio risk review complements the risk assessments that are undertaken by each project team. The review team does not have the project knowledge to identify risks, nor does it have the time available to undertake risk mitigation actions. However, it can contribute to risk analysis and planning.

Since the review group normally contains more experienced managers, its members can often call on that experience to advise the project team on the significance of certain risk, helping the team to prioritize risks. They can also recommend mitigation and contingency strategies that they have seen used effectively in the past.

The following are successful practices that can be applied in portfolio risk management:
Secure executive support for the portfolio review process. Maintain this by regular reports on findings and lessons learned.
Schedule the meetings well in advance; ideally make it a recurring, regular appointment on a day when many of the project leads can be expected to be present. Issue invitations to the review board well in advance; good reviewers will have many other commitments.
Select projects for review carefully. You might expect to review the biggest projects every month, but ensure that a broad cross-section of medium-sized projects is also reviewed.
Follow a standard agenda for each project, so that project leads know what to expect from the meeting. For example, 20 minutes may be allowed for presentation of the current risk assessment, followed by a 20 minute discussion of the mitigation and contingency strategies, followed by a 5-minute review of any lessons learned to be shared with other project teams.
Use standard data structures for project status reporting and risk assessment.
Ensure both data structures are updated and distributed to all attendees in advance of the meeting; this will enable you to reduce the time spent in the meeting.
Encourage project team leads to attend the review, either in person or on the telephone.
Ensure that the project team gets value from the review. Often this can be achieved by reviewing progress on issues that might not technically be risks, but where the experience of the review board members can assist the project team.
Avoid attributing any blame for the project situation.
Allow any project member to request a review on their project.

The above described SF Risk Management Discipline advocates the use of proactive, structured risk management for software development and deployment projects. The SF Risk Management Process includes several logical steps (e.g., identification, analysis, planning, tracking, controlling, and learning) through which a project team should cycle continuously during the project life cycle. The learning step is used to communicate project risk lessons learned and feedback on enterprise-level risk management resources to an enterprise-wide risk knowledge base.

SF Readiness Management

Readiness Management is an important discipline for SF. This discipline outlines an approach for managing of the knowledge, skills and abilities needed to plan, build and manage successful solutions. The SF Readiness Management Discipline describes fundamental principles based on the core SF and provides guidance for a proactive approach to readiness throughout the IT lifecycle. This discipline also provides a plan for following a readiness management process. Together with proven practices, this discipline provides a foundation for individuals and project teams to manage readiness within their organizations.

The SF Readiness Management Discipline defines readiness as a measurement of the current state versus the desired state of knowledge, skills and abilities (KSAs) of individuals in an organization. This measurement is the real or perceived capabilities at any point during the ongoing process of planning, building and managing solutions.

Each role on a project team includes important functional areas that individuals performing in those roles should be capable of fulfilling. Individual readiness is the measurement of the state of an individual with regard to the knowledge, skills and abilities needed to meet the responsibilities required of their particular role.

At the organizational level, readiness refers to the current state of the collective measurements of readiness used in both strategic planning and in evaluating capability to achieve successful adoption and realization of a technology investment.

SF and OF concentrate on successful ways to plan, build and manage solutions. The SF Readiness Management Discipline focuses on providing guidance and processes for these solutions in the areas of assessing and acquiring KSAs necessary for enterprise architecture (EA) planning and project solution teams. Other far-reaching organizational readiness aspects, such as process improvement and organizational change management, are not directly and exhaustively addressed by the SF Readiness Management Discipline.

FIG. 30 is a block diagram depicting an exemplary readiness management discipline. The SF Readiness Management Discipline focuses on the areas of knowledge, skills and abilities for the individual, solution, and enterprise architecture levels. The additional organizational readiness examples shown should be proactively addressed but are outside the core focus of the discipline.

Readiness Fundamentals

The foundation principles, important concepts and proven practices of SF as applied to the Readiness Discipline are outlined below. The primary ideals of effective readiness management are highlighted in this section and referenced further herein below.

Readiness Principles

The SF foundational principles are cornerstones of the framework's approach. Those principles relating in particular to successful readiness management are highlighted in this section.

Foster Open Communications

By establishing an open learning environment that encourages individuals to take ownership of their skills development, acknowledge and commit to rectifying skill deficiencies, and participate in setting their goals for their learning plans, individuals tend to take greater pride and have a higher drive to succeed and help others. Groups successful in creating this type of open learning environment often have periodic team training sessions where knowledge and learning is both shared and received.

Invest in Quality

Obtaining the appropriate skills for a project team is an investment. Taking time out of otherwise productive work hours, the funds for classroom training, courseware, mentors or consulting can certainly be a significant monetary investment. However, investing time and resources to obtain or develop the right people with the right skills generally results in higher quality output and greater chances of success. Projects that fail do not supply a positive return on investment. Projects that succeed with low quality result in lowered satisfaction and adoption, which in turn can have significant cost impact in areas such as support. Up-front investment in staffing teams with the right skills generally leads to greater success and higher quality.

Learn from all Experiences

Capturing and sharing both technical and non-technical best practices is fundamental to ongoing improvement and continuing success by:
Allowing team members to benefit from the success and failure experiences of others.
Helping team members to repeat successes.
Institutionalizing learning through such techniques as reviews and postmortems.

Milestone reviews and postmortems help teams to make midcourse correction and avoid repeating mistakes. Additionally, capturing and sharing this learning creates best practices out of the things that went well.

Stay Agile, Expect Change

Changes in project direction, operational procedures or individual resources can occur unexpectedly and with significant impact. Being adept at successfully facing change means having individuals and project teams committed to readiness. Readiness agility refers to having a defined readiness management process, doing proactive readiness management, and providing incentives that encourage individuals and project teams to swiftly gain the appropriate level of knowledge, skills and abilities through training, mentoring, or hands-on learning to successfully meet their defined goals. Leaving out any of these aspects of the Readiness Management Discipline increases the likelihood for risks and failure. Without the agility achieved from having a readiness process in place and being able to quickly obtain the appropriate skills necessary for success, organizations can miss opportunities and find themselves behind their competition.

Some Important Concepts

These concepts for readiness describe mindsets that are common to groups that successfully manage their approach to readiness.

Understand the Experience You Have

Individual knowledge and experience is an asset that offers dual value. The individual who possesses the knowledge and experience benefits personally as well as the organization as a whole. The value of this knowledge is diminished for both the individual and the organization without a collective understanding and measurement. For example, an individual may possess knowledge that the organization does not currently recognize, or the organization may lack a method to access that knowledge. Consequently, knowledge assessment and knowledge management are important concepts of a readiness effort. An organization can promote readiness through the capture and utilization of knowledge. A defined knowledge management program will take the idea from concept to reality. The added value of a knowledge management program is its identification of knowledge lacking in both individuals and the organization.

Willingness to Learn

Willingness to learn includes a commitment to ongoing self improvement. It both encourages and enables knowledge acquisition and sharing.

Readiness Should Be Continuously Managed

Learning should be made an explicit and planned activity—for example, by dedicating time for it in the schedule—before it will have the desired effect.

Proven Practices

The following proven practices are common actions to ensure readiness is a continuous, ongoing focus for success.

Carry Out Readiness Planning

As with any aspect of a project, planning for readiness is the key to success. Knowing up front the required level of readiness creates a proactive approach to assembling the appropriate resources, defining budgetary needs for training or obtaining the appropriate expertise, and building training time into the schedule. Readiness plans for each role are rolled up to create an overall readiness plan for the solution team. Without planning, readiness management is likely to be overlooked until a significant gap in skills causes the project to be challenged, leading to significant risk of failure.

Measure and Track Skills and Goals

Successful readiness management includes assessing and tracking skills and the goals of individuals. This includes taking into account current abilities versus the desired knowledge levels so that the appropriate matching of skills can happen at both the individual and the project levels during resource allocation. Tracking and measuring this information helps ensure project teams have the capability of doing readiness planning. Through the process of planning, project teams select members with both the desire to participate and skills required. The most effective way to accomplish this is via a mandatory skills-reporting database and requiring individuals to keep the data up to date.

Treat Readiness Gaps as Risks

After completing assessments and determining the proficiency gaps—essentially finding the current versus the desired state—project teams should identify readiness gaps as risks and treat them as such. Gaps in areas of important knowledge, such as the skills and abilities needed to successfully complete a project, can have profound effects on the schedule, budget, and resources needed to fill those gaps. Depending on the type of project, readiness risks may delay project initiation or indicate a need to obtain resources with the appropriate skills. When gaps are treated as risks there is generally a more proactive approach to readiness management and subsequent mitigation of these risks.

Readiness Process Overview

The SF Readiness Management Discipline includes a readiness management process to help prepare for the knowledge, skills and abilities needed to build and manage projects and solutions.

FIG. 31 is a block diagram depicting an exemplary readiness management process. The readiness management process is composed of four steps: (1) Define, (2) Assess, (3) Change and (4) Evaluate. Each step of the process includes a series of tasks to help reach the next milestone.

(1) Define
Scenarios
Competencies
Proficiencies

(2) Assess
Measure knowledge, skills, abilities
Analyze gaps
Create learning plans
   (3) Change
Train
Track progress
   (4) Evaluate
Review results
Manage knowledge

The process is considered an ongoing, iterative approach to readiness and is adaptable to both large and small projects. For aligning individual, project team, or organizational KSAs, following the steps in the readiness process helps to manage the various tasks.

The most basic approach to the readiness process is simply to assess skills and make appropriate changes through training and assessment. On projects that are small or have short timeframes, this streamlined approach is quite affective. However, performing the steps of defining the skills needed, evaluating the results of change and keeping track of KSAs allow for the full realization of readiness management, and is typically where organizations reap the rewards of investments in readiness activities.

Proactive Readiness Management

Often projects begin without the appropriate level of awareness of the skills individuals should possess to make the project a success. Therefore, teams too frequently find themselves reacting to situations rather than preparing individuals ahead of time to tackle situations that arise. In other words, only when it is determined that a project is losing control is the skills gap addressed, by either turning to companies that can provide solutions to their problems, buying in the skills temporarily or dissolving the project altogether.

The intent of the Readiness Management Discipline is to enable both individuals and groups to be more proactive in their approach to readiness. The discipline provides the foundation for establishing steps to proactively manage readiness issues most likely to be encountered while introducing new technologies, or managing the ongoing operation of solutions. By establishing the competencies and skill levels essential for success, a project team will have the information needed to plan and budget for its training needs to implement the solution.

Equipped with the knowledge of how different scenarios and competencies relate to job roles, teams will be better able to map skills in which people fulfilling the roles should be proficient. This up-front identification allows a more proactive approach to analyzing strengths and weaknesses, to devise appropriate training plans and better enable individual, project team, and strategic planning success.

Another differentiator in a proactive versus reactive approach to readiness management is capturing the knowledge, skills and abilities of individuals and sharing the important learning and best practices with others. Knowledge sharing can be as simple as brown-bag sessions or a more comprehensive approach such as software-based knowledge management and knowledge bases. In either case, this sharing creates a valuable return on investments made in learning.

Readiness Management: A Proactive Approach

| Proactive | vs. | Reactive |
|---|---|---|
| Treat readiness planning as | vs. | React to shortfalls in knowledge, |
| positive | | skills, abilities |
| Use a known and structured | vs. | Using and ad hoc process or none |
| process | | at all |
| Anticipate and schedule | vs. | Conduct training or fix gaps as |
| readiness needs | | they occur |
| Develop and use knowledge | vs. | Unknown knowledge assets |
| management system | | |

Readiness Throughout the IT Lifecycle

As part of the management of the IT lifecycle, the Frameworks provide guidance around the overall approach to setting the IT strategy through the enterprise architecture (EA) model. Enterprise architecture is a framework composed of four architecture perspectives: business, application, information, and technology. A number of issues to consider when working with the EA process are outlined below.

Any project will introduce change that represents a shift from the existing norm. It is essential that the necessary KSAs to achieve the desired new state are available or can be developed or purchased within the constraints of budget and time. Projects that make it to the planning phase of the enterprise architecture process should have these elements identified and made part of the project criteria.

In EA planning, greater detail around the gap between the current and future knowledge, skills and abilities of the organization is gathered in a manner similar to inventorying other resources of the enterprise. During this time the KSAs within the organization should be considered as the portfolio of projects is prioritized. Skills inherent upon completing one project may be foundational to the delivery of a subsequent project, resulting in a need to appropriately sequence or have the ability to obtain the expertise needed.

In the development phase of the EA process model, the enterprise IT organization should ensure that project initiatives are closely aligned with business needs, the project team is fully prepared in terms of training and skills and is conforming to project requirements to deliver measurable business value.

The important readiness activity during the stabilizing phase in EA is feedback. Individual projects provide feedback about assumptions made during planning, and the effectiveness of the readiness activities performed during development. Capturing this feedback and recycling it into the next iteration of EA planning is the basis of a “continuous improvement” mindset.

It is imperative to allot the necessary time to assimilate the learning and skills development needed to meet the project requirements. Learning is inherently an iterative process. Tailoring the timing and delivery of the training to optimize the learning experience requires an organization's ongoing commitment to learning.

Steps of the Readiness Process

(1) Define

During EA planning, an organization aligns its business and IT goals to create a shared vision of what the organization will look like. While doing this, the teams and the organization should also define the individual skill sets needed to implement projects necessary to reach that shared vision. This is the first step of the SF Readiness Management process and is called “define.” During this stage, the scenarios, competencies, and proficiency levels needed to successfully plan, build, and manage the solutions are identified and described. This is also the time to determine which roles in the organization should be proficient in the defined competencies. Depending on the role, the individual may need to be proficient in one or many of the defined competencies.

Three components of readiness concentrated on during the Define step are:
Scenarios
Competencies
Proficiencies

Outputs from the Define step include:
Competencies identified with desired proficiency levels
Competencies and proficiencies mapped to the appropriate scenario

Scenarios

Scenarios are used to describe the typical situation the EA or IT department encounters when introducing technology projects. Scenarios generally fall into one of four categories detailed below. These correlate, to some degree, to the phases, focus areas and unique challenges an organization goes when developing and managing technologies or products.

FIG. 32 is a block diagram depicting an exemplary correlation between IT scenario categories and typical phases, training types, and skills management. FIG. 32 is derived from work by the Cranfield Institute of the United Kingdom. Four exemplary IT scenarios as illustrated in FIG. 32 are:

High Potential. Focus on the situations an IT department encounters when planning and designing to deploy, upgrade, and/or implement a new product, technology, or service in its organization. These are typically research type situations in which the technology is brand new or in beta form.

Strategic. Scenarios in this category focus on the situations an IT department is likely to encounter when exploiting new technologies, products, or services. These are typically market-leading solutions which could lead to business transformation defining the to-be long-term architecture.

Key Operational. Scenarios in this category focus on the situations an IT department is likely to encounter once it has deployed, upgraded, and/or implemented a new product, technology, or service that has to coexist, or continue to seamlessly interact with legacy software and systems. These are typically today's business-critical systems, aligned with the as-is technology architecture.

Support. Scenarios in this category focus on situations in which it is necessary to extend the product to fit the needs of a customer's environment. These are typically valuable but not business-critical solutions and often involve legacy technology.

These four exemplary IT scenario categories are presented in FIG. 32, in which IT scenario categories that correlate to typical phases, training types, and skills management encountered when developing and managing technologies or products are shown.

By categorizing IT projects within the EA into the appropriate scenarios, readiness planning can be done according to the unique nature of that project. Different scenarios require distinct approaches to obtaining the appropriate resources and skills for that project type. By first defining the scenario, the appropriate competencies and proficiencies can then be mapped. Differing scenario types may also drive decisions for out-sourcing or using consulting to obtain the skills needed. For example, doing an infrastructure deployment project of software currently in beta development would take a much different approach to achieving the appropriate skill set for the project team than would a key operational project dealing with more conventional and proven systems. Staffing for a “high-potential” project scenario might include specialized vendor trained consultants versus a project scenario where readiness planning typically includes courseware training and certification of in-house staff.

Here is a summary of the scenario categories and typical approaches for obtaining the appropriate levels of readiness in terms of knowledge, skills and abilities.

High Potential. Have a high degree of agility, be able to investigate and evaluate new technologies and to be prepared to obtain (for a short period) the best expertise available.

Strategic. Have in-house, in-depth expertise at the solution architect level and be able to bridge skills across technology to the business.

Key Operational. Quality of technical knowledge and process are important as is ready availability of the right skills. Typically, out-sourcing occurs to obtain quality skills and knowledge or developing strong in-house capability.

Support. The cost of delivery becomes paramount and the organization may decide to rely on external skills (particularly for legacy) on a reactive basis.

With the projects and their associated scenarios defined, it is now time to identify the competencies and subsequent proficiencies associated with these project scenarios.

Competencies

In the context of readiness, “competent” means being adept or well qualified to perform in a given IT scenario. Competencies are intended to describe the measurable objectives, or tasks, that an individual should complete with proficiency in a given scenario.

“Competency” is used to define a major part of an individual's job or job responsibility relating to performance. A competency can be considered a “bucket” that consists of knowledge, skills, and performance requirements:
Knowledge. The information that an individual should possess to perform competently in the job.
Skills. The behaviors that make up the competency. These are the abilities that describe competency in a specific area.
Performance Requirements. The expected results of an individual's executing his or her skills and knowledge at a proficient level of performance in the job role.

Proficiencies

“Proficiency” is used in relation to readiness as the measure of ability to execute tasks or demonstrate competencies within a given scenario. Proficiencies describe tasks that individuals at a given skill level should be able to perform.

The proficiency or skill level for a given competency is designated by the level at which individuals are assessed or assess themselves. This proficiency level provides a benchmark, or starting point, for analyzing the gap between the individuals' current skills set and the necessary skills for completion of the tasks associated with the given scenario.

In the SF Readiness Management process, two determinations should precede the creation of a learning plan. First, the desired level of proficiency should be determined. Second, the current state of readiness should be determined. The proficiency level should be determined for a given scenario and set of competencies, using either self-assessment or assessment testing. Once the beginning and end points are known, the gap is identified. It is at this point that the learning plan is developed to assist in moving to the desired proficiency level.

The following table shows an example proficiency rating scale used in completing proficiency assessments.

| Skill | | |
|---|---|---|
| Level | Simple | |
| Rating | Description | Description |
| 0 | No Experience | Not applicable. |
| 1 | Familiar | Familiarity: Skill in formative stages, has |
| | | limited knowledge. Not able to function |
| | | independently in this area. |
| 2 | Intermediate | Working knowledge: Good understanding of |
| | | skill area, is able to apply it with reasonable |
| | | effectiveness. Functions fairly independently |
| | | in this area but periodically seeks guidance |
| | | from others. |
| 3 | Experienced | Strong working knowledge: Strong |
| | | understanding of skill area, is able to apply it |
| | | very effectively in position. Seldom needs |
| | | others' assistance in this area. |
| 4 | Expert | Expert: Has highly detailed, thorough |
| | | understanding of this area and is able to apply |
| | | it with tremendous effectiveness in this |
| | | position. Often sought out for advice when |
| | | others are unable to solve a problem related to |
| | | this skill area. |

A proficiency gap is when performance is at a lower level than the expected proficiency level for a role.

During the Define step of the SF Readiness Management process, the level at which individuals should be performing for each job role in given scenarios are determined. Proficiency levels are then associated with competencies so when assessments are completed, the output can be measured and analyzed to determine proficiency gaps.

(2) Assess

The Assess step of the SF Readiness Management process (of FIG. 31) determines the competencies individuals currently possess. It is during this step that analysis of the competencies as they relate to the various job roles begins, to determine the skills of individuals within each of these roles. Then the desired competencies identified are analyzed against the current competencies—the “as-is versus the to-be.” This work enables the learning plans' development, so that desired competency levels can be reached.

Depending on the number of job roles needed to make the technology a success, a given scenario might have multiple:
Competencies by scenario
Defined levels of proficiency by competency
Objective skills assessments
Learning plan road maps

Tasks during this step in the process are:

Measure knowledge, skills, abilities
Analyze gaps
Create learning plans

Outputs from the assess step are:
Assessment output/gap analysis
Learning plans

Measure Knowledge, Skills, Abilities

There are two options available for performing individual assessments: self or skills. Self-assessment is a procedure whereby individuals assess their own level of ability. This includes responding to a list of questions such as, “Are you able to perform x?” Self-assessment requires individuals to measure their own ability scale, ranging from familiarity to expert levels. This technique is effective in learning what an individual thinks of his or her level of ability. While it might not always be an accurate assessment of the individual's abilities, it can be directly linked to the individual's perceptions of his or her readiness.

Skills assessments test the actual expertise of an individual. This type of test requires individuals to respond to specific, often technical, questions to show their knowledge; to perform specific tasks, and to demonstrate analysis abilities.

By measuring the current state of the individuals and aligning those results with the desired state (identified during the Define step), organizations, project teams and individuals are able to identify the gaps between the current state and the desired state of readiness. In many cases when facing a new project, groups do not have the internal capabilities or experience to correctly assess the skills and abilities needed. Providers such as Certified Technical Education Centers (CTEC) or consulting organizations can assist with this important step.

The following is a list of example sub-processes suggested in order to perform successful assessments.

Determine the Assessment Process

The assessment should be conducted according to a documented process that is capable of meeting the assessment purpose. This is the time to conduct planning for the assessment. Activities can include:
Define the required inputs.
Document the activities to be performed in conducting the assessment.
Document the resources required and the assessment schedule.
Document a description of the planned assessment output.

Data Collection and Rating

Next, the strategy and techniques for the selection, collection, and analysis of the data and the justification of the ratings should be identified. Additional considerations include:
Ensure the objective evidence gathered is sufficient to meet the assessment purpose and scope.
Validate the data collected.
Document the justification of ratings.
Document the decision-making process that is used to derive rating judgments.

Recording the Assessment Output or Gap Analysis

Finally, the assessment results are documented and compared to the desired competency levels. The difference in scores is the defined skill gap. The following steps and information are included in the output.
Results (gaps in performance) are analyzed and documented.
Results of the assessment are reported.
The assessment report generally contains at least the following information:
   Date of the assessment
   Assessment input
   Identification of the objectives being assessed
   Explanation of the assessment approach
   Identification of any additional information collected and used in the assessment process

Analyze Gaps

A proficiency gap occurs when an individual actually performs at a lower level than the expected proficiency level for his or her role. During the Define step, the level at which individuals should be performing for a given competency is determined. During the Assess step, the organization determines the level at which individuals are actually performing. With these two components—the current state and the desired state—the gaps are identified and individuals can concentrate on bridging these gaps through the use of learning plans. Training and on-the-job experience will close these gaps. It is at this point that a project team should commit to supporting its members as they execute the learning plans. Identifying a proficiency gap is meaningless if the commitment to support and giving the necessary training is not provided.

Create Learning Plans

Now that gaps in the individual's current skill set have been analyzed; the information gathered can be used to formulate training plans. An effective learning plan identifies the appropriate resources such as training materials, courseware, sections, computer based training, mentoring, on the job or self-directed training, that will assist in this evolution.

Learning plans should consist of both formal and informal learning activities, and guide individuals through the process of moving from one proficiency level to the next. The learning plan should be taken beyond a mere list of available and suggested assets; it should be applied into the context of the work environment. The most effective adult training takes into account the different learning styles of individuals and accommodates those differences to efficiently use time and resources. As well as a plan for training, learning plans should account for how to begin to apply the information learned to the job.

(3) Change

The Change step of the SF Readiness Management process (of FIG. 31) begins the advancement of skills through learning in order to bridge the gap between current proficiency and desired proficiency levels.

Tasks and outputs of readiness during the change step are:
Training
Track Progress

Outputs of the Change step are:
Knowledge gained from training
Progress tracking data

Train

Now that the learning plans created during the Assess step are put in place, actual training, hands on learning and mentoring occurs.

Track Progress

Another component associated with the change portion of the readiness management process is implementing a system of tracking the progress of the learning plans. The approach to progress tracking can be as simple as a spreadsheet or as advanced as a tool that allows monitoring and reporting of individuals and their skills by scenario and competency. It is important to have the ability to track individual progress as employees move from one stage to the next as they bridge the learning gap. This way, at any time in the lifecycle, organizations can analyze individual or overall readiness to make thoughtful adjustments to readiness plans.

(4) Evaluate

The Evaluate step of the SF Readiness Management process (of FIG. 31) determines whether the learning plans were effective and whether the lessons learned are being successfully implemented on the job.

During evaluation, a determination is made if the desired state, as described during the define step and measured during the assess step, was achieved through change. In addition, this is the time to integrate the lessons learned into the organization in order to help make the next project more successful.

This evaluate step can be the end of the readiness management process. But since learning is an ongoing need for continued success, evaluation is viewed as a beginning to an iterative process. Now is the chance to begin defining readiness needs again or to reassess KSAs and determine whether additional change is required.

Components of readiness concentrated on during the evaluate step:
Review results
Manage knowledge

Outputs from the evaluate step:
Feedback
Certifications
Knowledge Management system

Review Results

A real-world test of training's success is the effectiveness of the individual back on the job. One of the activities during the change step is identifying the most effective approach to the transfer of knowledge. A suggested approach is to follow traditional training delivery, such as instructor-led and self-study, with on-the-job mentoring or coaching.

One benefit of this approach is the capability not only to guide individuals through their first exposure to new concepts, but also to allow the expert (mentor or coach) to assess the effectiveness of the training. Using verbal and written feedback, the expert highlights the areas where individuals are performing well and is demonstrating an understanding of the given concepts. Likewise, the mentor or coach is able to provide feedback on the areas where the individuals are struggling or appear weak in their understanding and application of the new learning. This review helps to identify if the knowledge transfer approach taken was the most effective and those areas which may need to be re-addressed and where further training may be necessary.

The individuals' activities in this phase may include some introspection and self-assessment to determine whether the learning was effective before putting those new competencies to work. Individuals may also decide it is a good time to become certified because they have done the learning, performed the important tasks, and assimilated the knowledge.

Manage Knowledge

A natural side effect of training individuals is that the knowledge they acquire becomes intellectual capital the individual can capture and disseminate throughout the organization. As learning plans are completed and applied on the job, individuals discover important learning that their training provided. Sharing this information with others throughout the organization enhances the collective knowledge and fosters a learning community. One objective of Readiness Management Discipline is to encourage development of a knowledge management system to better enable the sharing and transfer of proven practices and lessons learned, as well as create a skills baseline of the knowledge contained within the organization.

Individuals in an organization carry with them a body of learning, expertise, and knowledge that, however extensive or expansive, encompasses less than the collective knowledge of all the people. A knowledge management system provides an infrastructure by which that knowledge can be harnessed and made available to a community.

As organizations face the need for global knowledge that can be easily and quickly leveraged, compounded by the shorter timeframes for implementing solutions, requirements increase for individuals to share their knowledge and expertise, and reuse what others have learned.

Knowledge management systems provide many benefits including, but not limited to, the following:
Increasing organizational effectiveness by creating the ability for individuals to find the information and expertise they need, when they need it, fast—regardless of its location.
Establishing a common structure that facilitates the easy sharing of experiences and proven practices.
Facilitating individuals working across organizational and geographical barriers through “global” communities. Because many customers have locations world-wide, there's an increased need for collaboration, sharing of proven practices and lessons learned.
   Readiness and the SF Team and Process Models

As described, the enterprise architecture model is useful when creating a readiness strategy that affects the entire organization and IT lifecycle. At the project team and individual levels, the readiness management process can be used to map activities within the SF Process and Team models.

When considering readiness there is a need to partition the specific readiness goals into the necessary activities and deliverables produced throughout the project lifecycle intended to achieve those goals. Each role will perform activities and produce deliverables that relate to the project readiness goals for their constituency. When readiness is seen as a component of the project goals, readiness deliverables are completed at various levels within each phase and milestone of the project. Thus, mapping of readiness activities and deliverables to the SF Process Model phases is useful but teams adjust their activities (and when these activities occur) according to the size and type of project.

The focus is on preparing the team with the knowledge, skills and abilities to effectively deliver the project. In the early stages of the SF envisioning phase, this includes documenting the project approach to readiness. This approach documentation may contain information such as:
The individuals that are to perform assessments, priorities, and budgets for training existing staff or obtaining the needed skills
Determination of the project scenarios and desired proficiency levels
The ways in which these activities will be accomplished

During the SF planning phase, the high-level activities and deliverables identified during envisioning are taken to a greater level of detail, with estimates and dependencies applied for the tasks and integrated into the overall project plan and schedule. This helps determine the true cost and feasibility of the project beyond the development effort alone. This is the time when team assessment can be conducted to produce information on skills gaps so analysis and planning for bridging that gap can move forward.

Because the needs of the team precede the operational needs, many of the gaps identified for the team are filled during the planning phase. This improves the design and determines the readiness of the team for development.

Effectively prepared, Development and Testing can focus on the project deliverables during the development phase. Release Management, User Experience and Product Management can begin in the early stages of preparation for final release. Incremental exposure of the product to the external constituencies and gradual involvement in the later stages of testing allow the team to assess the efficacy of the organizational readiness activities on the eventual owners of the product.

In the last stages of the project, most of the readiness activities have been or are being executed as the training and preparation of the users and support and operations staff is done, and the product is released and/or deployed.

At the end of the project, the team effort relative to readiness is evaluated by the team and the organization so that subsequent projects can repeat successes and learn from the areas that require improvement.

The deliberate outputs for readiness are often embedded in the regular milestone deliverables, but may be itemized separately to highlight or manage them with individual attention. Where the gap in KSAs is large, the more deliberate Program Management needs to be in assuring readiness activities and deliverables are not relegated to the background or assumed to occur indirectly. Readiness activities are people-centric, and therefore require constant vigilance.

Skills Required for SF Roles

A factor in the success of the SF team model is its separation of roles and their respective goals. This feature requires each role function team to focus on the aspect of the project it is responsible for delivering to the customer. Because these role functions are distinct, the required skills range from marketing to technical writing to unit test code development. Certain team roles may be combined if one person has a broad skill set that meets the goals. Large, complex projects may require many individuals with skills specific to each aspect of the role function.

A key is taking the project vision and following the SF Readiness Management Discipline to proactively map the goals to the roles and their respective skills required for success.

Product Management

| | |
|---|---|
| Main Role | Proven experience in the area of Product Management. |
| | Able to lead and manage a team. |
| | Business and technical knowledge. |
| | Marketing, Communications, Business case development |
| | (cost/benefit analysis) skills required. |
| | Advocate for the Customer. |
| Sub-Role | Proven experience in product management. |
| | Able to define version/release plan for product/solution. |
| | Able to prioritize requirements and features per |
| | version/release. |
| Sub-Role | Proven experience in product management. |
| | Business and Competitive knowledge. |
| | Ability to do research and synthesize data. Translate into |
| | solution requirements. |
| Sub-Role | Proven experience in product management with emphasis on |
| | marketing. |
| | Able to create/drive demand via marketing program. |
| | Able to build community and support for solution via |
| | communications. |

Program Management

| | |
|---|---|
| Main Role | Proven experience in managing projects and teams. |
| | Business and technical knowledge. |
| | Facilitation, negotiation, communications skills. |
| | Able to drive trade-off decisions. |
| Sub-Role | Proven experience in managing projects and teams. |
| | Business and technical knowledge. |
| | Facilitation, negotiation, communications skills. |
| | Able to drive trade-off decisions. |
| Sub-Role | Proven experience in the area of architecture. |
| | Technical expertise in given technology or solution. |
| | Understanding of customer environment. |
| Sub-Role | Proven experience in the project administration. |

Development
Program Management

| | |
|---|---|
| Main Role | Prior experience managing a solution development team. |
| | Technical expertise in products/technologies which are |
| | relevant to solution. |
| | Understanding of application and infrastructure components |
| | (hardware &software). |
| Sub-Role | Prior experience developing solutions focus on application |
| | dev. |
| | Understanding of standards for coding and building apps. |
| | Knowledge of relevant products and APIs, industry standards |
| | to build to. |
| Sub-Role | Prior experience developing solutions focus on infrastructure. |
| | Technical expertise in products relevant to solution. |
| | Hardware knowledge may also be required. |

Test

| | |
|---|---|
| Main Role | Proven experience in the area of testing. |
| | Ability to lead and manage a team. |
| | Technical expertise in products/technologies which are |
| | relevant to solution. |
| | Understanding of application and infrastructure components |
| | (hardware & software). |
| | Understanding of testing requirements and standards. |
| Sub-Role | Technical expertise in products/technologies which are |
| | relevant to solution. |
| | Understanding of application and infrastructure components |
| | (hardware & software). |
| | Understanding of testing requirements and standards. |
| Sub-Role | Proven experience in usability design and testing. |

Release Management

| | |
|---|---|
| Main Role | Prior experience in Release Management. |
| | Ability to lead and manage a team. |
| | Technical knowledge hardware & software components |
| | Ability to release and deploy a solution. |
| | Advocate for the operations team |
| Sub-Role | Prior experience in Release Management. |
| | Technical knowledge hardware & software components |
| | Ability to release and deploy a solution. |

User Experience

| | |
|---|---|
| Main Role | Proven experience in developing guidelines and technical |
| | documentation to aid in understanding and development of |
| | solution. |
| | Excellent written and oral communication skills. |
| | Knowledge of user requirements. |
| | Understanding of Usability. |
| | Advocate for End User. |
| Sub-Role | Proven experience in technical writing. |

Creating Readiness Plans

During the SF Process Model planning phase, each SF team role, whether represented by an individual or an entire functional team, should consider the readiness aspects of their respective constituency. This requires planning for the activities required to meet the readiness approach criteria essential for the project to be successfully completed and meet the goals of the solution. To create the deliverables for the Project Plan Approved milestone, each role needs to consider, at a high level, the current knowledge, skills and abilities of their represented constituency and the level of effort and feasibility of the change to their constituency during and after the project. The output of this effort is a role-centric readiness plan.

One important component of this effort is the process of planning from the bottom up. For example, rather than having the Test team follow a schedule developed by the team lead, the Test team develops a schedule and passes it up through the team hierarchy. Each role cluster provides its own budget and schedule estimate to the Program Manager, who then rolls this information up into the master project plan. The benefit of this approach is that each role cluster contributes to the readiness plan. Each role cluster has defined a portion of the team's readiness and is therefore committed to overall readiness. The inclusion of the readiness plan as part of the master project plan allows the organization to accurately represent the change and gauge the true cost of the project so as to better project the return on that investment before proceeding to the next phases.

The SF Readiness Management Discipline described in the example above provides guidance and a foundation for individuals, teams and organizations to establish a process of defining, assessing, changing and evaluating the knowledge, skills and abilities needed for successful planning, building and managing successful solutions.

Exemplary SF Data Structures:

FIG. 33 is an example of devices 3302 and team members 3316 creating, manipulating, and otherwise interacting with a data structure 3312 that can facilitate the process of designing and developing a project. Each team member 3316 may be comprised of one or more people and/or groups of teams. Each team member is capable of interacting with data structure 3312. Examples of such interactions include creating, viewing, storing, transmitting, receiving, modifying, forwarding, etc. data structure 3312.

More specifically, FIG. 33 is a block diagram illustrating an example of devices 3302 and associated components. Devices 3302(A) and 3302(B) are in communication with other over a communication channel represented by transmission media 3314. In a described implementation, devices 3302 comprise a personal computer (e.g., a desktop or laptop computer). However, devices 3302 can alternatively comprise any device type described herein above with reference to FIG. 1. A type of device 3302(A) may differ from a type of device 3302(B). Moreover, although only two devices 3302 and team members 3316 are shown, three or more of each may alternatively be involved in an interaction with a data structure 3312.

A display screen 3310 may be integral with or merely connected (wirelessly or by wire) to device 3302. The contents of data structure 3312 may be presented on and viewed from display screen 3310. Because devices 3302(A) and 3302(B) are illustrated as having similar components, only device 3302(A) is independently and specifically described below.

Generally, device 3302(A) includes one or more processors 3304(A), at least storage media 3306(A), and a communication interface 3308(A) that is coupled to and may form a part of transmission media 3314. Storage media 3306(A) includes processor-executable instructions that are executable by processor 3304(A) to effectuate functions of device 3302(A). Such processor-executable instructions may include programs for displaying, modifying, communicating, etc. data structure 3312.

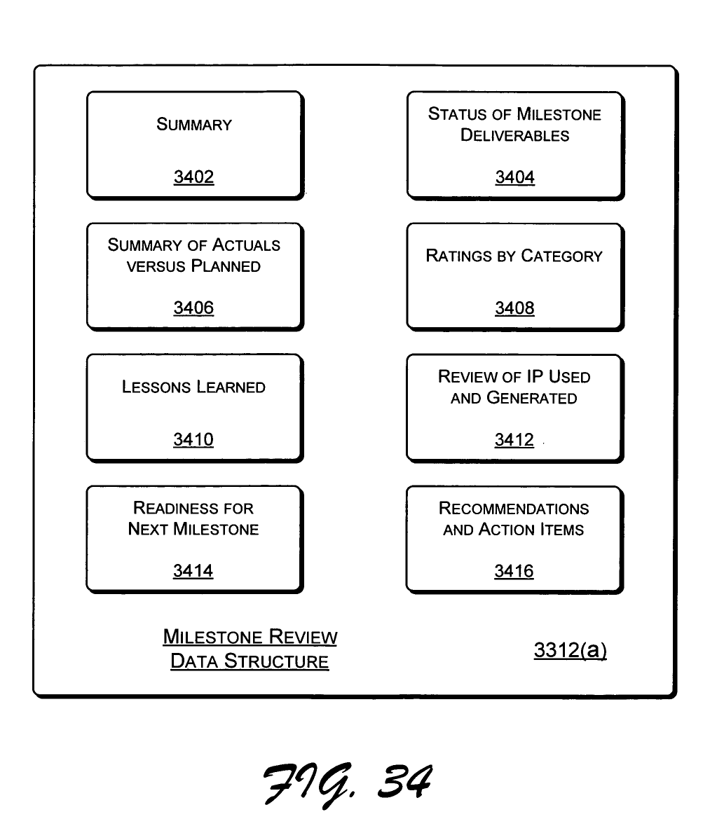

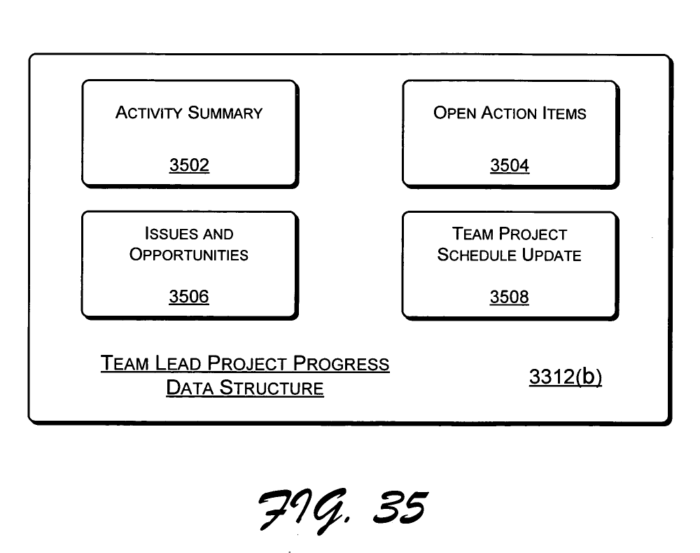

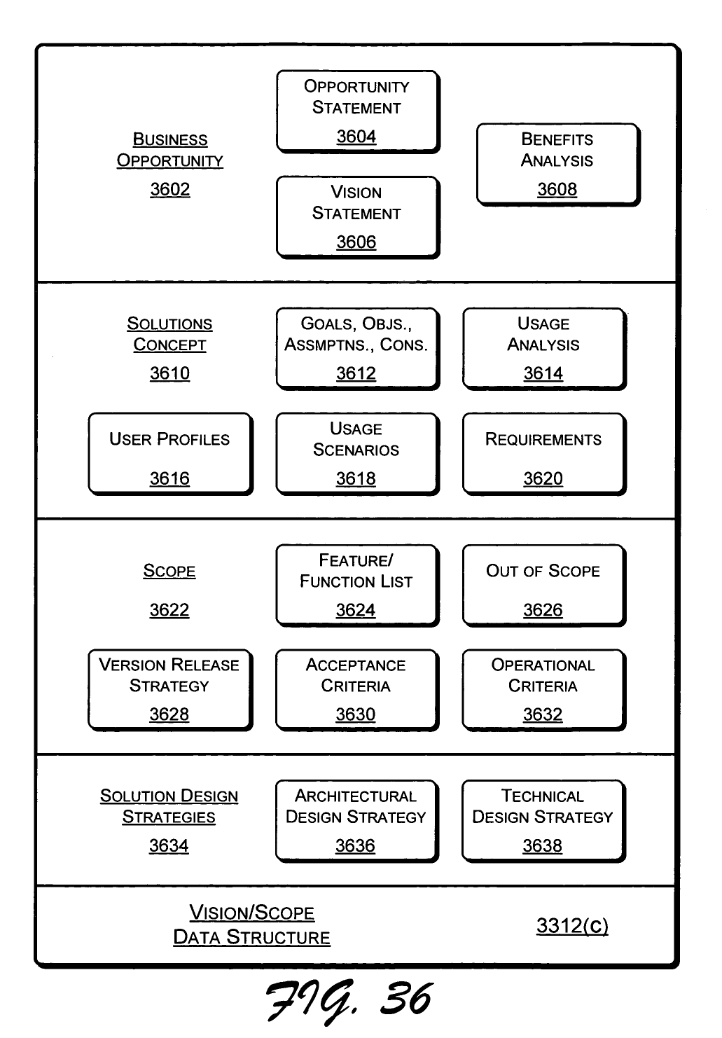

Storage media 3306(A) may be realized as volatile and/or nonvolatile memory. More generally, device 3302(A) may include and/or be coupled to media generally (e.g., electromagnetic or optical media) that may be volatile or non-volatile media, removable or non-removable media, storage or transmission media, some combination thereof, and so forth. As illustrated, storage media 3306(A) stores data structure 3312. Examples of data structure 3312 are described herein below with references to FIGS. 34-42. Data structure 3312 is also shown in transit along a communication channel formed from transmission media 3314.

Although not explicitly shown in FIG. 33, device 3302(A) is capable of accepting user input (e.g., from a mouse, a keypad, a touch pad/tablet, a keyboard, etc.). In response to user input (e.g., from team member 3316 ), an application (not separately shown in FIG. 33) utilizes the input to create, modify, add to or subtract from, etc. data structure 3312.

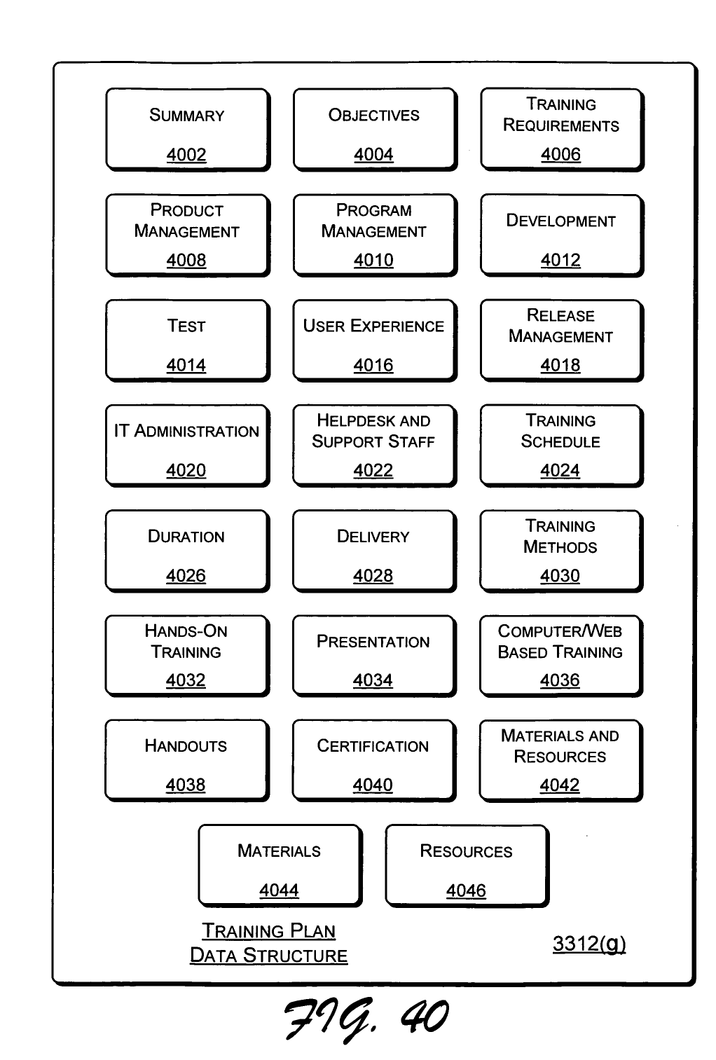

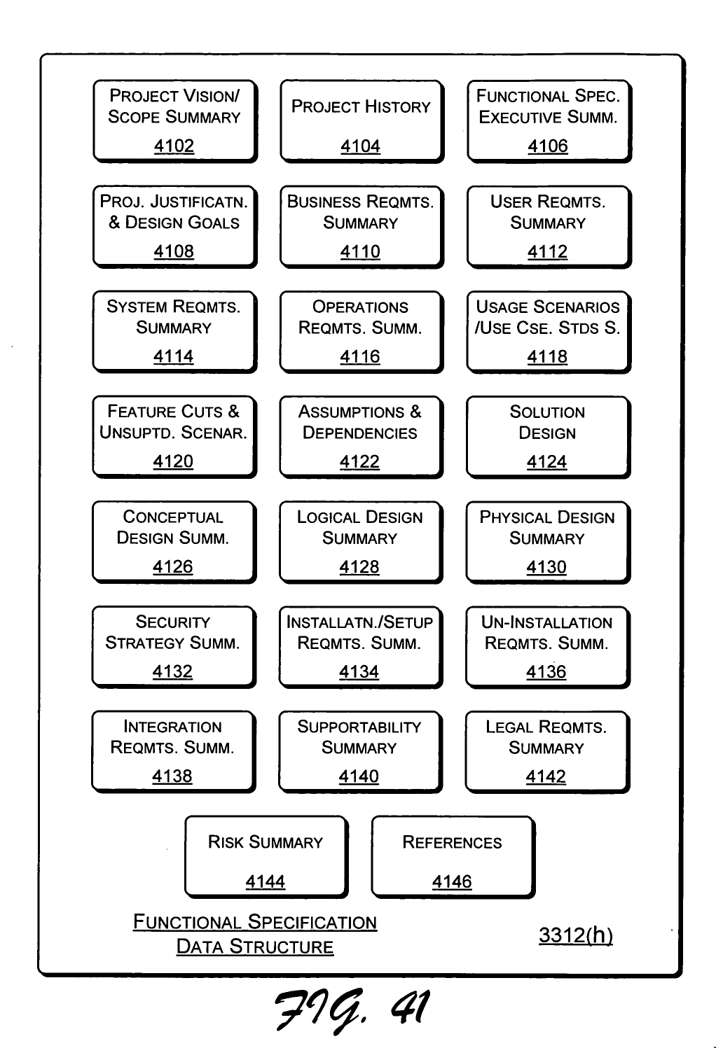

Nine example data structures 3312 are described herein below with reference to FIGS. 34-42. Each is related to and/or relevant for one or more process model phases and/or one or more disciplines. For example, data structures 3312 of FIGS. 34, 35, 36, 37, and 38 relate to at least an envisioning phase, and data structures 3312 of FIGS. 39, 40, and 41 relate to at least a planning phase. Also, data structure 3312 of FIG. 42 relates to at least a deploying phase. Additionally, data structures 3312 of FIGS. 34-42 are relevant to at least a risk management discipline, and data structure 3312 of FIG. 40 is also relevant to a readiness management discipline.

For each data structure 3312(a-i) of each of FIGS. 34-42, respectively, the data structure 3312 thereof is first introduced and described. Fields of each data structure 3312 are then identified and described.

FIG. 34 is an example milestone review data structure 3312(a). The Milestone Review data structure 3312(a) summarizes the observations and findings of the project's Milestone Review. This process is undertaken at transition points throughout the project to ensure quality and make appropriate adjustments. A Milestone Review allows the project team to assess two aspects of the project: how it is being conducted and the quality of the project's output. It provides an opportunity to learn from the project work that has transpired to date and to use that learning to improve the project.

Generally, the Milestone Review process examines the current project status, identifies what has been successful to that point, pinpoints any problems or quality issues, determines the lessons learned, and makes specific recommendations on how to proceed.

Milestone Reviews can occur at each point where the team and the customer are to jointly agree to proceed, thus signaling a transition from one phase into the next. These points are typically identified as Major Milestones. Additionally, doing reviews at interim and internal milestones serve as checkpoints for the project teams. The Project Post-Mortem, the final milestone review, rolls up a full assessment at the project's conclusion.

Summary 3402

The Summary field presents the key elements in a brief paragraph and describes the method(s) used to conduct the Milestone Review (e.g., meetings, conference calls, surveys, etc.).

Status of Milestone Deliverables 3404

The Status of Milestone Deliverables field lists the deliverables that should be complete at the point of the Milestone Review and identifies their status. If it is for a project's first Milestone Review, substantially all deliverables to that point are usually listed. If it is for a subsequent Milestone Review, substantially all deliverables created since the last review are usually listed. Example status conditions include “complete,” “in progress,” “deleted,” and so forth. For deliverables still in progress, a more granular metric that describes either “percent complete” or the sub-deliverables that are complete is useful.

Justification: This communication enables the customer, the project team, and other stakeholders to make informed decisions about the project and other related activities.

Summary of Actuals versus Planned 3406

The Summary of Actuals versus Planned field documents for each deliverable the estimated time and resources and the actual time and resources used to date. This field also shows the calculated differences between the estimates and the actuals.

Justification: These comparisons identify potential problems as well as those areas that may be ahead of schedule and enable the project team to adjust the project plan. This data is also valuable to help quantify assessments on equivalent tasks later in the project or when bidding on similar projects in the future.

Ratings by Category 3408

The Ratings by Category field reports the quantitative measurements taken on the important dimensions (categories) of the project. Both the project team and the customer can provide these ratings. A category rating is an indication of two factors: (1) Assessment—how well a category is working for the project. (2) Impact—the importance and effect the category will have on the project's success/failure.

The categories include project processes (e.g., risk management, communication, quality assurance, etc.), technical documentation, technical processes (e.g., interface development, testing, etc.), project structure, project documentation (e.g., project plans, progress reports, etc.), methods and tools, and product.

Each indicatior (e.g., assessment and impact) has a ratings scale. The ratings for each indicator are multiplied to determine each category's overall rating.

By way of example only:

| | |
|---|---|
| Assessment: | 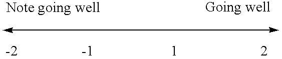 |
| Impact: | 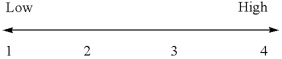 |

| Category | Assessment | Impact | Rating (A*I) |
|---|---|---|---|
| Risk Management Process | 1 | 3 | 3 |
| Communication Process | −2 | 3 | −6 |
| Interface Development | 1 | 2 | 2 |
| Quality Assurance Process | 2 | 1 | 2 |

Justification: The team evaluates these category ratings to determine source causes and to make improvement recommendations. This information also provides input to the ongoing risk management process. Categories with low ratings tend to have associated risks needing identification.

Lessons Learned 3410

The Lessons Learned field identifies three main items: (1) Things that are working well and should continue as elements of the project. (2) Things that need changing, either because they are not working or could be improved. (3) Things that should not be repeated or should be discontinued.

This field is developed by examining the Deliverables' status, Planned versus Actuals comparison, and Category ratings and then determining:
Why were we successful? What contributed to that success?
Could we improve on that success as we continue with the project?
What risks did we successfully manage? How?
Why was there a problem? What went wrong?
What were the signs that should have warned us? Are there new risk factors we should identify for future projects?
What should we have done differently?

Review of IP Used and Generated 3412

The Review of IP Used and Generated field lists the existing intellectual property leveraged to create the customer's solution and any new intellectual property that may have future value to this and other projects.

Justification: This information may be useful to other projects and should be shared with internal staff and external partners.

Readiness for Next Milestone 3414

The Readiness for Next Milestone field describes how well the project is positioned to achieve the next milestone. By analyzing the Deliverables' status, Planned versus Actuals comparisons, Category ratings, and Lessons learned, the team can assess how much adjustment needs to be made to the project in order to reach the next milestone.

Examples of this assessment include:

If the current deliverables are late, can resource adjustments be made to meet deadlines?

If the project processes (e.g., communication, change management, etc.) are not working effectively, can they be amended in time to facilitate efficiencies?

Justification: This information ensures that the project team identifies the necessary success factors and actions required to achieve the next milestone.

Recommendations and Actions Items 3416

The Recommendations and Actions Items field makes specific recommendations (derived from the lessons learned section) on how the project should be adjusted. These recommendations are prioritized based on their relative value to achieving the project's goals. The recommendations should focus at least primarily on high priority issues and be connected to the rated categories.

Recommendations may include alternative methods for performing work, best practices to apply to project protocols (e.g., risk management, communication, etc.), adjustments to project plans and structure, feature trade-offs, and so on.

Justification: Action items are derived from the recommendations; they identify the specific individual/group responsible for taking the action and the time target for completing the action. Action items are generally those things that have the greatest positive impact on the project. One of the action items should usually be to update the risks and issues document with new or changed items that fall out of the milestone review process.

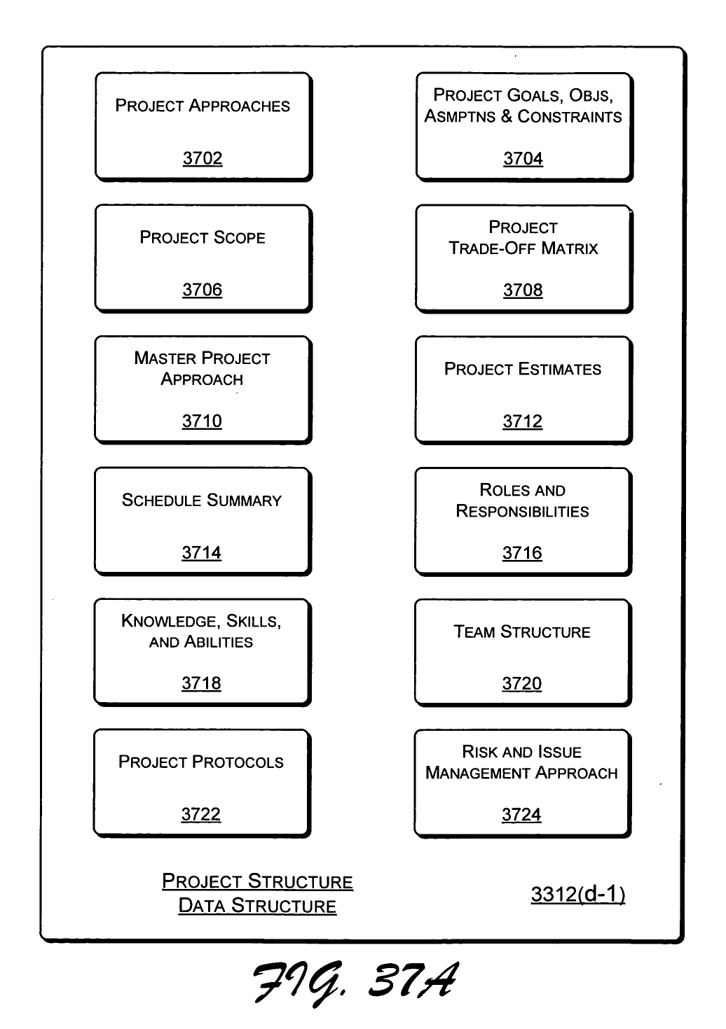

FIG. 35 is an example team lead project progress data structure 3312(b). The Team Lead Project Progress data structure 3312(b) summarizes a team's progress on a project, including variance and impact on project delivery (e.g., schedule, cost, and scope). Depending on the project's communication plan, it may be advisable to prepare and distribute this report relatively frequently (e.g., weekly).

Justification: This report communicates project status, progress, and important issues to the Project Manager, Project Sponsor, and/or Stakeholders. For example, if you are the Team Lead on a large project, your status information will likely go to the Project Manager. If you are the Project Manager, your status information will likely go to your Project Sponsor or others.

Activity Summary 3502

This field summarizes the work completed by the team for the reporting period. Justification: This section highlights (i.e., exhaustive detail should usually be avoided regarding) work completed.

By way of example only: The following is a brief summary of the major team activities and accomplishments for the week:
Activity 1
Activity 2
Activity 3

Open Action Items 3504

This field summarizes “open” action items that are scheduled for completion within the reporting period. Justification: This field ensures tracking and reporting of items that have not been completed.

By way of example only: The following is a summary of the action items that are open at the time of this report:
Action Item 1
Action Item 2
Action Item 3

Issues and Opportunities 3506

This field lists issues that affect the project and highlights project-related opportunities. Justification: The Issues and Opportunities field addresses open action items and communicates project variances or impact on project delivery. Whether or not a variance creates an impact depends on project priorities and expectations.

Issues for Escalation are highly likely to impact schedule or quality: events happening now or in the immediate future that will likely jeopardize the project. Note: Schedule variance on tasks not on the Critical Path may not pose a problem as long as extra time is not exhausted on those tasks.

The following are the top issues that usually affect the completion of the team's assignments. They are listed in order, starting with the item that has the greatest possible impact on the relevant work:
Issues for Escalation (also referred to as Red or High)
Potential Issues (also referred to as Yellow or Medium)

The following are opportunities to enhance the project's efforts:
Opportunities (also referred to as Green)

Team Project Schedule Update 3508

The Team Project Schedule Update field provides a detailed report of changes to schedule status. Justification: This field updates the status of tasks, or work packages, being performed by sub-teams or individuals on a project (e.g., development team, test team, etc.). These generally become part of the master project schedule.

To improve efficiency, task names are entered as they appear on the master schedule. If you are using a link-aware and capable application or other tool to track tasks, a link to those files may be inserted.

By way of example only, the following is a list of the work packages (or tasks) my team worked on in the last week:

| | | | | |
|---|---|---|---|---|
| Work packages | | | Estimated | Estimated |
| assigned | | Hours | hours | completion |
| this week | Complete? | worked | remaining | date |

I have updated the project schedule for all activities in the above work packages or tasks:
□ Yes
□ No

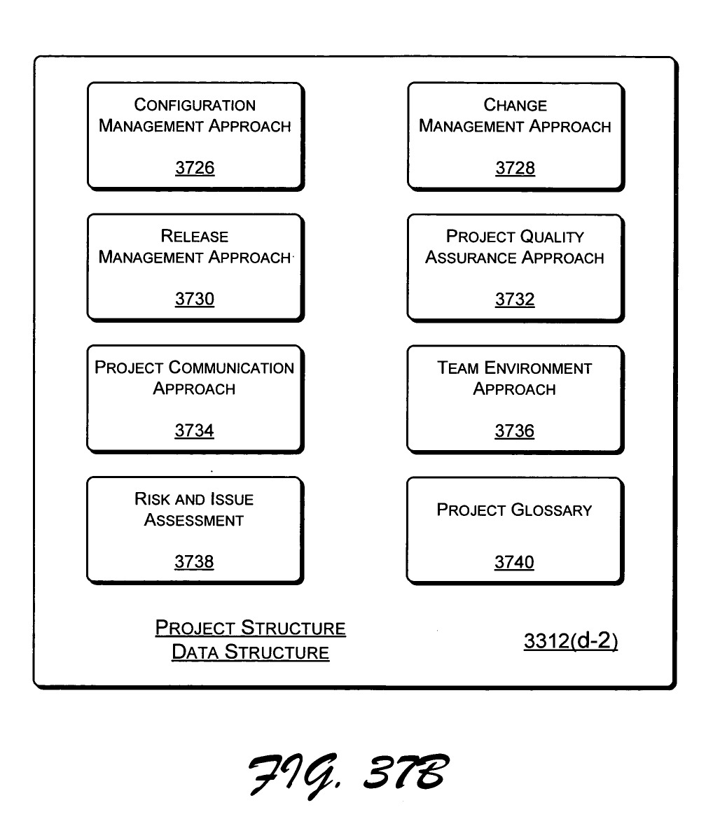

FIG. 36 is an example vision/scope data structure 3312(c). The Vision/Scope data structure 3312(c) represents the ideas and decisions developed during the envisioning phase. A goal of the phase, represented by the content of the description, is to achieve team and customer agreement on the desired solution and overall project direction.

The Vision/Scope data structure 3312(c) is organized into four main fields:
Business Opportunity 3602: a description of the customer's situation and needs
Solutions Concept 3610: the approach the project team will take to meet the customer's needs
Scope 3622: the boundary of the solution defined though the range of features and functions, what is out of scope, a release strategy, and the criteria by which the solution will be accepted by users and operations
Solution Design Strategies 3634: the architectural and technical designs used to create the customer's solution

Justification: The Vision/Scope data structure 3312(c) is usually written at the strategic level of detail and is used during the planning phase as the context for developing more detailed technical specifications and project management plans. It provides clear direction for the project team; outlines explicit, up-front discussion of project goals, priorities, and constraints; and sets customer expectations.

Team Role Primary: Product Management is the key driver of the envisioning phase and is responsible for facilitating the team to the Vision/Scope approved milestone. Product Management defines the customer needs and business opportunity or problem addressed by the solution.

Team Role Secondary: Program Management is responsible for articulating the Solution Concept, Goals, Objectives, Assumptions, Constraints, Scope, and Solution Design Strategies sections of this data structure.

Business Opportunity 3602

The Business Opportunity field contains the statement of the customer's situation. It is expressed in business language, instead of technical terms. This field usually demonstrates the solution provider's understanding of the customer's current environment and its desired future state. This information is the overall context for the project.

Opportunity Statement 3604

The Opportunity Statement subfield describes the customer's current situation that creates the need for the project. It may contain a statement of the customer's opportunity and the impact of capitalizing on that opportunity (e.g., product innovation, revenue enhancement, cost avoidance, operational streamlining, leveraging knowledge, etc.). It may contain a statement of the customer's problem and the impact of solving the problem (e.g., revenue protection, cost reduction, regulatory compliance, alignment of strategy and technology, etc.). It usually also includes a statement that connects the customer's opportunity/problem to the relevant business strategy and drivers. The Opportunity Statement is written concisely using a business executive's voice.

Justification: The Opportunity Statement subfield demonstrates that the solution provider understands the customer's situation from the business point of view and provides the project team and other readers with the strategic context for the remaining (sub)fields.

Vision Statement 3606

The Vision Statement subfield clearly and concisely describes the future desired state of the customer's environment once the project is complete. This can be a restatement of the opportunity; however, it is written as if the future state has already been achieved. This statement provides a context for decision-making. It should be motivational to the project team and the customer.

Justification: A shared Vision Statement among all team members helps ensure that the solution meets the intended goals. A solid vision builds trust and cohesion among team members, clarifies perspective, improves focus, and facilitates decision-making.

Benefits Analysis 3608

The Benefits Analysis subfield describes how the customer will derive value from the proposed solution. It connects the business goals and objectives to the specific performance expectations realized from the project. These performance expectations are generally expressed numerically. This section can be presented using the following entries:
Business Goals and Objectives
Business Metrics
Business Assumptions and Constraints
Benefits Statement

Justification: The Benefits Analysis subfield demonstrates that the solution provider sufficiently understands the customer's situation. It also defines the customer's business needs, which may provide vital information for making solution/technology recommendations.

Solutions Concept 3610

A Solutions Concept field provides a general description of the technical approach the project team will take to meet the customer's needs. This includes an understanding of the users and their needs, the solution's features and functions, acceptance criteria, and the architectural and technical design approaches.

Justification: The Solutions Concept field provides teams with limited but sufficient detail to prove the solution to be complete and correct; to perform several types of analyses including feasibility studies, risk analysis, usability studies, and performance analysis; and to communicate the proposed solution to the customer and other key stakeholders.

Goals, Objectives, Assumptions, and Constraints 3612

The Goals, Objectives, Assumptions, and Constraints subfield contains the following components that define the product's parameters:
Goals (the product's final purpose or aim)
Objectives (the goals broken into measurable components)
Assumptions (factors considered true, real, or certain that are awaiting validation)
Constraints (a nonfunctional requirement that might limit the product)

The Goals and Objectives are initially derived from the business and technical goals and objectives that are developed during the opportunity phase and confirmed during the envisioning phase. The Assumptions and Constraints may be derived from the product's functionality, as well as research regarding the customer's environment.

Justification: The Goals and Objectives articulate both the customer's and the team's expectations of the solution and can be converted into performance measurements. The Assumptions attempt to create explicit information from implicit issues and to point out where factual data is unavailable, and the Constraints place limits on the creation of boundaries and decision-making.

Usage Analysis 3614

The Usage Analysis subfield lists and defines the solution's users and their important characteristics. It also describes how the users will interact with the solution. This information forms the basis for developing requirements.

User Profiles 3616

The User Profile subfield describes the proposed solution's users and their important characteristics. The users are identified in groups, which are usually stated in terms of their functional areas. Users are often from both the IT (e.g., help desk, database administration, etc.) and the business (e.g., accounting, warehouse, procurement, etc.) areas of the customer's organization. The important characteristics identify what the users are doing that the solution will facilitate. These characteristics can be expressed in terms of activities: for example, the accounting user receives invoices and makes payments to suppliers.

This subfield generally includes a level of user profile information that enables the identification of unique requirements.

Justification: Initially, the User Profiles subfield enables the development of usage scenarios (next section). Beyond that, User Profiles provide the project teams with vital requirements information. A complete set of User Profiles ensures that all high-level requirements can be identified. The product team uses these profiles as input when developing the Feature/Function List. The development team uses these profiles as input to its architecture and technology design strategies. The user education team uses these profiles to establish the breadth of their work.

Usage Scenarios 3618

The Usage Scenarios subfield defines the sequences of activities the users perform within the proposed solutions environment. This information is comprised of a set of key events that will occur within the users' environment. These events should be described by their objectives, key activities and their sequences, and the expected results.

Justification: The Usage Scenarios subfield provides vital information to identify and define the solution's user and organizational requirements, the look and feel of user interfaces, and the performance users expect of the solution.

Requirements 3620

The Requirements subfield identifies what the solution “must” do. These Requirements can be expressed in terms of functionality (for example, a registration Web site solution will allow the users to register for events, arrange for lodging, etc.) as well as the rules or parameters that apply to that functionality (for example, the user can only register once, and must stay in lodging approved by the travel department). Requirements can exist at both the user level and the organizational level.

Justification: User and Organizational Requirements are the key input to developing product scope and design strategies. Requirements are the bridge between the usage analysis and solution description. A complete statement of Requirements demonstrates that the solution provider understands its customer's needs. The statement also becomes the baseline for more detailed technical documentation in the planning phase. Good Requirements analysis lowers the risk of downstream surprises.

By way of example only, example Requirements include:
Business Requirements
User Requirements
Operational Requirements
System Requirements.

Scope 3622

The Scope field places a boundary around the solution by detailing the range of features and functions, by defining what is out of scope, and by discussing the criteria by which the solution will be accepted by users and operations. The Scope clearly delineates what stakeholders expect the solution to do, thus making it a basis for defining project scope and for performing many types of project and operations planning.

Feature/Function List 3624

The Feature/Function List subfield contains an expression of the solution stated in terms of Features and Functions. It identifies and defines the components required to satisfy the customer's requirements.

Justification: The Feature/Function List enables the customer and project team to understand what the project will develop and deliver into the customer's environment. It is also the input to the Architectural and Technical Design Strategies.

Out of Scope 3626

The Out of Scope subfield lists and defines a limited set of features and functions excluded from a product or solution—that is, the features and functions that fall outside its boundaries. It does not usually list everything that is Out of Scope; it generally lists and defines features and functions that some users and other stakeholders might typically associate with a type of solution or product.

Justification: Out of Scope delineation helps to clarify the solution scope and can explicitly state what will not be delivered in the solution.

Version Release Strategy 3628

The Version Release Strategy subfield describes the strategy by which the project will deliver incremental sets of features and functions of the customer's solution in a series of releases that build upon each other to completion.

Justification: The Version Release Strategy enables the customer to plan for the orderly implementation of the solution, including the acquisition of the required infrastructure to support the solution. It also describes how the solution provider will provide the customer with a usable set of functions and features as soon as possible.

Acceptance Criteria 3630

The Acceptance Criteria subfield defines the metrics that are to be met in order for the customer to understand that the solution meets its requirements. Justification: Acceptance Criteria communicate to the project team the terms and conditions under which the customer will accept the solution.

Operational Criteria 3632

The Operational Criteria subfield defines the conditions and circumstances by which the customer's operations team judges the solution ready to deploy into the production environment. Once deployed, the customer takes ownership of the solution. This section may specify the customer's requirements for installing the solution, training operators, diagnosing and managing incidents, and so on.

Justification: Operational Criteria communicate to the project team the terms and conditions under which the customer will allow deployment and ultimately sign off on the project. This information provides a framework for planning the solution's deployment.

Solution Design Strategies 3634

The Solution Design Strategies field has two subfields.

Architectural Design Strategy 3636

The Architectural Design Strategy subfield describes how the features and functions will operate together to form the solution. It identifies the specific components of the solution and their relationships. A diagram illustrating these components and relationships is an excellent communication device.

Justification: The Architectural Design Strategy converts the list of features and functions into the description of a fully functional, integrated environment. This information enables the customer to visualize the solution in its environment. It may drive the selection of specific technologies. The Architectural Design Strategy is a key input to the design specification.

Technical Design Strategy 3638

The Technical Design Strategy subfield documents the application of specific technologies to the Architectural Design. It is a high-level description of the key products and technologies to be used in developing the solution.

Justification: A Technical Design Strategy identifies the specific technologies (e.g., proprietary technologies) that will be applied to the solution and demonstrates their benefits to the client.

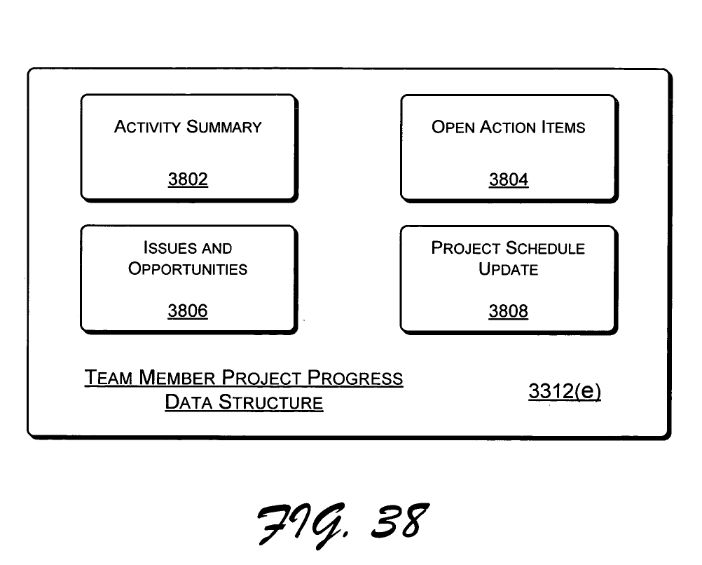

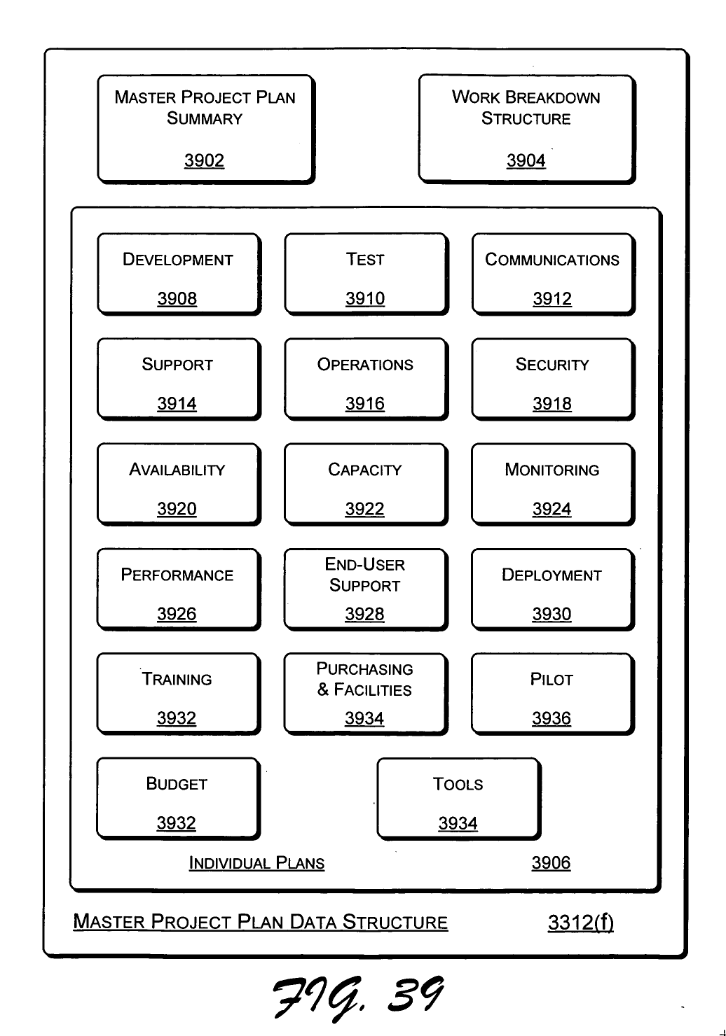

FIGS. 37A and 37B are together an example project structure data structure 3312(d-1) and 3312(d-2), respectively. Project Structure data structure 3312(d) defines the approach the team is to take in organizing and managing the project. It is the strategic representation of initial decisions made regarding goals, work scope, team requirements, team processes, and risk.

Justification: The Project Structure baseline is created during the envisioning phase and is utilized and revised throughout the remaining phases, serving as an essential reference for the project team on how they will work together successfully.

Team Role Primary: The Program Management role is responsible for facilitating the creation of the baseline with input from other core team members.

Project Approaches 3702

The Project Approaches field defines how the team will manage and support the project. It provides descriptions of project scope, approaches, and project processes.

Project Goals, Objectives, Assumptions, and Constraints 3704

The Project Goals, Objectives, Assumptions, and Constraints field describes the project environment:
Goals (the project's final purpose or aim)
Objectives (the goals broken into measurable components)
Assumptions (factors considered true, real, or certain, and that await validation)
Constraints (a non-functional requirement that will limit the project team's options).

Project Goals and Objectives are initially derived from the business goals and objectives that are developed during the opportunity phase and confirmed during the envisioning phase. Assumptions and Constraints may be derived from strategic services (Rapid Portfolio Alignment, Rapid Economic Justification) and research regarding the customer's environment.

Justification: Project Goals and Objectives articulate the customer's and team's expectations of the project and can be converted into performance measurements. Project Assumptions attempt to create explicit information from implicit issues and to point out where factual data is unavailable. Project Constraints place limits on the creation of boundaries and decision-making.

Project Scope 3706

The Project Scope field defines the tasks, deliverables, resources, and schedule necessary to deliver the customer's solution. The tasks are expressed in the Master Project Approach, the Milestone Approach, the Project Estimates, and the Project Schedule. These multiple views allow the customer and project team to look at the project from different perspectives and to analyze how the work is organized.

Justification: The tasks, deliverables, resources, and schedule exist at a high level of detail. These Project Scope statements provide the context for more detailed planning during follow-on project phases.

Project Trade-off Matrix 3708

The Project Trade-off Matrix field is a table that represents the customer's preferences in setting priorities among schedule, resources, and features. When using the graphic (e.g., of FIG. 12), the check marks are moved to the appropriate boxes and the (blanks) are filled in within the sentence: Given fixed ______, we will choose a ______, and adjust ______ as necessary.

Justification: The Trade-off Matrix sets the default standard of priorities and provides guidance for making trade-offs throughout the project. These trade-offs should be established up front and then reassessed throughout the project's life.

Master Project Approach 3710

The Master Project Approach field is the roll-up of the project teams' approaches. This includes an overall statement of strategy for the project and individual strategy statements for each team. A strategy statement describes a general approach to accomplish work without associated metrics.

The Master Project Approach also describes how the various project teams will collaborate to build and deploy the customer solution. This creates an awareness of the dependencies among the teams.

This section also typically includes a description of the high-level work tasks to be undertaken by each team. The work can be described in part by identifying what its result or deliverable is to be. This description can also include things such as tools, methodologies, best practices, sequences of events, and so forth.

Justification: The Master Project Approach ensures that each team understands how it will contribute to the project's overall success. In addition, it communicates to the customer that the solutions provider and its partners are working from a well-developed strategy. The Master Project Approach evolves into the Master Project Plan during the planning phase.

The example subfields below describe the project team's approach to building the project work packages:
Development Approach
Test Approach
Training Approach
User Support Approach
Communication Approach
Deployment Approach
Operations Approach
Milestone Approach: The Milestone Approach identifies the significant events in the project's lifespan. During envisioning, these are usually expressed as External Milestones that identify visible accomplishments of high-level deliverables and illustrate the project's schedule targets. At the highest level, External Milestones can be associated with the completion of a specific project phase.
   The Milestone Approach identifies the basis for establishing milestones. Depending on the nature of the project, Milestones can be finance-based, progress-based, product-based, and so on. The Milestone Approach defines this basis and identifies the milestone events that will be tracked.

Justification: Describing Milestones early in the project establishes high-level time targets the customer can confirm and the team can anticipate during its planning activities. It also identifies the checkpoints where Milestone Reviews will occur to assess the project's quality and its results.

Project Estimates 3712

The Project Estimates field contains an estimate of the resources and costs to be used for the project teams to accomplish their work. Resources include people, equipment, facilities, and material. Costs are calculated by applying rates to each type of resource.

This field typically contains the following information, broken out by each functional team:
A list of resource types
The amount of the resource required
The rate applied to each resource
The cost of each resource
Total cost of resources for each functional team
Optionally the cost for all resources summed together.

Justification: Project Estimates provide information for calculating the budget estimate. They also enable the project manager and team leads to identify the specific resources needed to perform the work.

Schedule Summary 3714

The Schedule Summary field identifies and compiles the collective work tasks and their calendar dates into a complete project schedule that identifies its beginning and end dates. Each major Project Milestone is identified and assigned a targeted completion date. The schedule is a consolidated schedule—it includes the work and dates of multiple (up to all) project teams.

The scheduling process is iterative. During the envisioning phase, the project's Major Milestones anchor the schedule. During the planning phase, the schedule will become more granular as the work tasks are broken down.

Justification: The Schedule Summary provides the basis for the customer to verify timelines and for the project team to produce a constrained master plan from which it can validate proposed budgets, resources, and timescales.

Roles and Responsibilities 3716

The Roles and Responsibilities field defines how people will be organized in the project. The assurance of quality resources and structure begins with creating people “requirements” and follows with organizing those people into teams and allocating responsibility. Clear statements of skill requirements and roles and responsibilities enable the project manager to select the right people and communicate to them how they will contribute to the project's success.

Knowledge, Skills, and Abilities 3718

The Knowledge, Skills, and Abilities (KSA) field specifies the requirements for project participants. This is expressed by defining the knowledge, skills, and abilities needed to conduct the project. These requirements should include technical, managerial, and support capabilities. This information is organized into functional teams and responsibilities. At the highest level, the KSA can be based on the standard SF roles. Each functional team, or SF role, is listed, and the team's knowledge, skills, and abilities requirements are defined alongside each entry in the listing.

Justification: Knowledge, Skills, and Abilities information facilitates the careful selection of specific project participants and provides the basis for creating the core team structure.

Team Structure 3720

The Team Structure field defines the project's organizational entities (e.g., project manager, sponsor(s), steering committee, team leads, etc.), illustrates their relationships to one another, and defines levels of responsibility and reporting structure. When complete, the team structure assigns names to each organizational entity and explicitly calls out the individual team (or team members) tasked with executing, reviewing, and approving the project's work. This assignment is usually spread across all entities participating in the project: the solution provider, partners thereof, and the customer.

Justification: The documentation of the project's organizational structure ensures that all project participants understand their roles in making the project a success, clarifies lines of reporting and decision-making, and provides key stakeholders an opportunity to ensure that the project's organizational structure (project form) will facilitate the work (project function).

Project Protocols 3722

The Project Protocols field is the set of project processes that is standardized to ensure that project participants are performing the processes in the same manner. This standardization creates performance efficiencies and facilitates a common language among the project stakeholders.

Risk and Issue Management Approach 3724

The Risk and Issue Management Approach field describes the processes, methods, and tools to be used to manage the project's risks and issues. It is sufficiently detailed to facilitate the risk and issue management process during the envisioning and planning phases. It also makes it possible to categorize issues as product issues or project issues.

This field may also include the following:
Description of risk and issue management processes, methods, and tools
Schedule/frequency of risk and issue management activities
Roles and responsibilities within the risk and issue management process
Specifications of the risk/issue assessment form and the issues resolution form.

Justification: The Risk and Issue Management documentation field ensures that project participants understand their responsibilities in identifying and managing risks and issues and that all project personnel are using the same risk and issue management processes.

Configuration Management Approach 3726

The Configuration Management Approach field defines how the project's deliverables (e.g., hardware, software, management and technical documents, and work in progress) will be tracked, accounted for, and maintained. Configuration Management includes project documents, the development and test environments, and any impact on the production environment.

This section may include the following:
Description of configuration management processes, methods, and tools
Processes to request configuration changes (steps, approval levels)
Roles and responsibilities for configuration management
Version-control standards for documents.

Justification: The Configuration Management documentation field ensures that the project can maintain object and document integrity so that a single version is used.

Change Management Approach 3728

The Change Management Approach field describes how the project's scope will be maintained through structured procedures for submitting, approving, implementing, and reviewing change requests. The change management process is responsible for providing prompt and efficient handling of any request for change.

This section may include the following:
Change management processes, methods, and tools
Composition of the Change AdvisoryBoard
Change request form
Roles and responsibilities of change management activities
Reference to the contractual change order from the Customer Contracting Approach section.

Justification: Documenting the Change Management Approach in this field helps the project maintain a timely single perspective of the project's scope (both project activities and products produced) and ensure that only contracted work is undertaken.

Release Management Approach 3730

The Release Management Approach field describes the processes, methods, and tools that coordinate and manage releases of the solution to the different test and production environments. It describes the processes of coordinating and managing the activities by which releases to the production IT environment are planned, tested, and implemented.

This field includes the transition plan (release to production) and plans for back-out processes. The approach can be made to be compliant with the OF Release Management Process.

Justification: This information ensures that the project plans for and follows an orderly process of solution test and implementation, thus limiting the impact on the customer's operational environment and ensuring that environment is operationally ready to receive the release.

Project Quality Assurance Approach 3732

The Project Quality Assurance Approach field defines how the project intends to deliver products that meet the customer's quality expectations and the quality standards of the solutions provider and partners thereof. It addresses both the project's management and the development of the project's product.

This section may include the following:
Quality expectations
Process for assurance (e.g., audit, reviews, contractor controls)
Process for control (e.g., peer reviews, inspections, tests)
Quality organization (e.g., entities, roles, and responsibilities)
Templates for the Product Review, Project Milestone Review, and Customer Approval reports
Training requirements.

Justification: A well-developed Product Quality Assurance Approach is key to managing customer confidence and ensuring the development and deployment of a golden solution.

Project Communication Approach 3734

The Project Communication Approach field defines how and what the project will communicate with its stakeholders. This communication occurs within the team and between the team and external entities. The Project Communication Approach identifies the processes, methods, and tools required to ensure timely and appropriate collection, distribution, and management of project information for all project stakeholders. It also describes the team's strategy for communicating internally among team members and company personnel, as well as externally with vendors and contractors.

This section may include the following:
Project Stakeholders and their communication requirements
Types of communications (e.g., progress reports, change management requests, configuration management documentation, release management documentation, risks and issues, financial reports, project plans, technical specifications, etc.) and their standard configurations and media
Communication type owners
Project organization/distribution lists
Communication infrastructure requirements (e.g., tools, internal and external tracking systems, etc.)

The progress report is an important document that should be detailed in this field. It describes how to collect and distribute the non-financial metrics and qualitative information that pertain to project progress, team performance, schedule slippage, risks, and issues that impact the project. The progress report should summarize completed work, report on milestones, and highlight new risks.

The Project Communication Approach field should be organized into two sections: communication within the project and user communication. The user communication subfield includes the processes, methods, and tools that will explain the solution to the customer and user communities to ensure rapid and trouble-free adoption of the solution. This identifies the key points along the project cycle where the solution will be presented to the users and provides a description of what is presented (e.g., user requirements, functional specifications, prototypes, etc.). This subfield identifies responsibilities for creating and delivering the user communication and identifies a process for collecting user feedback for incorporation into technical documents as well as the solution.

Justification: A well-developed Project Communication Approach ensures that information is available to users in a timely manner to facilitate decision-making. It sets the expectations with the customer and the project teams that information will be distributed in a standardized fashion and on a regular basis.

Team Environment Approach 3736

The Team Environment Approach field defines the approach for creating the project team environment. It defines the physical environment requirements needed to conduct the project and the plan to establish that environment. Environmental elements include at least floor space (e.g., offices, meeting rooms, etc.) and equipment (e.g., computers, desks, chairs, telephones, etc.). These requirements also define the location of the environmental elements and their proximity to each other. It also describes tools, systems, and infrastructure to be used by the team, such as version-control software, developer tools and kit, test tools and kit, and so forth.

In addition to requirements, this section can establish infrastructure staging and the roles and responsibilities for environment setup. If appropriate, the requirements can be identified by team role (e.g., development, logistics, testing, user education, etc.).

Justification: The Team Environment Approach ensures that the working environment is readily available in the timeframes set by the project schedule.

Risk and Issue Assessment 3738

The Risk and Issue Assessment field identifies and quantifies the risks and issues that have become apparent through the envisioning phase. This field is developed early in the phase and is updated as more information is gathered. At the close of the envisioning phase, this field contains any risks and issues that are known to exist at that point in time.

The field may include the following:
Risk Identification/Statements: a list of project risks and the conditions and consequences of each of the risks
Risk Analysis: the objective assessment of any risk's significance; the calculation of risk exposure by assessing probability and impact for each item on the list of risks
Risk Plan: the actions that will prevent and minimize risks and provide a course of action if risks occur
Risk Priorities: the top “x” risks the project should focus on.

Justification: Early identification of risk enables the team to begin managing those risks.

Project Glossary 3740

The Project Glossary field defines the meaning and usage of the terms, phrases, and acronyms found in the documents used and developed throughout the opportunity, solution development, implementation, and operations management phases of product or solution development.

Justification: The Project Glossary helps to ensure good communication and understanding by providing knowledge, understanding, and common usage for terms, phrases, and acronyms.

FIG. 38 is an example team member project progress data structure 3312(e). The Team Member Progress data structure 3312(e) summarizes weekly accomplishments and highlights concerns and issues that may affect the project. The Team Lead uses such information to analyze the project and report its progress to the Project Manager, Project Sponsor, or Stakeholders, as appropriate.

Justification: The Team Member Progress data structure 3312(e) communicates project status, progress, and important issues to the Team Lead.

Activity Summary 3802

The Activity Summary field presents the work completed during the reporting period. Justification: The Activity Summary highlights (i.e., exhaustive detail is to be avoided regarding) work completed.

By way of example only, the following is a brief summary of the major activities and accomplishments for the week:
Activity 1
Activity 2
Activity 3

Open Action Items 3804

The Open Action Items field summarizes “open” action items scheduled for completion within a given reporting period. Justification: Open Action Items ensures tracking and reporting of items not yet completed.

By way of example only, the following is a summary of the action items that are open at the time of this report:
Action Item 1
Action Item 2
Action Item 3

Issues and Opportunities 3806

The Issues and Opportunities field lists issues that affect the project and highlights project-related opportunities. Justification: Issues and Opportunities address open action items and communicate project variances or impact on project delivery. (Whether or not a variance creates an impact depends on project priorities and expectations.)

Issues for Escalation are highly likely to impact schedule or quality: events happening now or in the immediate future that will likely jeopardize the project. Note: Schedule variance on tasks not on the Critical Path may not pose a problem as long as extra time is not exhausted on those tasks.

The following are the top issues that usually affect the completion of assignments. They are listed in order, starting with the item that has the greatest possible impact on the work:
Issues for Escalation (also referred to as Red or High)
Potential Issues (also referred to as Yellow or Medium).

The following are opportunities to enhance the project's efforts:
Opportunities (also referred to as Green).

Project Schedule Update 3808

The Project Schedule Update field provides a detailed report of changes to schedule status. Justification: The Project Schedule Update field updates the status of tasks being performed by sub-teams or individuals on a project (e.g., development team, test team, etc.). These can become part of the master project schedule.

For greater efficiency, task names are entered as they appear on the master schedule. If a hyperlink aware and/or capable application or some other tool to track tasks is being used, insert a link to those files may be inserted.

By way of example:

The following is a list of the tasks worked on in the last week.

| | | | | |
|---|---|---|---|---|
| | | | Estimated | Estimated |
| Tasks assigned | | Hours | hours | completion |
| this week | Complete? | worked | remaining | date |

I have entered my hours for the week in the time tracking system:
□ Yes
□ No

FIG. 39 is an example master project plan data structure 3312(f). The Master Project Plan data structure 3312(f) is a data structure into which subsidiary plans (e.g., development, test, etc) are synchronized and presented together as a single plan. The data includes qualitative information that is contained in many of the subsidiary plans. The types of subsidiary plans included in this master plan can vary depending on the scope and type of project.

In an exemplary SF, the Master Project Plan is a collection (or “roll up”) of plans developed by the various teams (e.g., Program Management, Development, etc) and not usually an independent plan by itself. It usually also contains summaries of each of the subsidiary plans. However, depending on the size of the project, some subsidiary plans may be entirely rolled into this data structure.

Justification: The benefit of presenting these subsidiary plans as one plan is that it:
Facilitates an understanding of the overall approach to the project
Facilitates reviews and approvals
Helps identify gaps and inconsistencies.

The benefit of having a plan that breaks into smaller plans is that it:
Facilitates concurrent planning by various teams
Clarifies accountability since the teams are each responsible for their own plans.

Team Role Primary: Program Management is accountable for delivering the Master Project Plan by ensuring that all teams have developed and submitted the necessary plans and that those plans are of acceptable quality.

Team Role Secondary: The team roles are responsible for developing the plans for their specific functional responsibilities and reviewing the consolidated Master Project Plan to ensure it is executable.

Master Project Plan Summary 3902

The Master Project Plan Summary field provides a quick overview of the Master Project Plan, including a general description of what subsidiary plans are included. Justification: Some readers may wish to know only the highlights of the plan, and summarizing creates that user view. It also enables the full reader to know the essence of the document before they examine the details.

Work breakdown Structure 3904

The Work breakdown Structure (WBS) field identifies the specific work required to conduct the project, expressed in tasks and deliverables and the relationships among those tasks. The work breakdown structure includes both management and technical activities, and lists work required of any participating entities (e.g., solution provider, partners thereof, and the customer). The work breakdown structure can exist at multiple levels of detail. The WBS can be expressed in graphic form.

Justification: The Work breakdown Structure is the basis for resource, schedule, and budget planning. A quality WBS creates clarity and focus for team members, and provides the detail that is likely to lead to individual work accountability.

Individual Plans 3906

The Individual Plans field includes multiple subfields with a subfield for each individual plan. Example individual plans 3908 -3934 are described below.

Development Plan 3908

The Development Plan subfield provides a summary of the development plan's key elements. This summary typically includes information about the development objectives, overall delivery strategy, and key design goals. Other important aspects of the Development Plan may also be included here based on need (e.g., development standards and guidelines).

Test Plan 3910

The Test Plan subfield provides a summary of the test plan's key elements. This summary typically includes information about the testing objectives, overall test approach, expected test results, and test deliverables. Other important aspects of the Test Plan may also be included here based on need (e.g., key test responsibilities, testing procedures, etc.).

Communications Plan 3912

The Communications Plan subfield provides a summary of the communication plan's key elements. This summary typically includes information about the overall communication objectives, any sensitivities or confidentialities that must be accommodated, and key communication subjects and audiences for both internal and external communications. Other important aspects of the Communication Plan may also be included here based on need.

Solution Provider Support Plan 3914

The Solution Provider Support Plan subfield provides a summary of the support plan's key elements. This summary typically includes information about the support objectives and how those requirements will be satisfied in the operational environment. Other important aspects of the Solution Provider Support Plan may also be included here based on need.

Operations Plan 3916

The Operations Plan subfield provides a summary of the operation plan's key elements. This summary typically includes information about the operational objectives, operations infrastructure, skill requirements, and key operational activities. Other important aspects of the Operational Plan may also be included here based on need.

Security Plan 3918

The Security Plan subfield provides a summary of the security plan's key elements. This summary typically includes information about the security objectives and an overview of management, operational, and technical control processes. Other important aspects of the Security Plan may also be included here based on need.

Availability Plan 3920

The Availability Plan subfield provides a summary of the availability plan's key elements. This summary typically includes information about the availability objectives and goals and an overview of how the hardware and software availability will be maintained. Other important aspects of the Availability Plan may also be included here based on need.

Capacity Plan 3922

The Capacity Plan subfield provides a summary of the capacity plan's key elements. This summary typically includes information about the capacity objectives, users, loads, growth, and monitoring. Other important aspects of the Capacity Plan may also be included here based on need.

Monitoring Plan 3924

The Monitoring Plan subfield provides a summary of the monitoring plan's key elements. This summary typically includes information about the monitoring objectives and the key monitoring processes (e.g., anticipating, detecting, diagnosing, etc). Other important aspects of the Monitoring Plan may also be included here based on need.

Performance Plan 3926

The Performance Plan subfield provides a summary of the performance plan's key elements. This summary typically includes information on the performance requirements and the overall objectives for meeting those requirements as well as the key tools, infrastructure, and methodologies used to maintain performance. Other important aspects of the Performance Plan may also be included here based on need.

End-User Support Plan 3928

The End-User Support Plan subfield provides a summary of the end-user support plan's key elements. This summary typically includes information about the end-user support objectives, the usability requirements, how those requirements will be satisfied in the operational environment, and so forth. Other important aspects of the End-User Support Plan may also be included here based on need.

Deployment Plan 3930

The Deployment Plan subfield provides a summary of the deployment plan's key elements. This summary typically includes information about deployment objectives; the scope, strategy, and schedule for deployment; and the site installation process. Other important aspects of the Deployment Plan may also be included here based on need.

Training Plan 3932

The Training Plan subfield provides a summary of the training plan's key elements. This summary typically includes information about training objectives, the specific training requirements, the training schedule, and the training methods. Other important aspects of the Training Plan may also be included here based on need.

Purchasing & Facilities Plan 3934

The Purchasing & Facilities Plan subfield provides a summary of the purchasing and facilities plan's key elements. This summary typically includes information about the purchasing requirements and the objectives and plans to fulfill those requirements. It also usually includes information about the facilities requirements. Other important aspects of the Purchasing and Facilities Plan may also be included here based on need.

Pilot Plan 3936

The Pilot Plan subfield provides a summary of the pilot plan's key elements. This summary typically includes information about the pilot's scope and success factors, transition plan, and the process used to evaluate the pilot. Other important aspects of the Pilot Plan may also be included here based on need.

Budget Plan 3932

The Budget Plan subfield provides a summary of the budget plan's key elements. This summary typically includes an estimate of the total budget and estimates for each project (or sub-project) required to deliver the solution. This summary can also include a listing of the key cost areas (e.g., hardware, software, etc). Other important aspects of the Budget Plan may also be included here based on need.

Tools 3934

The Tools subfield lists and describes the tools that can assist the project in the detailed planning process. These may include forecasting and budget tracking tools, for example.

FIG. 40 is an example training plan data structure 3312(g). The Training Plan data structure 3312(g) identifies the needs and processes for training the people who will participate in creating the solution. This training can be on a particular software package or development environment or about specific hardware components. This data structure focuses on the project teams (which can include the customer's information technology staff and help desk); it does not generally address the training needs of the end-user or support staff for ongoing operations.

Justification: Training provides team members with the working knowledge and proper tools required to build a successful solution. The analysis performed to develop the Training Plan also establishes the team members' skills baseline and facilitates the mitigation of any technology gaps that become evident. Providing the training as specified in the Training Plan can also jump start the team and increase their satisfaction and productivity.

Team Role Primary: Program Management assesses the project's knowledge and skill requirements and the staff available to identify the training necessary for a successful project. The Development Plan and Functional Specifications contain information that will outline the training requirements for the project.

Team Role Secondary: Development, Test, User Experience, and Release Management provide input into the Training Plan on their team members' knowledge and skills gaps and the form of training most likely to be beneficial for them.

Summary 4002

The Summary field provides an overall summary of the contents of the data structure. Justification: Some readers may want to know only the plan's highlights, and summarizing creates that user view. It also enables the full reader to know the essence of the document before they examine the details.

Objectives 4004

The Objectives field describes the training activities' key objectives in terms of creating sufficient competency in both technical and project management knowledge and skill areas. Justification: Identifying Objectives ensures that the plan's authors have carefully considered the situation and solution and created an appropriate training approach.

Training Requirements 4006

The Training Requirements field defines what the training process is to deliver. It does the following:
Identifies the teams that will require training
Defines their specific knowledge and skill requirements
Establishes the proficiency levels for that knowledge and skill
Identifies the training needed to attain proficiency targets.

Some of the possible team roles are listed below. Teams may be added as required based on the project situation. Justification: Training recommendations are best made from a set of requirements. By initially defining the requirements, the project can select the specific training and methods that match the needs.

Product Management 4008

The Product Management field describes the position and responsibilities of the Product Management role for developing the solution and identifies the knowledge and skills useful for performing that role successfully. Four sets of information may be included in this field:
Description of project responsibilities
Knowledge and skill requirements
Proficiency levels by knowledge and skill area
Training requirements.

This information can be placed in a table. Example proficiency level standards are provided below. They can be used to establish the proficiency levels for the knowledge and skill areas.

Program Management 4010

The Program Management field describes the position and responsibilities of the Program Management role for developing the solution and identifies the knowledge and skills useful for performing that role successfully. Four sets of information may be included in this field:
Description of project responsibilities
Knowledge and skill requirements
Proficiency levels by knowledge and skill area
Training requirements.

This information can be placed in a table. Example proficiency level standards are described below and may be used to establish the proficiency levels for the knowledge and skill areas.

Development 4012

The Development field describes the position and responsibilities of the Development role for developing the solution and identifies the knowledge and skills useful for performing that role successfully. Four sets of information may be included in this field:
Description of project responsibilities
Knowledge and skill requirements
Proficiency levels by knowledge and skill area
Training requirements.

This information can be placed in a table. The proficiency level standards described below can be used for the knowledge and skill areas.

Test 4014

The Test field describes the position and responsibilities of the Test role for developing the solution and identifies the knowledge and skills useful for performing that role successfully. Four sets of information may be included in this section:
Description of project responsibilities
Knowledge and skill requirements
Proficiency levels by knowledge and skill area
Training requirements

This information can be placed in a table. The proficiency level standards described below can be used for the knowledge and skill areas.

User Experience 4016

The User Experience field describes the position and responsibilities of the User Experience role for developing the solution and identifies the knowledge and skills useful for performing that role successfully. Four sets of information may be included in this section:
Description of project responsibilities
Knowledge and skill requirements
Proficiency levels by knowledge and skill area
Training requirements.

This information can be placed in a table. The proficiency level standards described below can be used for the knowledge and skill areas.

Release Management 4018

The Release Management field describes the position and responsibilities of the Release Management role for developing the solution and identifies the knowledge and skills useful for performing that role successfully.

IT Administration 4020

The IT Administration field describes the position and responsibilities of the customer's information technology administration staff for developing the solution and identifies the knowledge and skills useful for performing those responsibilities successfully. The training for this group addresses how to support and administer the solution as well as how to use it. Four sets of information may be included in this section:
Description of project responsibilities
Knowledge and skill requirements
Proficiency levels by knowledge and skill area
Training requirements.

This information can be placed in a table. The proficiency level standards described below can be used for the knowledge and skill areas.

Helpdesk and Support Staff 4022

The Helpdesk and Support Staff field describes the position and responsibilities of the customer's help desk and support staff for developing the solution and identifies the knowledge and skills useful for performing those responsibilities successfully. The Helpdesk and Support Staff are preferably prepared to support the solution during pilot as well as deployment. Four sets of information may also be included in this section:
Description of project responsibilities
Knowledge and skill requirements
Proficiency levels by knowledge and skill area
Training requirements.

This information can be placed in a table. The proficiency level standards described below can be used for the knowledge and skill areas.

Training Schedule 4024

The Training Schedule field provides details about when specific training is desirable (over the life of the project) and the duration of that training. Justification: This information can be placed into the project schedule, and it impacts the overall budget. Some training may need to occur before development tasks can be started for superior results, thus creating task dependencies.

Duration 4026

The Duration field identifies the duration of the training for each training requirement (by team and type of training). Teams and team members may benefit from different intensities of training. This information may be placed in a table.

Delivery 4028

The Delivery field identifies when the various training tasks are to occur over the project's life. Teams and team members may attend training at different times, based on development activities and resource constraints. These training tasks can be organized into training milestones and placed into the project plan.

Training Methods 4030

The Training Methods field describes the manner in which training is to be delivered. The four fields listed below serve as examples and can be added to or subtracted from. The four following fields may alternatively be considered subfields of the Training Methods field.

Justification: Effective training occurs when the method is matched to the audience. By considering alternative methods, the project can make decisions about the appropriateness of training given the project's logistics and existing constraints.

Hands-on Training 4032

The Hands-on Training field or subfield identifies those training preferences that are to be satisfied using hands-on training methods.

Presentation 4034

The Presentation field or subfield identifies those training preferences that are to be satisfied using presentation methods.

Computer or Web-Based Training (CBT/WBT) 4036

The Computer or Web-Based Training field or subfield identifies those training preferences that are to be satisfied using CBT or WBT methods.

Handouts 4038

The Handouts field or subfield identifies those training preferences that are to be satisfied using written materials. Handouts such as reference cards or brochures can provide training or can supplement other kinds of training.

Certification 4040

The Certification field or subfield identifies those training preferences that are to entail certification to demonstrate a specified level of proficiency.

Materials and Resources 4042

The Materials and Resources field identifies what is to be acquired or created in order to deliver the training. Justification: This information may impact the project budget and schedule, depending on whether materials and resources are readily available.

Materials 4044

The Materials field describes overall training materials and how they will be acquired. Existing materials may be purchased, but new materials may be developed. If materials require development, the following is described:
Level of effort required
Who will provide support for the effort
How much time and budget is required
How the completed materials will be shipped.

Resources 4046

The Resources field identifies who is to provide the training for each training event and whether the training exists or requires development. If training is to be developed, the following is described:
Level of effort required
Who will provide support for the effort
How much time and budget is required.

Example Proficiency Levels for Fields described above

This field (not illustrated in FIG. 40) identifies and describes example proficiency levels. These levels can be applied to both the overall team role as well as specific knowledge and skill areas. These levels can be used during self-assessment to allow the organization to develop a skill set gap analysis and define training plans that address deficiencies uncovered in that gap analysis. The five exemplary levels (0-4) are:
Level 0: No Exposure.

Have no exposure or experience with the relevant technologies or products
Level 1: Familiar.

Have read through and understand available materials.

Have attended relevant presentations, technical briefings, first-look training, or similar sessions.

Have a strong understanding of fundamental networking and data communication principles and technologies.

Lacks significant hands-on experience with the product or technology.

Lacks participation in large projects using relevant technologies or products.
Level 2: Intermediate.

Have reached a Level 1 competency rating.

Have attended or completed hands-on training with labs.

Have participated in at least one large (e.g., 500 desktop and multiple server) project in relevant technology.

Have passed at least one certification exam for the relevant technology or product.

Lacks significant enterprise-level project leadership.

Lacks significant hands-on experience in real-world situations, with the relevant technology or product.
Level 3: Experienced.

Have reached a Level 2 competency rating.

Have hands-on experience with the relevant products and technologies.

Have completed a successful enterprise-level project or pilot with the relevant technologies or products.

Have led a successful enterprise-level project in any technology.

Have reached a higher certification level status.

Lacks significant experience leading successful enterprise-level projects and/or pilots with the relevant technologies or products.

Lacks significant architecture experience with the relevant technologies or products.
Level 4: Expert.

Have reached a Level 3 competency rating.

Have independently led and completed several enterprise-level projects and/or pilots with the relevant technology or product.

Have written or collaborated on technical documents as a subject matter expert on the relevant technologies or products.

Have standing as the technical specialist for the relevant technologies or products.

Have architected and implemented complex solutions using the relevant technologies or products.

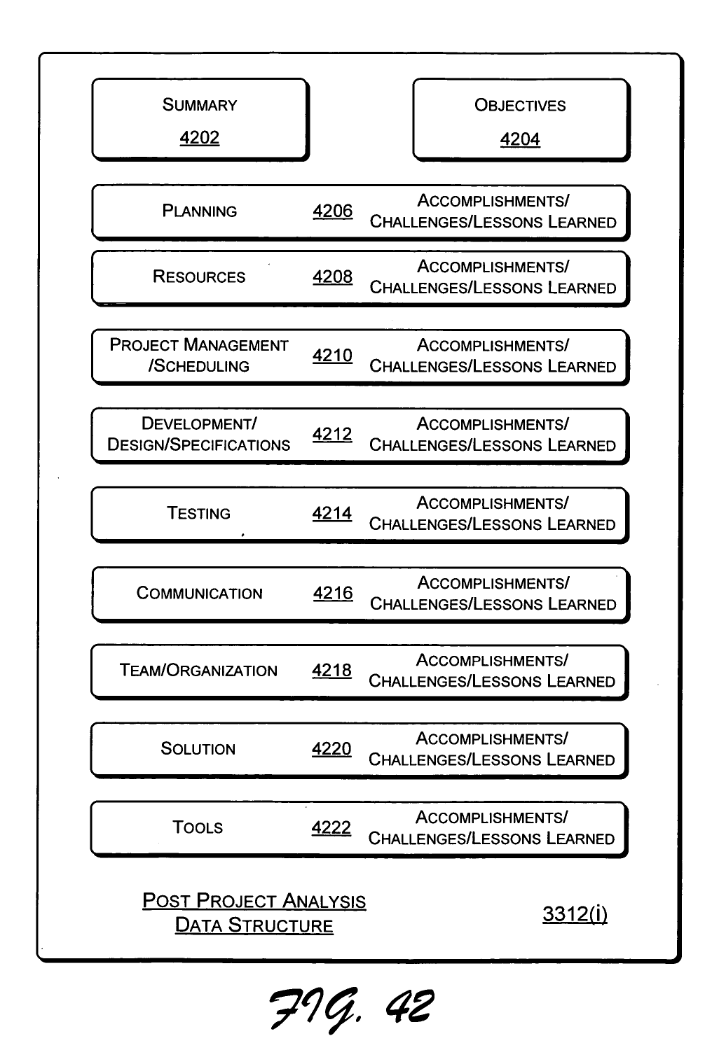

FIG. 41 is an example functional specification data structure 3312(h). The Functional Specification data structure 3312(h) is the repository for the set of relatively deep, technical drill-down information that details much if not all of the elements of the solution deliverables, explaining in relatively exact and specific terms what the team is building and deploying. The Functional Specification is intended to be the final technical document against which development team members build.

The Functional Specification is built upon the foundation of 8 separate documents, which are summarized in the Functional Specification. At least two options are contemplated: (1) Providing customers with 9 deliverables (4 requirements deliverables, 1 Usage Scenarios deliverable, 3 design deliverables, plus the parent Functional Specification deliverable) and (2) Providing customers with a combination of the requirements deliverables, usage scenarios deliverable, and design deliverables into a single Functional Specification with sub-topics.

The eight foundational deliverables are:
Usage Scenarios
User Requirements
Business Requirements
Operations Requirements
System Requirements
Conceptual Design
Logical Design
Physical Design.

Justification: The Functional Specification is in essence a contract between the customer and the team, describing from a technical view what the customer expects. The quality of the Functional Specification (completeness and correctness) has a significant impact on the quality of the development activities and all follow on phases.

Team Role Primary: Program Management is responsible for ensuring that the Functional Specification is completed by its estimated completion date. Program Management also ensures that the design elements of the Functional Specification are consistent with the Vision/Scope document and relevant plans from the Master Project Plan and Operational Plan. Development has the primary responsibility for creating the content of the design deliverables within the Functional Specification. Release Management participates with Development both in content creation and review to ensure operational, deployment, migration, interoperability and support needs are addressed within the designs.

Team Role Secondary: Product Management reviews and understands the design deliverables within the Functional Specification in order to convey solution design to parties external to the team and to ensure that product features are represented in the design according to initial project sponsor requirements. Test reviews the Functional Specification to ensure test plans are in place to validate the designs. User Experience reviews the design deliverables to ensure user requirements are met.

Project Vision/Scope Summary 4102

The Project Vision/Scope Summary field provides an overview of the project's vision and scope. This typically includes a summary of the business opportunity, solution concept, and scope sections of the Vision/Scope data structure.

Justification: This information provides important context for the reader. The vision/scope information is the strategic statement of the solution, which can facilitate reader understanding of the Functional Specification details. By including this information, both internal and external project members share a common understanding of the project, thus setting a common set of expectations.

Project History 4104

The Project History field describes the important events and decisions that have been made to date to deliver the project to this point. This history may be associated with the process of understanding the customer's circumstances and business needs or any prior attempts at delivering a similar solution. If this is the first implementation, this section may be omitted.

Justification: Team members (internal and external) should share the same understanding of the project, and this historical information ensures that this can occur. Providing this information closes any gaps or discrepancies in the teams' historical knowledge base.

Functional Specification Executive Summary 4106

The Functional Specification Executive Summary field provides a strategic statement of the contents of the Functional Specification. It identifies which foundational documents (e.g., requirements, usage scenarios, designs) comprise the Functional Specification and provide a brief statement about the content of each. Justification: This information gives the reader a guideline of the structure of this deliverable and the strategic context for reading its detail.

Project Justification and Design Goals 4108

Project Justification and Design Goals field summarizes the requirements deliverables by stating their contents in terms of business, user, and technical needs. These needs justify the project. This field typically also converts those needs into a statement of the solution design goals that guided the development of the design documents.

Justification: This information provides an understanding of the requirements analysis that was completed and further clarification of project goals in addition to those already summarized in the Vision/Scope field above.

Business Requirements Summary 4110

The Business Requirements field provides a summary of the contents of the Business Requirements deliverable. This typically includes a succinct statement of the contents of each of the key fields of the requirements deliverable (e.g., Cost Benefit Analysis, Scalability, etc.) For some projects, it may be appropriate to include the entire contents of the business requirements, if a choice has been made to consolidate all technical documentation into one large central deliverable.

User Requirements Summary 4112

The User Requirements Summary field provides a summary of the contents of the User Requirements deliverable. This typically includes a succinct statement of the contents of each of the key sections of the requirements document (User Experience, Reliability, Accessibility, etc.) For some projects, it may be appropriate to include the entire contents of the user requirements, if a choice has been made to consolidate all technical documentation into one large central deliverable.

System Requirements Summary 4114

The System Requirements Summary field provides a summary of the contents of the System Requirements deliverable. This typically includes a succinct statement of the contents of each of the key sections of the requirements deliverable (Systems and Services Dependencies, Interoperability, etc.) For some projects, it may be appropriate to include the entire contents of the system requirements, if a choice has been made to consolidate all technical documentation into one large central deliverable.

Operations Requirements Summary 4116

The Operations Requirements Summary field provides a summary of the contents of the Business Requirements deliverable. This typically includes a succinct statement of the contents of each of the key sections of the requirements deliverable (Security, Manageability, Supportability, etc.) For some projects, it may be appropriate to include the entire contents of the operations requirements, if a choice has been made to consolidate all technical documentation into one large central deliverable.

Usage Scenarios/Use Case Studies Summary 4118

The Usage Scenarios/Use Case Studies Summary field provides a summary of the contents of the Usage Scenarios deliverable. This typically includes a succinct statement of the contents of each of the key use case fields of the deliverable. For some projects, it may be appropriate to include the entire contents of the usage scenarios, if a choice has been made to consolidate all technical documentation into one large central deliverable.

Feature Cuts and Unsupported Scenarios 4120

The Feature Cuts and Unsupported Scenarios field identifies the requirements that will not be met by this project or release. This typically includes the identification of any requirement (e.g., business, user, system, operational, usage scenario) that cannot be met and an explanation of why it cannot be met. This field may also identify future solution releases that will satisfy these requirements.

Justification: Just as it is important to provide detailed descriptions of what the project will deliver, it is equally important to describe features and scenarios that are being omitted from the project scope. This further clarifies the current project emphasis and deliverables and prevents possible misunderstanding or confusion.

Assumptions and Dependencies 4122

The Assumptions and Dependencies field lists and defines the project-oriented assumptions and dependencies (as opposed to feature dependencies or environmental dependencies) that have been identified through the process of developing the Functional Specification. An example of a dependency is this: a delivery may require advanced skills in various product technologies or business processes. Listing assumptions and dependencies separately facilitates the understanding of each.

Justification: Assumptions typically identify where actual data does not exist and the actions required to verify those assumptions. Dependencies identify any actions that are to be taken to ensure those dependencies are incorporated into the project plans.

Solution Design 4124

The Solution Design field identifies the design deliverable that have been developed and summarizes the overall solution design in a succinct statement. It also typically defines why each of these design deliverables is useful for the project. Justification: This information provides the reader with strategic context for the follow on reading. It explains the differences between the design deliverables and explains how each provides a unique picture of the solution.

Conceptual Design Summary 4126

The Conceptual Design Summary field provides a summary of the contents of the Conceptual Design deliverable. This typically includes a succinct statement of the contents of each of the key fields of the deliverable (e.g., Solution Overview and Solution Architecture, etc.). For some projects, it may be appropriate to include the entire contents of the design deliverable, if a choice has been made to consolidate all technical documentation into one large central deliverable.

Logical Design Summary 4128

The Logical Design Summary field provides a summary of the contents of the Logical Design deliverable. This typically includes a succinct statement of the contents of each of the key fields of the deliverable (e.g., Users, Objects, Attributes, etc.). For some projects, it may be appropriate to include the entire contents of the design deliverable, if a choice has been made to consolidate all technical documentation into a large central deliverable.

Physical Design Summary 4130

The Physical Design Summary field provides a summary of the contents of the Physical Design deliverable. This typically includes a succinct statement of the contents of each of the key fields of the deliverable (e.g., Application, Infrastructure, etc.). For some projects, it may be appropriate to include the entire contents of the design deliverable, if a choice has been made to consolidate all technical documentation into one large central deliverable.

Security Strategy Summary 4132

The Security Strategy Summary field describes the solution security strategy that will influence the design. The following questions can assist in developing this strategy:
What are the principal objectives to providing a secure environment?
What compromises in security are necessary for user convenience, usability, and performance?
What specific security tools and technologies will be implemented within the solution?

The Physical Design deliverable contains the specific security details in a per-feature/per-component format. This strategy field is instead a brief synopsis of a uniform security strategy, along with references to the Security Plan.

Installation/Setup Requirements Summary 4134

The Installation/Setup Requirements Summary field is a summary of the environmental requirements for solution installation. This information may be derived from the Deployment Plan's installation fields. The Physical Design deliverable contains the details on how these requirements will be satisfied.

Un-Installation Requirements Summary 4136

The Un-Installation Requirements Summary field describes how the solution is removed from its environment. This typically includes a definition of what is to be considered prior to removing the solution and what is to be considered in a backup/restore capacity prior to un-installing to insure safe recovery/rebuild at a later time.

Integration Requirements Summary 4138

The Integration Requirements Summary field is a summary of integration and interoperability requirements and the project goals related to these requirements. The Migration Plan may be referenced or summarized here, as it contains integration and interoperability specifications. The Physical Design deliverable contains the details on how integration is to be delivered.

Supportability Summary 4140

The Supportability Summary field is a summary of the supportability requirements and the project goals related to these requirements. The Operations Plan and Support Plan may be referenced or summarized here, as they contain supportability specifications. The Physical Design deliverable contains the details on how supportability is to be delivered.

Legal Requirements Summary 4142

The Legal Requirements Summary field is a summary of any legal requirements to which the project is to adhere. Legal requirements may originate, for example, from the customer's corporate policies or from regulatory agencies governing the customer's industry.

Risk Summary 4144

The Risk Summary field identifies and describes the risks associated with the Functional Specification. This typically includes risks that may impact development and delivery of the solution where the risk source is the content of the Functional Specification. The list of risks should be accompanied by the calculated exposure for each risk. If appropriate, this section may also contain a summary of the mitigation plans for those risks.

References 4146

The References field identifies any internal or external resources that provide supplementary information to the Functional Specification.

FIG. 42 is an example post project analysis data structure 3312(i). The Post Project Analysis data structure 3312(i) records the results of conducting a depth and breadth assessment of the project from its inception (envisioning phase) to completion (deployment phase). This assessment captures successes, challenges and failures, and identifies what should have been done differently on this project and what could be done differently in future projects.

Justification: Conducting and documenting a post project review formalizes the process of learning from past experience. This has value for individuals and the organization as they move forward with new projects. The lessons learned while creating the solution need to be captured and communicated to all participating team members and other parts of the organization. This helps in the creation of future solutions more quickly with less expense and risk.

The following table identifies an example of recommended time frames for a post project review based on various project characteristics:

| Project | 2 Weeks After | 5 Weeks After |
|---|---|---|
| Characteristic | Completion | Completion |
| Scope of project | Small | Large |
| Length of project | Short | Long |
| | (days to 3 months) | (3 months to years) |
| Energy level of team | Low | High |
| members | | |
| Team member time | Some | Total |
| available | (working on other | |
| | projects) | |

Team Role Primary: Program Management is responsible for developing and distributing the Post Project Analysis. Their main responsibility is to facilitate the analysis and encourage information exchanges between the teams and among team members. Program Management also contributes input to the analysis from their experiences in project.

Team Role Secondary: All other roles preferably either contribute to this data structure or review it for completeness. Product Management conducts analysis and provides information regarding the customer's experience and satisfaction with the project and solution. Development conducts analysis and provides information regarding the building of the solution. Test conducts analysis and provides information regarding the quality of the solution. User Experience conducts analysis and provides information regarding user effectiveness. Release Management conducts analysis and provides information regarding the deployment process and the status of ongoing operations.

Summary 4202

The Summary field provides a brief summary of this data structure, including what will be done with the contents, especially the lessons learned. It may be helpful to list the top three accomplishments, top three challenges, and top three valuable lessons learned.

Example questions to answer to develop this field's content are:
What three things (in order of importance) went well?
What three things (in order of importance) need improvement?
What suggestions do we have for improvement?
What other issues need followed up?

Justification: Some readers may wish to know only the highlights of this data structure deliverable, and summarizing creates that user view. It also enables the full reader to know the essence of the deliverable before they examine the details.

Objectives 4204

The Objectives field defines the document's objectives. These may include (1) recording the results of a comprehensive project analysis and (2) ensuring that lessons learned during the project are documented and shared.

Justification: A deliverable containing valuable insight should direct the reader to specific actions of incorporating that insight into their knowledge base. The objectives statements can assist the reader in this process.

Nine (9) Additional Fields 4206-4222

Each of the fields 4206-4222 includes three subfields: accomplishments, challenges, and lessons learned. These three (1-3) subfields are described as follows: (1) Accomplishments: The Accomplishments subfield describes what was successful about a project's aspect of the given field (e.g., planning, resources, etc.). What contributed to that success and why it was successful can also be described. (2) Challenges: The Challenges subfield describes any problems that occurred with the project's aspect of the given field. What contributed to those problems and why they were problems can also be described. (3) Lessons Learned: The Lessons Learned subfield describes what was learned about the project's aspect of the given field and how that aspect can be handled differently next time. This recommendation can be to use the same approach or significant changes can be suggested.

Planning 4206

The Planning field provides analysis and insight on the project's planning aspect. This typically includes information regarding the planning processes used, who participated in the planning processes, and the quality of the plans (e.g., with respect to reliability, accuracy, completeness, etc).

Example questions to answer to develop this field's content are:
Were the team goals clear to you?
Were the marketing goals clear to you?
Were the development goals clear to you?
How complete do you think the planning was before the actual commencement of work?
How could planning be improved?
What recommendations would you make for the planning process for the next release?

To clarify, accomplishments, challenges, and lessons learned are specifically described with regard to the planning aspect of the project for field 4206. Although these descriptions are not repeated for fields 4208-4222 below, they are also applicable to the aspects thereof as noted above.

Accomplishments: The Accomplishments subfield describes what was successful about the project's planning aspect, including a description of what contributed to that success and why it was successful.

Challenges: The Challenges subfield describes any problems that occurred with the project's planning aspect, including what contributed to those problems and why they were problems.

Lessons Learned: The Lessons Learned subfield describes what was learned about planning and how planning should be effectuated the next time. Recommendations from lessons learned can be to use the same approach or can be suggestions for significant changes.

Resources 4208

The Resources field provides analysis and insight on the project's resources aspect. This typically includes information regarding the availability, quality, and application of resources.

Example questions to answer to develop this field's content are:
How can we improve our methods of resource planning?
Were there enough resources assigned to the project, given the schedule constraints?
What could have been done to prevent resource overload?
Do you think resources were managed effectively once the project started?

Project Management/Scheduling 4210

The Project Management/Scheduling field provides analysis and insight on the project's project management and scheduling aspects. This includes information regarding one or more of:
The integration of planning
Scope management
Budget management
Schedule management
Resource allocation
Vendor management
Risk management
Quality management.

Example questions to answer to develop this field's content are:
Was the schedule realistic?
Was the schedule detailed enough?
Looking over the schedule, which tasks could you have estimated better and how?
Did having a series of milestones help in making and monitoring the schedule?
What were the biggest obstacles to meeting the scheduled dates?
How was project progress measured? Was this method adequate? How could it be improved?
Was contingency planning apparent? How can we improve our contingency planning for the next release?
How could scheduling have been done better or been made more useful?
What would you change in developing future schedules?
How were changes managed late in the cycle?

Development/Design/Specifications 4212

The Development/Design/Specifications field provides analysis and insight on the project's development aspect. This typically includes information regarding the development processes used (e.g., coding standards, documentation, versioning, approval, etc), who participated in the development processes, and the quality of the designs and specifications that were used during development (e.g., with respect to reliability, accuracy, completeness, etc).

Example questions to answer to develop this field's content:
Were there issues in the functional design and ownership?
Were there issues in the architectural design and ownership?
Were there issues involved in using components or with code sharing? How could this be done more effectively?

Testing 4214

The Testing field provides analysis and insight on the project's testing aspect. This typically includes information regarding the testing processes used, who participated in the testing processes, and the quality of the testing plans and specifications that were used during testing (e.g., with respect to reliability, accuracy, completeness, etc).

Example questions to answer to develop this field's content are:
Were there issues in test interaction?
Were there issues in test case design and coverage?
Were there enough testers?
Was the quality of the solution we shipped acceptable?
Did we work well with all of the testers?

Communication 4216

The Communication field provides analysis and insight on the project's communication aspect. This typically includes information regarding the communication processes used, the timing and distribution of communication, the types of communication distributed, and the quality of the communication content.

Example questions to answer to develop this field's content are:
Was communication in your group handled efficiently and effectively?
Was communication between groups handled efficiently and effectively?
Was program management effective in disseminating information?
Was program management effective in resolving issues?
Was the e-mail alias usage effective? How could the aliases be better set up to improve communication?
Were the status meetings effective?
Was communication with the external groups (e.g., component suppliers, content suppliers, OEMs, support, international) effective?

Team/Organization 4218

The Team/Organization field provides analysis and insight on the project's team and organization structure aspects. This typically includes information regarding team leadership, any sub-teams and their structure, and the quality of the integration among the teams. It can also include information about the scope of each team's work, the performance of its designated role on the project, and the balance among the teams regarding decision-making.

Example questions to answer to develop this field's content are:
Did you understand who was on the team and what each member was responsible for?
Were the roles of the different groups (e.g., development, test, user experience, program management, marketing) clear to you?
What would you do to alter the organization to more effectively put out the solution? What functional changes would you make?What project team organization changes would you make?
Do you think the different groups fulfilled their roles?
What was deficient in your group? Other groups?
Did you have all the information you needed to do your job? If not, were you able to obtain the information?
Did you think the team worked together well?
Were management decisions communicated to the team? Did you understand how decisions were made?
Were external dependencies managed effectively?

Solution 4220

The Solution field provides analysis and insight on the project's solution aspect. This typically includes information regarding the processes of:
Understanding the customer's business objectives and requirements
Developing a solution concept
Determining the need for and deploying a pilot
Readying the operational environment for full deployment.

It can also include information on customer satisfaction and any metrics on business value.

Example questions to answer to develop this field's content are:
In retrospect, could the work of your group have been done better? How?
What needs to happen so your group can avoid problems in the future?
Are you satisfied with the solution you shipped? If not, why?
What would you do to improve the process of creating the solution?

Tools 4222

The Tools field provides analysis and insight on the project's tools aspect. This typically includes information regarding the specific tools used, the specific application of the tools, the usefulness of those tools, and any limitations of the tools.

Example questions to answer to develop this field's content are:
What improvements do you recommend for tracking bugs that will make the process more effective for use during development of the next release?
What improvements do you recommend for document and code source control?
What comments do you have about the build process and the compilers?
What comments do you have about the coding standards?
What other tools do you need?
What other improvements do you need to make on your existing tools?
   Guidelines for Successful Post Project Analysis Meetings

Do:
Be constructive and supportive.
Be precise and specific.
Focus on challenges and suggestions for improvement surrounding processes rather than specific individuals.

Do NOT:
Use peoples names.
Be negative or hostile.
Ask permission.
Explain or justify your comments and recommendations, unless asked to do so by someone else.
Repeat comments and recommendations made by others.
Express agreement or disagreement with comments and recommendations made by others.

Although systems, media, devices, methods, procedures, apparatuses, techniques, schemes, approaches, procedures, arrangements, and other implementations have been described in language specific to structural, logical, algorithmic, and functional features and/or diagrams, it is to be understood that the invention defined in the appended claims is not necessarily limited to the specific features or diagrams described. Rather, the specific features and diagrams are disclosed as example forms of implementing the claimed invention.

1. One or more processor-accessible media having processor-executable instructions that comprise a data structure, the data structure comprising:
at least two fields identifying needs and processes for training people who are to participate in creating a software solution;
wherein the at least two fields correspond respectively to at least two teams formed from the people who are to participate in creating the software solution.

2. The one or more processor-accessible media as recited in claim 1, wherein the at least two fields comprise a first field corresponding to a product management team and a second field corresponding to a test team.

3. The one or more processor-accessible media as recited in claim 1, wherein the at least two fields comprise a first field corresponding to a program management team and a second field corresponding to a user experience team.

4. The one or more processor-accessible media as recited in claim 1, wherein the at least two fields comprise a first field corresponding to a development team and a second field corresponding to a release management team.

5. The one or more processor-accessible media as recited in claim 1, wherein the at least two fields correspond to at least two teams selected from the group of teams comprising: product management, program management, development, test, user experience, and release management.

6. The one or more processor-accessible media as recited in claim 5, wherein a field of the at least two fields includes two or more of: a description of project responsibilities, an indication of knowledge and skill requirements, an explanation of proficiency levels by knowledge and skill area, or a listing of training requirements.

7. The one or more processor-accessible media as recited in claim 1, wherein the data structure comprises a training plan data structure; and wherein the data structure further comprises:
a summary field that provides an overall summary of the contents of the training plan data structure; and
an objectives field that describes the training activities' key objectives in terms of creating sufficient competency in both technical and project management knowledge and skill areas.

8. The one or more processor-accessible media as recited in claim 1, wherein the data structure further comprises:
a training requirements field that defines what a planned-for training process is to deliver by identifying teams that are to have training, by defining their specific knowledge and skill requirements, by establishing proficiency levels for that knowledge and skill, and by identifying training to attain the proficiency targets.

9. The one or more processor-accessible media as recited in claim 1, wherein the data structure further comprises:
(i) an information technology (IT) administration field that relates to position and responsibilities of a customer's IT administration staff and (ii) a helpdesk and support (HS) staff field that relates to position and responsibilities of the customer's HS staff;
wherein the IT administration field and the HS staff field each include at least one of: a description of project responsibilities, an indication of knowledge and skill requirements, an explanation of proficiency levels by knowledge and skill area, or a listing of training requirements.

10. The one or more processor-accessible media as recited in claim 1, further comprising:
a milestone review data structure that is adapted to summarize observations and findings of a project's milestone review;
wherein the milestone review data structure comprises:
a status of milestone deliverables field that lists deliverables that are to be completed at a milestone review and identifies their status; and
a readiness-for-next-milestone field that describes how well the project is positioned to achieve a next milestone.

11. The one or more processor-accessible media as recited in claim 1, further comprising:
a team lead project progress data structure that is adapted to summarize a team's progress on a project, including variance and impact on project delivery;
wherein the team lead project progress data structure comprises:
an issues and opportunities field that lists issues that affect the project and highlights project-related opportunities; and
a team project schedule update field that provides a report of changes to schedule status.

12. The one or more processor-accessible media as recited in claim 1, further comprising:
a vision/scope data structure that is adapted to represent ideas and decisions developed during an envisioning phase of a project for the software solution; and wherein the vision/scope data structure describes an agreement between an overall team of the project and a customer of the software solution on a desired solution and overall project direction.

13. The one or more processor-accessible media as recited in claim 12, wherein the vision/scope data structure comprises:
a business opportunity field that describes the customer's situation and needs;
a solutions concept field that describes an approach the overall team of the project is to take to meet the customer's needs;
a scope field that describes a boundary of the solution as defined through a range of features and functions and a customer acceptance criteria;
a solution design strategies field that describes architectural and technical designs to be used to create the software solution.

14. The one or more processor-acessible media as recited in claim 1, further comprising:
a project structure data structure that is adapted to define an approach the at least two teams are to take in organizing and managing a project for the software solution, the project data structure comprising a strategic representation of decisions regarding one or more of goals, work scope, team requirements, team processes, or risk.

15. The one or more processor-accessible media as recited in claim 14, wherein the project structure data structure comprises:
a knowledge, skills, and abilities (KSA) field that specifies requirements for project participants, the requirements organized into functional teams and responsibilities; and
a risk and issue assessment field that identifies and quantifies risks and issues that become apparent during an envisioning phase.

16. The one or more processor-accessible media as recited in claim 15, wherein the risk and issue assessment field comprises at least one of:
risk identification statements that lists project risks and conditions and consequences of each of the listed risks;
a risk analysis that describes an objective assessment of any risk's significance, including a calculation of risk exposure by assessing probability and impact for each item on the list of project risks;
risk plans that describe actions that can prevent and/or minimize risks and provide a course of action if a risk does occur; or risk priorities that enumerates the top “x” risks that threaten the project.

17. The one or more processor-accessible media as recited in claim 1, further comprising:
a team member project progress data structure that is adapted to summarize periodic accomplishments and to highlight concerns and issues that may affect a project for creating the software solution;
wherein the team member project progress data structure comprises:
an open action items field that summarizes “open” action items scheduled for completion within a given reporting period; and
an issues and opportunities field that lists issues that affect the project and highlights project-related opportunities.

18. The one or more processor-accessible media as recited in claim 1, further comprising:
a master project plan data structure that is adapted to present a single synchronized plan covering multiple which subsidiary plans;
wherein the master project plan data structure comprises:
a master project plan summary field that provides an overview of the master project plan data structure, the overview including a general description of subsidiary plans contained therein.

19. The one or more processor-accessible media as recited in claim 18, wherein the master project plan data structure includes qualitative information relating to at least one subsidiary plan selected from the group comprising: a development plan, a test plan, a support plan, and a training plan.

20. The one or more processor-accessible media as recited in claim 19, wherein the development plan includes information regarding development objectives, overall delivery strategy, and key design goals; the test plan includes information regarding testing objectives, overall test approach, expected test results, and test deliverables; and the training plan includes information regarding training objectives, training requirements, training schedule, and training methods.

21. The one or more processor-accessible media as recited in claim 1, further comprising:
a functional specification data structure that is adapted to include technical drill-down information explaining what the at least two teams are building and deploying;
wherein the functional specification data structure comprises:
a functional specification executive summary field that provides a strategic statement of the functional specification data structure, at least partially, by identifying which foundational data structures comprise the functional specification data structure and by providing a brief statement regarding each such foundational data structure.

22. The one or more processor-accessible media as recited in claim 21, wherein the functional specification data structure further comprises eight summary fields, each summary field of the eight summary fields directed to one of usage scenarios, user requirements, business requirements, operations requirements, system requirements, conceptual design, logical design, or physical design.

23. The one or more processor-accessible media as recited in claim 1, further comprising:
a post project analysis data structure that is adapted to record results from conducting a depth and breadth assessment of a project for creating the software solution from its inception to its completion.

24. The one or more processor-accessible media as recited in claim 23, wherein the assessment of the post project analysis data structure captures successes, challenges, and failures as well as identifying what should have been done differently on the project and what could be done differently in future projects.

25. The one or more processor-accessible media as recited in claim 23, wherein the post project analysis data structure comprises:
a summary field that provides a brief summary of the post project analysis data structure, including what will be done with contents thereof, with the contents including lessons learned; and
an objectives field that defines objectives of the post project analysis data structure, the objectives including at least one of (i) recording results of a comprehensive project analysis or (ii) ensuring that the lessons learned during the project are documented and shared.

26. The one or more processor-accessible media as recited in claim 23, wherein the post project analysis data structure comprises at least two fields selected from a group of nine fields comprising a planning field, a resources field, a project management/scheduling field, a development/design/specifications field, a testing field, a communications field, a team/organization filed, a solution field, and a tools field; and wherein each field of the at least two fields includes at least one of an accomplishments subfield, a challenges subfield, or a lessons learned subfield.

27. The one or more processor-accessible media as recited in claim 23, wherein the one or more processor-accessible media comprise at least one of (i) one or more storage media or (ii) on or more transmission media.

28. A device comprising:
at least one processor; and
one or more media including processor-executable instructions that are capable of being executed by the at least one processor, the processor-executable instructions adapted to direct the device to perform actions comprising
accessing a training plan data structure;
enabling a user of the device to modify the training plan data structure; and
storing the training plan data structure after modification;
wherein the training plan data structure includes information related to risk management and readiness management for a software project.

29. The device as recited in claim 28, wherein at least one field of the training plan data structure that may be modified by the user of the device relate to one or more of a product management team, a program management team, a development team, a test team, a user experience team, and a release management team.

30. The device as recited in claim 28, wherein at least one field of the training plan data structure that may be modified by the user of the device includes information related to training to ensure an adequate level of knowledge, skills, and abilities by participants of the software project.

31. The device as recited in claim 28, wherein the one or more media includes or otherwise provides access to a knowledge, skills, and abilities database.

32. The device as recited in claim 28, wherein the processor-executable instructions are adapted to direct the device to perform further actions comprising:
accessing a prioritized risk list;
accessing at least part of risk knowledge base; and
enabling the user of the device to update the prioritized risk list responsive to the risk knowledge base.

33. A method comprising:
establishing a multiple stage process model comprising at least a stabilizing stage that is at least partially conducted subsequent to at least a portion of a developing stage; and
storing data associated with said multiple stage process model.

34. The method as recited in claim 33, wherein said multiple stage process model includes at least one further stage selected from a group of stages comprising an envisioning stage, a planning stage, and a deploying stage.

35. The method as recited in claim 33, wherein said stabilizing stage includes at least one milestone selected from a group of milestones comprising a bug convergence milestone, a zero bug bounce milestone, a user acceptance testing milestone, a release candidates milestone, a pre-production testing complete milestone, and a pilot complete milestone.

36. The method as recited in claim 33, wherein at least a portion of said stabilizing stage occurs prior to a deploying stage.

37. One or more processor-accessible media having processor-executable instructions that comprise a data structure, the data structure comprising:
a first field that defines knowledge, skills, and/or abilities to be utilized to conduct a software project, the first field organized into functional teams and responsibilities; and
a second field that describes processes, methods, and/or tools to be used to manage risks associated with the software project.

38. The one or more processor-accessible media as recited in claim 37, wherein:
the knowledge, skills, and/or abilities of the first field include technical, managerial, and/or support capabilities; and
the second field includes one or more of: a description of risk management processes, methods, and/or tools; a schedule/frequency of risk management activities; roles and responsibilities within the risk management process; and specifications of a risk assessment form.

39. The one or more processor-accessible media as recited in claim 37, wherein the processor-executable instructions, when executed by a device, are adapted to direct the device to perform an action comprising at least one of:
transmitting the data structure from the device; or
receiving the data structure at the device.
